(19) United States
(12) Patent Application Publication
(10) Pub. No.: US 2024/0161939 A1
(43) Pub. Date: May 16, 2024

(54) SOLID TARGET SYSTEMS FOR THE PRODUCTION OF HIGH-PURITY RADIONUCLIDE COMPOSITIONS

(71) Applicant: Nuclidium AG, Basel (CH)

(72) Inventors: Leila JAAFAR-THIEL, Erlangen (DE); Luqman Mukhtar ISRAD, Erie, PA (US); Attila MOLNAR, Munich (DE); Markus Josef BAIER, Teunz (DE)

(73) Assignee: Nuclidium AG, Basel (CH)

(21) Appl. No.: 18/474,211

(22) Filed: Sep. 25, 2023

Related U.S. Application Data
(60) Provisional application No. 63/409,684, filed on Sep. 23, 2022.

(51) Int. Cl. G21G 1/00; C25D 3/12; G21G 1/04

(52) U.S. Cl. CPC G21G 1/001; C25D 3/12; G21G 1/04; G21G 2001/0094

(57) ABSTRACT

The present disclosure is related to novel solid target systems that produce novel high-purity radionuclide compositions using medical cyclotrons, the compositions are of suitable radionuclidic and chemical purity for use in radiopharmaceutical applications, for example, diagnostic imaging and targeted-radionuclide therapy in nuclear medicine.

### 1. BACKGROUND

The present disclosure is related to solid target systems that produce high-purity radionuclide compositions using medical cyclotrons, the compositions are of suitable radionuclidic and chemical purity for use in radiopharmaceutical applications, for example, diagnostic imaging and therapy in nuclear medicine.

Radionuclides, largely used worldwide in diagnostic imaging procedures in the fields of oncology, neurology, and cardiology, are currently produced by medical cyclotron accelerators and nuclear reactors. In cyclotron production, a target coin (or simply “coin”) bearing a target metal is bombarded with subatomic particles, thereby, converting the target metal into a desired radionuclide via a nuclear reaction. The growing number of cyclotrons of different energies installed worldwide has given a strong impulse to the production of conventional and emerging radionuclides for medical applications (See, e.g., Synowiecki M. A., et al. Production of Novel Diagnostic Radionuclides in Small Medical Cyclotrons. EJNMMI Radiopharm. Chem. 2018; 3: 1-25).

In particular, the great advantage of using medical cyclotrons is the possibility to produce the medical radionuclide of interest on-site and on demand. The technological advancement in cyclotron-based production has recently encouraged the use of novel radionuclides (mainly radiometals) in medical applications for implementing the so-called personalized medicine approach. In particular, the strength of this approach relies on the possibility of selecting patients responding positively to targeted treatment by performing a preliminary diagnostic imaging using the same radiopharmaceutical with a differing radionuclide (theranostic approach) (Boschi A., Martini P., Costa V., Pagnoni A., Uccelli L. Interdisciplinary Tasks in the Cyclotron Production of Radiometals for Medical Applications. The Case of 47Sc as Example. Molecules. 2019; 24: 444; Srivastava S. C. A Bridge Not Too Far: Personalized Medicine with the Use of Theragnostic Radiopharmaceuticals. J. Postgrad. Med. Educ. Res. 2013; 47: 31-46; Qaim S. M. Medical Radionuclide Production. De Gruyter; Berlin, Germany: 2019.)

The availability of active and highly pure novel medical radionuclides is essential for the development of personalized nuclear medicine. Various copper radionuclides have been used in nuclear medicine, and they offer versatile choices for radionuclide imaging (e.g., in radiotracers) and therapy.

Copper radionuclides, including ⁶⁰Cu, ⁶¹Cu, ⁶²Cu, ⁶⁴Cu, and ⁶⁷Cu, offer versatile choices for applications in imaging and therapy. The short-lived ⁶⁰Cu (t_{1/2}=23.4 min), ⁶¹Cu (t_{1/2}=3.32 h) and ⁶²Cu (t_{1/2}=9.76 min) decay by electron capture and β⁺ emission and have been used to prepare perfusion agents such as Cu-pyruvaldehyde bis(N⁴-methylthiosemicarbazone) (PTSM) and Cu-ethylglyoxal bis(thiosemicarbazone) ETS. The longer-lived ⁶⁷Cu (t_{1/2}=62.01 h) decays exclusively by β⁻ emission and has been used to label monoclonal antibodies and antibody fragments for radioimmunotherapy. ⁶⁴Cu has an intermediate half-life of 12.7 h and a unique decay prolife (β⁺: 18%, β⁻: 38%, and electron capture: 44%), making it useful for radiolabeling nanoparticles, antibodies, antibody fragments, peptides, and small molecules for Positron Emission Tomography (PET) imaging and radionuclide therapy. ⁶⁴Cu radiopharmaceuticals can thus be used for quantitative PET imaging to calculate radiation dosimetry prior to performing targeted radiotherapy with ⁶⁴Cu or its beta-emitting isotopologue ⁶⁷Cu. ⁶⁴Cu has been incorporated into many labelled bioconjugates based on antibodies, peptides and small molecules that target specific receptors or antigens, particularly in oncology applications.

More recently, ⁶¹Cu (t_{1/2}=3.33 h, 61% β, Eₘₐₓ=1.216 MeV) has been considered a better choice for imaging at later time points of processes with slower kinetics and to achieve a higher tumor-to-background ratio in the detection of small metastases due to its longer half-life (3.33 h) compared with ⁶⁰Cu and ⁶²Cu. ⁶¹Cu is a positron-emitting radionuclide presenting decay characteristics comparable to ⁶⁸Ga but with the advantage of presenting a lower maximum positron energy (Eₘₐₓ=1.216 MeV vs. Eₘₐₓ=1.899 MeV) and a substantially more practical half-life (3.33 h vs. 68 min). (McCarthy, D. W. et al. High-purity production and potential applications of copper-⁶⁰ and copper-⁶¹. Nucl. Med. Biol. 1999, 26, 351-358.) The intermediate half-life and favorable decay properties allow for better image quality and possibly lower radiation dose to patients.

The cost and complexity of producing sufficient quantities of high-quality Cu radioisotopes for medical use present a major challenge in their broader adoption as radiopharmaceuticals. Ensuring the availability of suitable target coins is essential to providing high-quality cyclotron produced radioisotopes in the quantity needed for medical purposes.

A high apparent molar activity is often required when using Cu radionuclides to produce radiopharmaceuticals, e.g., radiolabeled bioconjugates using bifunctional chelators. To this end, contamination of a radiopharmaceutical composition by nonradioactive trace metals (i.e., “cold metals”) must be reduced. For example, the presence of nonradioactive carrier copper should be reduced as it will compete with the desired radionuclides for chelation, thus, interfering with radiolabeling, reducing yield, and reducing the apparent molar activity, e.g., of the radiolabeled radiopharmaceutical product. Another consideration is that the metal targets used to prepare radionuclides (e.g., enriched Ni for making radiocopper) often contain other trace metal impurities, including iron and zinc. Metal contaminants in a radiopharmaceutical composition also arise from solutions and equipment used in various production processes. Radionuclidic impurities should also be reduced. One source of such impurities is from, e.g., isotopically enriched Ni targets that often contain nickel isotopic impurities that can lead to undesired Cu isotopic impurities upon bombardment.

Accordingly, when preparing radionuclides for radiopharmaceutical applications, there is a need to reduce both radiochemical and radionuclidic contaminants that negatively influence the labelling and apparent molar activity of the final radiopharmaceutical product.

### 2. SUMMARY

The present disclosure describes, among other things, the construction and evaluation of a radiocopper (^{6x}Cu) production system that reduces the amount of costly isotopically enriched Ni target metal leading to more cost-efficient radiocopper production; reduces radionuclidic impurities (particularly ⁶⁰Co), nonradioactive Cu, and other trace metal contamination; and increases radiochemical purity, radionuclidic purity, chemical purity, and apparent molar activity of the resulting radionuclide compositions, which are suitable for use in medical applications such as production of radiotracers for medical imaging and treatment of cancer.

A first aspect of the present disclosure provides a novel coin for bombardment by subatomic particles for use in producing radionuclides, e.g., on a medical cyclotron; the coin includes a backing made up of Nb having a purity of at least 98.8%. In certain embodiments, various impurities in the Nb backing are limited to, e.g., Fe≤40 ppm; Ti≤60 ppm; Zn≤19 ppm; Cu≤5 ppm; Sn≤8 ppm; Ni<5 ppm; and Al≤5 ppm. In further embodiments, the backing has a backing surface that is free or substantially free of oxides, particularly metal oxides.

A second aspect of the present disclosure provides a coin as described in the first aspect of the disclosure described above, that also includes an electroplated coating of a target metal adhered to the backing surface. In certain embodiments, certain impurities in the target are limited, for example: Cd≤0.0005 ppm, Co≤0.005 ppm, Pb≤0.005 ppm, Cu≤0.08 ppm, and Fe≤0.15 ppm.

In certain embodiments, the target metal is Ni or Zn in naturally occurring isotopic abundance (“natural” Ni or Zn) or enriched to various levels of isotopic abundance.

A third aspect of the present disclosure provides a method for preparing a coin comprising an electroplated target metal adhered to the backing surface wherein the backing comprises material resistant to corrosion, the method comprising electroplating the target metal from a plating solution onto the backing surface; and wherein the plating solution has a pH of 9.5-10.7. In certain embodiments, the backing comprises Nb, Ag, Pt, Au, Al, or W, particularly Nb.

A fourth aspect of the present disclosure provides a method for preparing a coin according to the second aspect of the disclosure described above, the method comprising: electroplating the target metal from a plating solution onto the backing surface to form a target coating. In certain embodiments the plating solution has a pH of 9.5-10.7. In further embodiments is provided a coin prepared according to a method provided herein.

In embodiments of the third and fourth aspects, the methods further comprise one or more of the following elements: abrading the backing surface before the electroplating, wherein the plating solution comprises nitrate ions, wherein the electroplating occurs at a current of 120 to 300 μA, wherein the electroplating occurs for ≤3 hours, wherein the starting material source of the target metal used to prepare the plating solution is at least 99.9% pure, wherein the preparing the plating solution comprises ammonium ions, wherein the electroplating occurs in an electrolytic cell comprising a fixed anode, wherein the plating solution is characterized by reducing certain impurities to certain threshold levels, such as Cu≤0.1 ppm, Fe≤10 ppm, Ga, Lu, Pb, Y≤0.1 ppm; Zn, Co≤0.3 ppm; Cd, Cr, Al, Mn, Mo, Sn, Ti, and V≤1 ppm; and Family I (alkali metals) and Family II (alkaline earth metals) elements: ≤1000 ppm.

A fifth aspect of the present disclosure provides a high-purity radionuclide composition, the composition comprising a radionuclide and having a radionuclidic purity at the end of synthesis (EoB plus 90 minutes) for the radionuclide of ≥95%; and wherein the radionuclide is a Cu radionuclide, and/or the presence of certain radionuclidic impurities are limited, such as ^{110m}Ag≤0.1 Bq/g; ^{108m}Ag≤0.1 Bq/g; and ¹⁰⁹Cd≤0.1 Bq/g. In certain embodiments, the high-purity radionuclide composition is in the form of an aqueous chloride salt solution, e.g., [⁶¹Cu]CuCl₂. In certain embodiments, the radionuclide is ⁶¹Cu, ⁶⁴Cu, or ⁶⁸Ga. In certain embodiments, the high-purity radionuclide composition is characterized by a chemical purity for the radionuclide of ≥99.0%. In further embodiments, certain chemical impurities are limited to certain amounts, such as Fe≤2 mg/L; stable Cu isotopes are ≤1 mg/L; Zn(II)≤2 mg/L; Sn(IV)≤0.01 mg/L; Ti(IV)≤0.01 mg/L; Al(III)≤2 mg/L; As≤1 mg/L; Ni≤1 mg/L; and wherein any one of Cr, Cd, Co, and Y is ≤0.1 mg/mL. In certain embodiments, the high-purity radionuclide composition is characterized by one or more of: an activity concentration of 0.25-25 GBq/mL at calibration (EoB+8 hrs); an apparent molar activity of 10-100 MBq/nmol at calibration; and an activity at end of synthesis (EoB plus 90 minutes) of >500 MBq.

In a sixth aspect of the present disclosure, a method of making the high-purity radionuclide composition according to the fifth aspect of the present disclosure described above is provided, the method comprising: irradiating in a particle accelerator the target metal of the coin as according to the second aspect of the present disclosure described above, to produce an irradiated target material; and isolating the high-purity radionuclide composition. In certain embodiments, the method comprises the following elements: purifying the radionuclide chloride solution to reduce chemical impurities, wherein the irradiating time is up to the length of two half-lives of the radionuclide, such as one half-life.

In certain embodiments of the sixth aspect, the target metal is natural Ni, ⁶⁰Ni, ⁶¹Ni, and the radionuclide of the high-purity radionuclide composition is [⁶¹Cu]CuCl₂ according to one of the following reactions: ^{nat}Ni(d,n)⁶¹Cu and ⁶⁰Ni(d,n)⁶¹Cu. In certain embodiments, the target metal is ⁶¹Ni, the radionuclide is ⁶¹Cu produced according to the following reaction: ⁶¹Ni(p,n)⁶¹Cu. In certain embodiments, the target metal is ⁶⁴Zn, wherein the radionuclide is ⁶¹Cu produced according to the following reaction: ⁶⁴Zn(p,α)⁶¹Cu. In certain embodiments, the target metal is ⁶¹Ni, wherein the radionuclide is ⁶¹Cu produced according to the following reaction: ⁶⁰Ni(p,n)⁶⁰Cu. In certain embodiments, the target metal is ⁶²Ni, wherein the radionuclide is ⁶²Cu produced according to the following reaction: ⁶²Ni(p,n)⁶²Cu. In certain embodiments, the target metal is ⁶⁴Ni, wherein the radionuclide is ⁶⁴Cu produced according to the following reaction: ⁶⁴Ni(p,n)⁶⁴Cu. In certain embodiments, the target metal is ⁶⁸Zn, wherein the radionuclide is ⁶⁴Cu produced according to the following reaction: ⁶⁸Zn(p,αn)⁶⁴Cu. In further embodiments, the target metals are natural or are enriched in the identified isotope to at least 95%, at least 97%, or at least 99%.

### 3. BRIEF DESCRIPTION OF THE DRAWINGS

These and other features, aspects, and advantages of the present disclosure will become better understood with regard to the following description and accompanying drawings where:

FIG. 1—panels A-C, illustrate enhanced surface porosity and pore distribution homogeneity produced by electrodeposition at increasing pH, pH 9.3 (panel A), pH 10.0 (panel B), and pH 10.2 (panel C).

FIG. 2 panels A-C, illustrate with increasing magnification homogenous nickel coating having durable adhesion to a niobium coin upon completion of electroplating, as evaluated using a DINOLite digital microscope. Panel A, 20× magnification; panel B, 50× magnification; panel C, 250× magnification.

FIG. 3 shows samples of the coin provided according to the present disclosure with nickel deposited in the center of a niobium backing.

FIG. 4 displays the analysis of ⁶¹Cu purity of [⁶¹Cu]CuCl₂ solution obtained by irradiation of ^{nat}Ni on Nb backing with deuteron beam at 8.4 MeV for 3 h at 50 μA. The curved line corresponds to reduction in % purity of ⁶¹Cu over time and the bars correspond to radiocobalt activity over time.

FIG. 5 displays an analysis of ⁶¹Cu purity of [⁶¹Cu]CuCl₂ solution obtained by irradiation of ⁶⁰Ni on Nb backing with a deuteron beam at 8.4 MeV for 3 h at 50 μA. The curved line corresponds to the reduction in % purity of ⁶¹Cu over time, and the bars correspond to radiocobalt activity over time.

FIG. 6 presents the activity concentration of detected impurities in [⁶¹Cu]CuCl₂ solutions produced according to various methods. The ext. coin (Ag, natNi) data was generated by irradiation of a commercially available ^{nat}Ni target on Ag backing. The (Nb, natNi) and (Nb, Ni-61) data were generated based on irradiation of Ni targets (natural and isotopically enriched in ⁶¹Ni, respectively) electroplated according to the present disclosure on high-purity Nb backing. The activity concentration was assessed by gamma spectrometry and reported in Bq/g. The data shows that silver and cobalt isotopes are significantly reduced in the [⁶¹Cu]CuCl₂ solution produced by irradiation of Ni targets electroplated according to the present disclosure on high-purity Nb backing.

FIG. 7 shows the significant reduction in the sum of radionuclidic impurities present in a [⁶¹Cu]CuCl₂ solutions produced according to various methods. The ext. coin (Ag, natNi) data was generated based on irradiation of a commercially available ^{nat}Ni target on Ag backing. The (Nb, natNi) and (Nb, Ni-61) data were generated based on irradiation of Ni targets (natural and isotopically enriched in ⁶¹Ni, respectively), electroplated according to the present disclosure on high-purity Nb backing. The radionuclidic impurities were determined by gamma spectrometry and reported in Bq/g (summed radionuclidic impurities). The presented data highlight in particular the reduction of overall impurities in the [⁶¹Cu]CuCl₂ solution when produced in accordance with the present disclosure.

FIG. 8 illustrates the sustained high radionuclidic purity of a [⁶¹Cu]CuCl₂ solution produced according to the present disclosure compared to a commercially available ^{nat}Ni target on a Ag backing (ext. coin (Ag, natNi)). The (Nb, natNi) and (Nb, Ni-61) coins were prepared by electrodeposition according to the present disclosure on high-purity Nb backing. The data was generated using gamma spectrometry and reported in Bq/g providing the summed radionuclidic purities at t=0 h and at t=12 h. The presented data highlight the superior quality of the [⁶¹Cu]CuCl₂ solution when produced by irradiation of Ni targets electroplated according to the present disclosure on high purity Nb backing, where the purity after 12 hours is still well above the purity limits set by pharmacopeia for similar radionuclides for medical use.

FIG. 9 displays chemical impurities, as measured by ICP-MS, of the [⁶¹Cu]CuCl₂ solution when produced by bombardment of ^{nat}Ni vs. ⁶¹Ni when produced by irradiation of Ni targets electroplated according to the present disclosure on high-purity Nb backing.

### 4. DETAILED DESCRIPTION

### 4.1. Target Coin

An aspect of the present disclosure is the provision of a novel coin comprising a metal target for bombardment by subatomic particles to produce radionuclide compositions. In certain embodiments, a provided target coin is designed specifically for use in low energy, biomedical cyclotrons. In certain embodiments, a provided target coin is designed for use in biomedical cyclotrons.

### 4.1.1. Backing

In certain embodiments, the coin of the present disclosure comprises a backing. This backing has a mass and in certain embodiments has at least one backing surface upon which a targeting metal is deposited. The term “backing surface” as used herein refers to a single side of the backing that is or will be in contact with the target metal. In certain embodiments, the target metal is adhered to the backing, e.g., by electrodeposition. To describe this in another way, the target metal is adhered to the backing, for example, in the form of an electroplated coating or layer, this mass referred to herein simply as the “target” or “target metal.” After the target metal is adhered to the backing, the result is the coin.

In certain embodiments of the present disclosure, the backing comprises a chemically inert material, such as Nb, Ag, Pt, Au, Al, or W, particularly Nb. In certain embodiments of the present disclosure, the backing consists of a chemically inert material, such as Nb, Ag, Pt, Au, Al, or W, particularly Nb.

In certain embodiments, the backing is a Nb or Ag backing. In certain embodiments, the backing is a Ag backing. In certain embodiments, the backing is a Nb backing. In certain embodiments, the backing is a Pt backing. In certain embodiments, the backing is a Au backing. In certain embodiments, the backing is an Al backing. In certain embodiments, the backing is a W backing.

In certain embodiments, the backing is not a Ag backing. In certain embodiments, the backing is not a Pt backing. In certain embodiments, the backing is not a Au backing. In certain embodiments, the backing is not an Al backing. In certain embodiments, the backing is not a W backing.

In certain embodiments, the backing does not comprise Ag. In certain embodiments, the backing does not comprise Pt. In certain embodiments, the backing does not comprise Au. In certain embodiments does not comprise Al. In certain embodiments, the backing does not comprise W.

4.1.1.1 High-Purity Nb

In certain embodiments of the present disclosure, the backing is a high purity Nb backing. In certain embodiments, the purity of Nb is ≥98.8%. In certain embodiments, the purity of Nb is 299.8%. In certain embodiments, the purity of Nb is 99-99.9%. In certain embodiments, purity of Nb is 99-99.99%. In certain embodiments, of the purity of Nb is 99-99.999%.

In certain embodiments, the purity of the Nb backing is ≥98.850%, ≥98.900%, ≥98.950%, ≥990%, ≥99.050%, ≥99.100%, ≥99.150%, ≥99.200%, ≥99.250%, ≥299.300%, ≥99.350%, ≥99.400%, ≥99.450%, ≥99.500%, ≥99.510%, ≥99.520%, ≥99.530%, ≥99.540%, ≥99.550%, ≥99.560%, ≥99.570%, ≥99.580%, ≥99.590%, ≥99.600%, ≥99.610%, ≥99.620%, ≥99.630%, ≥99.640%, ≥99.650%, ≥99.660%, ≥99.670%, ≥99.680%, ≥99.690%, ≥99.700%, ≥99.710%, ≥99.720%, ≥99.730%, ≥99.740%, ≥99.750%, ≥99.760%, ≥99.770%, ≥99.780%, ≥99.790%, ≥99.800%, ≥99.810%, ≥99.820%, ≥99.830%, ≥99.840%, ≥99.850%, ≥99.853%, ≥99.856%, ≥99.859%, ≥99.862%, ≥99.865%, ≥99.868%, ≥99.871%, ≥99.874%, ≥99.877%, ≥99.880%, ≥99.883%, ≥99.886%, ≥99.889%, ≥99.892%, ≥99.895%, ≥99.898%, ≥99.901%, ≥99.904%, ≥99.907%, ≥99.910%, ≥99.913%, ≥99.916%, ≥99.919%, ≥99.922%, ≥99.925%, ≥99.928%≥99.931%, ≥99.934%, ≥99.937%, ≥99.940%, ≥99.943%, ≥99.946%, ≥99.949%, ≥99.952%, ≥99.955%, ≥99.958%, ≥99.961%, ≥99.964%, ≥99.967%, ≥99.970%, ≥99.973%, ≥99.976%, ≥99.979%, ≥99.982%, ≥99.985%, ≥99.988%, ≥99.991%, ≥99.994%, or ≥99.997%. In certain embodiments, of the purity of the Nb backing is 99.810%.

In certain embodiments, the Nb backing is characterized by limiting the amount of certain impurities, as described below.

In certain embodiments of the Nb backing, the amount of Fe in the backing is ≤30 ppm. In certain embodiments, the amount of Fe in the backing is ≤27 ppm, ≤28 ppm, ≤29 ppm, ≤30 ppm, ≤31 ppm, ≤32 ppm, ≤33 ppm, ≤34 ppm, ≤35 ppm, ≤36 ppm, ≤37 ppm, ≤38 ppm, ≤39 ppm, ≤40 ppm, ≤41 ppm, ≤42 ppm, ≤43 ppm, ≤44 ppm, ≤45 ppm, ≤46 ppm, ≤47 ppm, ≤48 ppm, ≤49 ppm, or ≤50 ppm.

In certain embodiments of the Nb backing, the amount of Ti in the backing is ≤60 ppm; for example, Ti is ≤10 ppm. In certain embodiments, the amount of Ti in the backing is ≤5 ppm, ≤6 ppm, ≤7 ppm, ≤8 ppm, ≤9 ppm, ≤10 ppm, ≤11 ppm, ≤12 ppm, ≤13 ppm, ≤14 ppm, ≤15 ppm, ≤16 ppm, ≤17 ppm, ≤18 ppm, ≤19 ppm, ≤20 ppm, ≤21 ppm, ≤22 ppm, ≤23 ppm, ≤24 ppm, ≤25 ppm, ≤26 ppm, ≤27 ppm, ≤28 ppm, ≤29 ppm, ≤30 ppm, ≤31 ppm, ≤32 ppm, ≤33 ppm, ≤34 ppm, ≤35 ppm, ≤36 ppm, ≤37 ppm, ≤38 ppm, ≤39 ppm, ≤40 ppm, ≤41 ppm, ≤42 ppm, ≤43 ppm, ≤44 ppm, ≤45 ppm, ≤46 ppm, ≤47 ppm, ≤48 ppm, ≤49 ppm, ≤50 ppm, ≤51 ppm, ≤52 ppm, ≤53 ppm, ≤54 ppm, ≤55 ppm, ≤56 ppm, ≤57 ppm, ≤58 ppm, ≤59 ppm, ≤60 ppm, ≤61 ppm, ≤62 ppm, ≤63 ppm, ≤64 ppm, ≤65 ppm, ≤66 ppm, ≤67 ppm, ≤68 ppm, ≤69 ppm, ≤70 ppm, ≤71 ppm, ≤72 ppm, ≤73 ppm, or ≤74 ppm.

In certain embodiments of the Nb backing, the amount of Zn in the backing is ≤19 ppm; e.g., Zn is ≤10 ppm. In certain embodiments, the amount of Zn in the backing is ≤5 ppm, ≤6 ppm, ≤7 ppm, ≤8 ppm, ≤9 ppm, ≤10 ppm, ≤11 ppm, ≤12 ppm, ≤13 ppm, ≤14 ppm, ≤15 ppm, ≤16 ppm, ≤17 ppm, ≤18 ppm, ≤19 ppm, ≤20 ppm, ≤21 ppm, ≤22 ppm, ≤23 ppm, ≤24 ppm, ≤25 ppm, ≤26 ppm, ≤27 ppm, ≤28 ppm, ≤29 ppm, or ≤30 ppm.

In certain embodiments of the Nb backing, the amount of Cu in the backing is ≤5 ppm; e.g., Cu is ≤3 ppm. In certain embodiments, the amount of Cu in the backing is ≤0.5 ppm, ≤1 ppm, ≤1.5 ppm, ≤2 ppm, ≤2.5 ppm, ≤3 ppm, ≤3.5 ppm, ≤4 ppm, ≤4.5 ppm, ≤5 ppm, ≤5.5 ppm, ≤6 ppm, ≤6.5 ppm, ≤7 ppm, ≤7.5 ppm, or ≤8 ppm.

In certain embodiments of the Nb backing, the amount of Sn in the backing is ≤5 ppm. In certain embodiments, the amount of Sn in the backing is ≤0.5 ppm, ≤1 ppm, ≤1.5 ppm, ≤2 ppm, ≤2.5 ppm, ≤3 ppm, ≤3.5 ppm, ≤4 ppm, ≤4.5 ppm, ≤5 ppm, ≤5.5 ppm, ≤6 ppm, ≤6.5 ppm, ≤7 ppm, ≤7.5 ppm, ≤8 ppm, ≤8.5 ppm, ≤9 ppm, ≤9.5 ppm, ≤10 ppm, ≤10.5 ppm, ≤11 ppm, ≤11.5 ppm, ≤12 ppm, ≤12.5 ppm, or ≤13 ppm.

In certain embodiments of the Nb backing, the amount of Ni in the backing is <5 ppm; e.g., Ni is <1 ppm. In certain embodiments, the amount of Ni in the backing is ≤0.2 ppm, ≤0.4 ppm, ≤0.6 ppm, ≤0.8 ppm, ≤1 ppm, ≤1.2 ppm, ≤1.4 ppm, ≤1.6 ppm, ≤1.8 ppm, ≤2 ppm, ≤2.5 ppm, ≤3 ppm, ≤3.5 ppm, ≤4 ppm, ≤4.5 ppm, ≤5 ppm, ≤5.5 ppm, ≤6 ppm, ≤6.5 ppm, ≤7 ppm, ≤7.5 ppm, or ≤8 ppm.

In certain embodiments of the Nb backing, the amount of Al in the backing is ≤5 ppm. In certain embodiments, the amount of Al in the backing is ≤0.2 ppm, ≤0.4 ppm, ≤0.6 ppm, ≤0.8 ppm, ≤1 ppm, ≤1.2 ppm, ≤1.4 ppm, ≤1.6 ppm, ≤1.8 ppm, ≤2 ppm, ≤2.5 ppm, ≤3 ppm, ≤3.5 ppm, ≤4 ppm, ≤4.5 ppm, ≤5 ppm, ≤5.5 ppm, ≤6 ppm, ≤6.5 ppm, ≤7 ppm, ≤7.5 ppm, ≤8 ppm, ≤8.5 ppm, ≤9 ppm, ≤9.5 ppm, or ≤10 ppm.

In certain embodiments of the Nb backing, the amount of Fe in the backing is ≤50 ppm (e.g., ≤30 ppm), the amount of Ti in the backing is ≤60 ppm (e.g., ≤10 ppm), the amount of Zn in the backing is ≤19 ppm (e.g., ≤10 ppm), the amount of Cu in the backing is ≤5 ppm (e.g., ≤3 ppm), the amount of Sn in the backing is ≤13 ppm (e.g., ≤5 ppm), the amount of Ni in the backing is <5 ppm (e.g., <1 ppm), and/or the amount of Al in the backing is ≤5 ppm (e.g., 1 ppm), or any combination of the above.

In certain embodiments, the Nb backing is 99.8% pure, and comprises: C≤24 ppm, H≤1 ppm, Mo≤2 ppm, Ni≤4 ppm, Si≤1 ppm, Ti≤2 ppm, Zr≤3 ppm, Fe≤1 ppm, Hf≤2 ppm, N≤14 ppm, O≤56 ppm, Ta≤785 ppm, and W≤4 ppm. In certain embodiments, the Nb backing is 99.9% pure and comprises: B≤10 ppm, Ni≤5 ppm, O≤100 ppm, Si≤100 ppm, Zr≤10 ppm, Ta≤500 ppm, H≤10 ppm, W≤100 ppm, C≤25 ppm, Ni≤20 ppm, Fe≤30 ppm, Cu≤5 ppm, Mo≤10 ppm, and Ti≤10 ppm.

4.1.1.2 Dimensions of the Backing

The backing according to the present disclosure is any two-dimensional shape without restriction and that has any thickness suitable for its intended use. In certain embodiments, the backing is a circle, an oval, or a geometric shape having from 3-10 sides, for example, a quadrilateral, such as a rectangle, square, trapezoid or parallelogram, a triangle, a composite of multiple geometric shapes, or an organic shape with irregular sides.

In certain embodiments, the backing has a circular cross-section (i.e., disc-shaped). In further such embodiments, the backing has a diameter of 35-15 mm, e.g., 28 mm, or 22 mm. Unless stated otherwise, the tolerance in diameter is ±0.1 mm.

In certain embodiments, the backing has a thickness of 0.50-3 mm or 1-2 mm. In certain embodiments the backing has a thickness of 0.75-2.25 mm, 0.88-2.13 mm, 1-2 mm, 1.13-1.88 mm, 1.25-1.75 mm, or 1.38-1.63 mm. In certain embodiments, the backing has a thickness of 0.5 mm, 0.63 mm, 0.75 mm, 0.88 mm, 1 mm, 1.13 mm, 1.25 mm, 1.38 mm, 1.5 mm, 1.63 mm, 1.75 mm, 1.88 mm, 2 mm, 2.13 mm, 2.25 mm, 2.38 mm, 2.5 mm, 2.63 mm, 2.75 mm, 2.88 mm, or 3 mm.

In certain embodiments, the backing has a thickness of 1 mm to 2.5 mm. In certain embodiments, the backing thickness is 1.5 mm.

Unless stated otherwise, the tolerance in the backing thickness values reported herein is f 0.05 mm.

In certain embodiments, the backing comprises a central disc-shaped groove. In further embodiments, the disc-shaped groove has a diameter of 10 mm and a depth of about 0.6 mm.

In certain embodiments, the surface of the backing material has a roughness (Ra) of 1.6 μm (micrometer). In certain embodiments, the surface of the backing material has an Ra of 1.5 μm. In certain embodiments, the surface of the backing material has an Ra of 1.4 μm. In certain embodiments, the surface of the backing material has an Ra of 1.3 μm. In certain embodiments, the surface of the backing material has an Ra of 1.2 μm. In certain embodiments, the surface of the backing material has an Ra of 1.1 μm. In certain embodiments, the surface of the backing material has an Ra of 1 μm. In certain embodiments, the surface of the backing material has an Ra of 0.9 μm. In certain embodiments, the surface of the backing material has an Ra of 0.8 μm. In certain embodiments, the surface of the backing material has an Ra of 0.7 μm. In certain embodiments, the surface of the backing material has an Ra of 0.6 μm. In certain embodiments, the surface of the backing material has an Ra of 0.5 μm. In certain embodiments, the surface of the backing material has an Ra of 0.4 μm. In certain embodiments, the surface of the backing material has an Ra of 0.3 μm. In certain embodiments, the surface of the backing material has an Ra of 0.2 μm. In certain embodiments, the surface of the backing material has an Ra of 0.1 μm.

Variations on the dimensions of the backing provided without tolerance values herein are according to ISO 2768 1:1989 General tolerances—Part 1: Tolerances for linear and angular dimensions without individual tolerance indications.

4.1.1.3 Backing Surface

In certain embodiments of the backing, and in particular, of the backing surface to which the target metal adheres, is free of oxides, for example, as evaluated by visual inspection. The presence of oxides is typically apparent as a discoloration that obscures the natural luster or color of the raw metal backing. In certain of these embodiments, any observed oxides are removed, e.g., by abrasion. Without being bound by theory, treatment of the backing surface with an abrasive method may further improve purity of the radionuclide product and/or to ensure sufficient adhesion of a target coating which in turn ensures target metal integrity during coin transfer and during particle bombardment.

In certain embodiments, the backing comprises Nb, wherein the backing surface is free or substantially free of oxides, particularly metal oxides. In certain embodiments, the Nb backing is new or unused, e.g., manufactured and stored to avoid exposure to oxidizing physical conditions. In certain embodiments, the backing is rolled out from a metal foil having a thickness greater than the desired thickness of the backing, thus imparting surface roughness.

In certain embodiments, the Nb backing surface has some oxidation, e.g., as observed by the presence discoloration of the natural luster or color of the raw metal surface. In related embodiments, the oxidation has been removed by physical abrasion, e.g., as described herein.

### 4.1.2. Target Metal

In certain embodiments, the target metal is the material to be irradiated (bombarded by, e.g., protons or deuterons) thereby producing radionuclide compositions of the present disclosure. In certain embodiments, impurities in the target metal are limited to certain levels described herein.

In certain embodiments, the target metal is electrodeposited, pressed, sintered, press-bonded, melted or physically deposited (through vapor or atomic deposition) onto the backing which acts as a stable carrier during the irradiation process. In certain embodiments, the target metal is in the form of a foil. In certain embodiments, the foil is a sheet or roll.

In certain embodiments, the electrodeposited target metal forms a target coating. In certain embodiments, the target coating covers only a portion of the backing surface, for example, the center of the backing surface but not all the way to the perimeter of the backing surface. In certain embodiments, the target coating is prepared by electroplating the target metal from a plating solution, e.g., as described herein. In certain embodiments, a target coating is prepared by electroplating a target metal from a plating solution onto a backing surface.

In certain embodiments, the deposited target is a smooth and homogenous deposit with uniform thickness (with less than 25%, 20%, 15%, 12%, 10%, or 5% variability, particularly less than 15% variability) free of observable cracks or craters.

In certain embodiments, the maximum thickness of the target coating is 0.07 mm, 0.075 mm, 0.08 mm, 0.085 mm, 0.09 mm, 0.095 mm, 0.1 mm, 0.105 mm, 0.11 mm, 0.115 mm, 0.12 mm, 0.125 mm, 0.13 mm, or 0.135 mm. In certain embodiments, the maximum thickness of the target coating is 0.1 mm.

In certain embodiments, the minimum thickness of the target coating is 0.1 mm, 0.105 mm, 0.11 mm, 0.115 mm, 0.12 mm, 0.125 mm, 0.13 mm, 0.135 mm, 0.14 mm, 0.145 mm, 0.15 mm, 0.155 mm, 0.160 mm, 0.165 mm, 0.17 mm, 0.175 mm, or 0.18 mm. In certain embodiments, the minimum thickness of the target coating is 0.14 mm.

Unless otherwise indicated, the tolerance of the thickness measurements is ±0.005 mm.

In certain embodiments, the amount of target metal deposited on the backing is 25 mg, 30 mg, 35 mg, 40 mg, 45 mg, 50 mg, 55 mg, 60 mg, 65 mg, 70 mg, 75 mg, 80 mg, 85 mg, 90 mg, 95 mg, 100 mg, 105 mg, 110 mg, 115 mg, 120 mg, 125 mg, 130 mg, 135 mg, 140 mg, 145 mg, 150 mg, 155 mg, 160 mg, 165 mg, 170 mg, 175 mg, 180 mg, 185 mg, 190 mg, 195 mg, 200 mg, 205 mg, 210 mg, 215 mg, 220 mg, 225 mg, 230 mg, 235 mg, or 240 mg.

In certain embodiments, the amount of target metal deposited on the backing is 20 mg, 21 mg, 22 mg, 23 mg, 24 mg, 25 mg, 26 mg, 27 mg, 28 mg, 29 mg, 30 mg, 31 mg, 32 mg, 33 mg, 34 mg, 35 mg, 36 mg, 37 mg, 38 mg, 39 mg, 40 mg, 41 mg, 42 mg, 43 mg, 44 mg, 45 mg, 46 mg, 47 mg, 48 mg, 49 mg, 50 mg, 51 mg, 52 mg, 53 mg, 54 mg, 55 mg, 56 mg, 57 mg, 58 mg, 59 mg, 60 mg, 61 mg, 62 mg, 63 mg, 64 mg, 65 mg, 66 mg, 67 mg, 68 mg, 69 mg, 70 mg, 71 mg, 72 mg, 73 mg, 74 mg, 75 mg, 76 mg, 77 mg, 78 mg, 79 mg, or 80 mg.

Unless otherwise indicated, the tolerance of the mass measurements is ±0.5 mg.

4.1.2.1.1 Nickel

In certain embodiments, the target metal is Ni. In certain embodiments, the target metal is natural Ni. Naturally occurring nickel is composed of five stable isotopes. ⁵⁸Ni is the most abundant isotope (68.077% natural abundance). The four minor (i.e., not most abundant) stable isotopes and their corresponding natural abundance is: ⁶⁰Ni (26.223%), ⁶¹Ni (1.1400), ⁶²Ni (3.635%), and ⁶⁴Ni (0.926%).

In certain embodiments, the target metal is Ni and is isotopically enriched in a minor isotope selected from ⁶⁰Ni, ⁶¹Ni, ⁶²Ni, and ⁶⁴Ni, relative to the minor isotope's natural abundance in Ni.

In certain embodiments, the target metal is Ni that is isotopically enriched in the minor isotope to 95% or more.

In certain embodiments, the target metal is Ni that is enriched in ⁶⁰Ni to 95%-99.99%. In certain embodiments, the target metal is Ni that is enriched in ⁶⁰Ni to 96%-99.99%. In certain embodiments, the target metal is Ni that is enriched in ⁶⁰Ni to 97%-99.99%. In certain embodiments, the target metal is Ni that is enriched in ⁶⁰Ni to 98%-99.99%. In certain embodiments, the target metal is Ni that is enriched in ⁶⁰Ni to 99%-99.99%.

In certain embodiments, the target metal is Ni that is enriched in ⁶¹Ni to 95%-99.99%. In certain embodiments, the target metal is Ni that is enriched in ⁶¹Ni to 95%-99.99%. In certain embodiments, the target metal is Ni that is enriched in ⁶¹Ni to 96%-99.99%. In certain embodiments, the target metal is Ni that is enriched in ⁶¹Ni to 97%-99.99%. In certain embodiments, the target metal is Ni that is enriched in ⁶¹Ni to 98%-99.99%. In certain embodiments, the target metal is Ni that is enriched in ⁶¹Ni to 99%-99.99%.

In certain embodiments, the target metal is Ni that is enriched in ⁶²Ni to 95%-99.99%. In certain embodiments, the target metal is Ni that is enriched in ⁶²Ni to 96%-99.99%. In certain embodiments, the target metal is Ni that is enriched in ⁶²Ni to 97%-99.99%. In certain embodiments, the target metal is Ni that is enriched in ⁶²Ni to 98%-99.99%. In certain embodiments, the target metal is Ni that is enriched in ⁶²Ni to 99%-99.99%.

In certain embodiments, the target metal is Ni that is enriched in ⁶⁴Ni to 95%-99.99%. In certain embodiments, the target metal is Ni that is enriched in ⁶⁴Ni to 96%-99.99%. In certain embodiments, the target metal is Ni that is enriched in ⁶⁴Ni to 97%-99.99%. In certain embodiments, the target metal is Ni that is enriched in ⁶⁴Ni to 98%-99.99%. In certain embodiments, the target metal is Ni that is enriched in ⁶⁴Ni to 99%-99.99%. In certain embodiments, the target metal is Ni that is enriched in ⁶⁴Ni to 95%. In certain embodiments, the target metal is Ni that is enriched in ⁶⁴Ni to 96%. In certain embodiments, the target metal is Ni that is enriched in ⁶⁴Ni to 97%. In certain embodiments, the target metal is Ni that is enriched in ⁶⁴Ni to 98%. In certain embodiments, the target metal is Ni that is enriched in ⁶⁴Ni to 99%.

In certain embodiments, the target metal is Ni that is isotopically enriched in the minor isotope to 97% or more. In certain embodiments, the target metal is Ni that is enriched in ⁶⁰Ni to 97%-99.99%. In certain embodiments, the target metal is Ni that is enriched in ⁶⁰Ni to 98%-99.99%. In certain embodiments, the target metal is Ni that is enriched in ⁶⁰Ni to 99%-99.99%. In certain embodiments, the target metal is Ni that is enriched in ⁶¹Ni to 97%-99.99%. In certain embodiments, the target metal is Ni that is enriched in ⁶¹Ni to 98%-99.99%. In certain embodiments, the target metal is Ni that is enriched in ⁶¹Ni to 99%-99.99%. In certain embodiments, the target metal is Ni that is enriched in ⁶²Ni to 97%-99.99%. In certain embodiments, the target metal is Ni that is enriched in ⁶²Ni to 98%-99.99%. In certain embodiments, the target metal is Ni that is enriched in ⁶²Ni to 99%-99.99%. In certain embodiments, the target metal is Ni that is enriched in ⁶⁴Ni to 97%-99.99%. In certain embodiments, the target metal is Ni that is enriched in ⁶⁴Ni to 98%-99.99%. In certain embodiments, the target metal is Ni that is enriched in ⁶⁴Ni to 99%-99.99%. In certain embodiments, the target metal is Ni that is enriched in ⁶²Ni to 97%±1%.

In certain embodiments, the target metal is Ni that is isotopically enriched in the minor isotope to 99% or more. In certain embodiments, the target metal is Ni that is enriched in ⁶⁰Ni to 99%-99.99%. In certain embodiments, the target metal is Ni that is enriched in ⁶¹Ni to 99%-99.99%. In certain embodiments, the target metal is Ni that is enriched in ⁶²Ni to 99%-99.99%. In certain embodiments, the target metal is Ni that is enriched in ⁶⁴Ni to 99%-99.99%. In certain embodiments, the target metal is Ni that is enriched in ⁶⁰Ni to 99%±0.5%. In certain embodiments, the target metal is Ni that is enriched in ⁶¹Ni to 99%±0.5%.

Unless stated otherwise, the tolerance associated with a given enrichment value is f 0.1%.

4.1.2.1.2 Zinc

In certain embodiments, the target metal is Zn. In certain embodiments, the target metal is isotopically enriched in ⁶⁸Zn relative to natural Zn. Natural Zn is composed of five stable isotopes with ⁶⁴Zn being the most abundant isotope (49.17% natural abundance). The minor isotopes along with their natural abundance are ⁶⁶Zn (27.73%), ⁶⁷Zn (4.04%), ⁶⁸Zn (18.45%), and ⁷⁰Zn (0.61%).

In certain embodiments, the target metal is Zn that is isotopically enriched in ⁶⁸Zn to 95% or more, e.g., 95%-99.99%. In certain embodiments, the target metal is Zn and is isotopically enriched in ⁶⁸Zn to 99% or more.

4.1.2.2 Target Coating Purity

In aspects of the provided disclosure, the target coating, i.e., the electrochemically deposited material on the backing surface, is highly pure. In certain embodiments, nuclear bombardment of the present high-purity target coating provides a radionuclide composition of higher purity than if a lower purity target coating had been used. In certain embodiments, the target coating comprises one or more of: Cd≤0.0005 ppm, Co≤0.005 ppm, Pb≤0.005 ppm, Cu≤0.08 ppm, and Fe≤0.15 ppm.

In certain embodiments, the target metal is natural Ni having a chemical purity of 95%-99.99%, e.g., 96%-99.99%, 97%-99.99%, 98%-99.99%, or 99%-99.99%.

In certain embodiments, the target metal is natural Ni having a chemical purity of ≥95%, ≥96%, ≥97%, ≥98%, ≥99%.

In certain embodiments, the target metal is “Ni having a chemical purity of 95%-99.99%, e.g., 96.%-99.99%, 97%-99.99%, 98%-99.99%, or 99%-99.99%.

In certain embodiments, the target metal is Ni that is enriched in ⁶¹Ni having a chemical purity of 95%-99.99%, e.g., 96%-99.99%, 97%-99.99%, 98%-99.99%, or 99%-99.99%.

In certain embodiments, the target metal is Ni that is enriched in ⁶²Ni having a chemical purity of 95%-99.99%, e.g., 96%-99.99%, 97%-99.99%, 98%-99.99%, or 99%-99.99%.

In certain embodiments, the target metal is Ni that is enriched in ⁶⁴Ni having a chemical purity of 95%-99.99%, e.g., 96%-99.99%, 97%-99.99%, 98%-99.99%, or 99%-99.99%.

### 4.1.3. Target Coating Dimensions

The dimensions of the target coating of the present disclosure are not particularly limited. The dimensions can be adjusted, e.g., according to the intended use of the coin. In certain embodiments, the surface area, mass, and thickness of the target coating are selected to accommodate various kinds of irradiation processes. In certain embodiments, the surface area (e.g., based on diameter for a circular coin), mass, and/or thickness of the target coating are selected to optimize, e.g., the activity yield and/or the radionuclidic purity of the produced radionuclide compositions, for example, on the basis of knowledge of the beam properties and reaction cross-sections provided by particular cyclotrons.

4.1.3.1 Target Coating Thickness

In certain embodiments, the target coating has a thickness of 5 to 250 μm, e.g., 5 to 200 μm, 5 to 180 μm, 5 to 170 μm, 5 to 160 μm, 5 to 150 μm, 5 to 140 μm, 5 to 130 μm, 5 to 120 μm, 5 to 110 μm, 20 to 150 μm, 50 to 150 μm, 75 to 150 μm, 90 to 150 μm, 50 to 130 μm, or 70 to 100 μm.

In certain embodiments, the target coating has a thickness of 40 to 250 μm, e.g., 50 to 250 μm, 60 to 250 μm, 70 to 250 μm, 80 to 250 μm, 90 to 250 μm, 100 to 250 μm, 110 to 250 μm, 120 to 250 μm, 130 to 250 μm, 140 to 250 μm, 150 to 250 μm, 160 to 250 μm, 170 to 250 μm, 180 to 250 μm, 190 to 250 μm, 200 to 250 μm, 220 to 250 μm, 50 to 220 μm, 50 to 200 μm, 50 to 180 μm, 50 to 160 μm, 50 to 150 μm, 50 to 140 μm, 50 to 130 μm, 50 to 120 μm, 50 to 110 μm, 50 to 100 μm, 50 to 90 μm, 50 to 80 μm, 50 to 70 μm, 100, 125, 150, 175, 200, 225, or 250 μm, 100 μm, 125 μm, 150 μm, 175 μm, 200 μm, 225 μm, 250 μm.

4.1.3.2 Target Coating Mass

In certain embodiments, the target coating has a mass of 40 mg or more. In certain embodiments, the target coating has a mass of 45 mg or more. In certain embodiments, the target coating has a mass of 50 mg or more. In certain embodiments, the target coating has a mass of 60 mg or more. In certain embodiments, the target coating has a mass of 30 to 200 mg, 30 to 180 mg, 30 to 160 mg, 30 to 140 mg, 30 to 120 mg, 30 to 100 mg, 30 to 90 mg, 30 to 75 mg, 40 to 160 mg, 40 to 130 mg, 40 to 110 mg, 45 to 100 mg, 60 to 100 mg, 70 to 90 mg. In certain embodiments, the target coating has a mass of 75 to 85 mg, 65, 70, 75, 80, 85, or 90 mg, 65 mg, 70 mg, 75 mg, 80 mg, 85 mg, 90 mg. Unless otherwise stated, the tolerance in a provided mass value is ±3 mg.

In certain embodiments, electroplating occurs in an electrolytic cell with a fixed anode. In these embodiments, a thicker target coating metal deposition occurs in the center of the backing. This thicker target coating material occurs where the cyclotron beam is most intense, providing a greater effective surface area and volume for direct bombardment, which in turn enhances activation efficiency and subsequently enhanced dissolution rate of the irradiated target coating. In certain embodiments, the target coating has a variability in the thickness of the target coating across the surface of the coating by about 25%, 20%, 15%, 12%, 10%, 5%, or less. In certain embodiments, the variability is 15% or less. In certain embodiments, the variability is 10% or less. For example, in certain embodiments, the thickness of the coating is 15% thicker in the center compared to the thickness at the edges of the coating.

In certain embodiments, the target coating is 5-30% thicker at the center compared to an average thickness of the coating around the perimeter, e.g., 5%, 7%, 10% or 12% to 15%, 17%, 20%, 25%, or 30% thicker, including 5-15%, 5-20%, 10-15%, 10-17%, 10-20%, 10-25%, 12-15%, 12-17%, 15-20%, or 12-25%, particularly 10-15% thicker at the center compared to an average thickness of the coating around the perimeter.

In certain embodiments, the target coating is generally circular in shape, having a diameter of 3 cm or less, e.g., from 2.5 cm to about 0.75 cm. In certain embodiments, 95% of the target coating mass is within a radius of 2.5, 2.0, 1.5, 1.2, or 1 cm. In certain embodiments, the radius may vary by 10%, 7%, 5%, 3%, 2%, or 1%.

### 4.2. Target Diameter

In certain embodiments, the target coating is electrodeposited on a surface of a backing in a circular shape that has a diameter of 1 cm. In certain embodiments, the diameter is 5 mm to 1 cm, e.g., 5 mm to 500 mm, 5 mm to 250 mm, 5 mm to 100 mm, 10 mm-50 mm, 10 mm-25 mm, 8 mm-15 mm. In certain embodiments, the target coating is a circular shape and has a diameter of 10 mm or 13 mm±1 mm.

4.2.1.1 Durability of Target Coating

In certain embodiments, the target coating material remains intact on the surface of the coin after being transferred to and from the cyclotron, such as by means of a pneumatic coin transfer system. An advantage of the present coins is that the electroplated target coating is sufficiently durable to remain adhered to the backing under conditions of direct air flow and abrupt mechanical movements incurred during coin transfer.

In certain embodiments, the target coating remains adhered to the backing during pneumatic transfer both to and from the cyclotron. Such a pneumatic system is typically fed by a compressed air connection of 6-7 bar, and at minimum, 360 SLPM flow. Such a system is “push-push”, and therefore, compressed air is typically blown on both the front and rear sides of the coin, respectively, depending on the direction of transfer. In certain embodiments, the target coating remains adhered to the backing after the coin comes to an abrupt stop as it reaches the target station or hot cell.

In certain embodiments, suitable tests that indicate target coating durability include the following, whereby the total plating mass loss for all tests combined should be negligible (e.g. <2% w/w): Visual inspection, gentle knocking/tapping on a countertop on top of white paper to check for loosening of target coating grains, gently rubbing an acid-washed Teflon spatula against the deposited target coating and checking for loosening of target coating grains, and/or placing and gently pressing down on a piece of Scotch tape against the target coating.

If there is access to the cyclotron apparatus, it is recommended to transfer the coin back/forth multiple times and ensure target coating stability (i.e., no mass loss). Such a test may be performed with or without a degrader (e.g., a 500 μm thin sheet of Al of at least the same dimensions as the target coating or greater) in place.

### 4.3. Methods of Preparing a Coin

In a further aspect of the present disclosure, a method is provided for preparing a coin comprising a target metal according to the present disclosure as described herein, wherein the method comprises the steps of electroplating the dissolved target metal from a plating solution onto the backing surface; wherein the plating solution has a pH of 9.5-10.7.

### 4.3.1. Obtaining/Preparing the Backing

In certain embodiments, the backing is comprised of a corrosion-resistant material. In certain embodiments, the backing comprises Nb, Ag, Pt, Au, Al, or W. In certain embodiments, the backing comprises Nb or Ag. In certain embodiments, the backing consists of Nb.

In certain embodiments, the backing comprises high-purity Nb as described herein, and is used, for example in preparing high-purity radionuclide compositions.

In further embodiments of these methods, the method further comprises a step of abrading the backing surface. The method of abrading is not particularly limited and includes any kind of mechanical abrasion. In certain embodiments, the entire area of the backing surface to be electroplated is abraded, e.g., to ensure adhesion of the target coating and/or to remove any oxides or discoloration, which may interfere with the electroplating. In certain embodiments, the abrading is performed with a vibrational tumbler. In certain embodiments, the abrading is performed with a corundum grinding stone. In certain embodiments, the abrasion is performed with a Bosh Impact 12 hand grinder (pink corundum abrasive grit size 60) at 50 rpm for a duration of roughly 45 to 60 seconds to cover a surface area of about 650-550 mm².

### 4.3.2. Preparing the Plating Solution

An aspect of the present disclosure is that by utilizing a basic solution for the plating solution, a higher anode-cathode potential can be achieved that reduces plating times, e.g., to <3 hours compared to the 24 hours of commercially available platings. In addition, the presence of ammonia in the plating solution leads to a lower rate of hydrogen evolution, resulting in a more homogenous and uniform crystal structure and uniform micropores in structure of a target metal coating, e.g., plated layer of Ni or Zn. Without being bound by any particular theory, it is thought that this can be attributed to the chemical nature of NH₃ and its tendency to receive hydrogen atoms to form NH₄⁺.

In certain embodiments, a mass of 40 to 100 mg of target metal (e.g., ^{nat}Ni, ⁶⁰Ni, or ⁶¹Ni) is electroplated onto a backing surface to be used in a single bombardment session. In certain embodiments, a mass of 50 to 100 mg of target metal is electroplated onto a backing surface to be used in a single bombardment session to obtain a radionuclide, e.g., of ⁶¹Cu or ⁶⁸Ga, particularly ⁶¹Cu.

In an aspect of the present disclosure, a plating solution having a basic pH is provided. In certain embodiments, the pH of the plating solution is from 9 to 11, e.g., 9.5-10.7 or 10-10.4. In certain embodiments, the plating solution has a pH of 9.5-10.7. In certain embodiments, the plating solution has a pH of 10-10.4. Unless indicated otherwise, the tolerance of any pH value of the plating solution is 0.1.

In certain embodiments, preparing the plating solution comprises the step of dissolving the target metal starting material, e.g., metal powder, in nitric acid.

In certain embodiments, electroplating the target metal is from a plating solution wherein the plating solution comprises nitrate ions. In certain embodiments, the plating solution comprises or is prepared using aqueous HNO₃. In certain embodiments, the plating solution does not comprise sulfate ions.

In certain embodiments, the method further comprises the step of preparing a plating solution.

In certain embodiments, preparing the plating solution comprises dissolving the target metal starting material. In certain embodiments, the plating solution is prepared by combining the target metal and a molar excess of HNO₃. In certain embodiments, the HNO₃ is in the form of 65% nitric acid (aqueous) and is added to the plating solution in excess of 40 grams HNO₃ per gram target metal (e.g., HNO₃:Ni 40 g:1 g).

In certain embodiments, a mass of 20 to 200 mg of target metal (e.g., ^{nat}Ni, ⁶⁰Ni, or ⁶¹Ni) is dissolved in the plating solution. In certain embodiments, a mass of 50 to 100 mg of target metal is dissolved in the plating solution. In certain embodiments, the mass of target metal dissolved in the plating solution is 20 mg, 25 mg, 30 mg, 35 mg, 40 mg, 45 mg, 50 mg, 55 mg, 60 mg, 65 mg, 70 mg, 75 mg, 80 mg, 85 mg, 90 mg, 95 mg, 100 mg, 105 mg, 110 mg, 115 mg, 120 mg, 125 mg, 130 mg, 135 mg, 140 mg, 145 mg, 150 mg, 155 mg, 160 mg, 165 mg, 170 mg, 175 mg, 180 mg, 185 mg, 190 mg, 195 mg, or 200 mg. In certain embodiments, a mass of 50 mg of target metal is dissolved in the plating solution. In certain embodiments, a mass of 100 mg of target metal is dissolved in the plating solution. Unless otherwise stated, the target mass has a tolerance of 3 mg.

In certain embodiments, preparing the plating solution comprises preparing a buffer solution by combining ammonium chloride and ammonium hydroxide in water. In certain embodiments, the plating solution is an ammonium buffer solution. In certain embodiments, the plating solution is or comprises ammonium ions. In certain embodiments, the buffer solution has a pH of 9.2-9.40, e.g., 9.28-9.30. In certain embodiments, the buffer solution has a pH of about 9.3 (at room temperature).

In certain embodiments, preparing the plating solution comprises adding a buffer solution to the plating solution comprising ammonium ions. In certain embodiments, a plating solution is prepared by contacting a metal salt with a buffer solution. In certain embodiments, a plating solution is prepared by contacting a metal nitrate with a buffer solution. In certain embodiments, a plating solution is prepared by contacting nickel nitrate with a buffer solution. In certain embodiments, a plating solution comprises a metal salt dissolved in a buffer solution. In certain embodiments, a plating solution comprises a nickel salt dissolve in a buffer solution. In certain embodiments, the plating solution comprises dissolved metal ions. In certain embodiments, the plating solution comprises dissolved metal ions for electrodeposition. In certain embodiments, the plating solution comprises ammonium ions and a dissolved metal for electrodeposition. In certain embodiments, the plating solution comprises nickel ions. In certain of these embodiments, the plating solution comprises the dissolved target metal.

In certain embodiments, the plating solution comprises ^{nat}Ni and/or ⁶⁰Ni or a salt thereof. In certain embodiments, the plating solution comprises ^{nat}Ni or a salt thereof. In certain embodiments, the plating solution comprises ⁶⁰Ni or a salt thereof. In certain embodiments, the plating solution comprises ⁶¹Ni or a salt thereof.

In certain embodiments, the plating solution has a pH of 8.5 to 11. In certain embodiments, the pH of the plating solution is 8 to 10.8. In certain embodiments, the pH is 8.10 to 10.6, 8.2 to 10.5, 8.3 to 10.4, 8.5 to 10.3, 8.6 to 10.25, 8.7 to 10.2, 8.5 to 10.15, 8.5 to 10.1, 8.5 to 10, 8.5 to 9.9, 8.5 to 9.80, 8.5 to 9.6, 8.5 to 9.50, 8.5 to 9.4, 8.5 to 9.3, 8.5 to 9.2, 8.5 to 9.1, or 8.5 to 9. In certain embodiments, the plating solution has a pH of 9, 9.50, 10, 10.05, 10.10, 10.15, 10.20, 10.25, 10.30, 10.35, 10.40, 10.50, 10.60, or 10.70, 9, 10, 10.05, 10.10, 10.15, 10.20, 10.25, 10.30, 10.35, or 10.40.

In certain embodiments, the step of preparing the plating solution further comprises adjusting the pH of the plating solution, e.g., after addition of the buffer, by adding an effective amount of NH₄OH to achieve a particular pH value for the plating solution.

In further embodiments, the step of adjusting the pH of the plating solution further adding NH₄OH, e.g., dropwise, to the plating solution until a desired pH is reached.

### 4.3.3. Purity of Electroplating Solution

An aspect of the present disclosure is the provision of a high-purity plating solution for use in the production of high-purity radionuclide compositions. Frequent sources of trace metals are the target metal starting material itself, especially enriched nickel, reagents and instruments used. Iron is common and requires careful consideration to be reduced from the environment in which the plating solution is prepared. Reagents are selected to reduce impurities.

In certain embodiments of the provided methods, the target metal is selected from those described in this disclosure. In certain embodiments, the target metal used to prepare the plating solution (i.e., target metal source material) is in the form of a metal salt, oxide or elemental metal. In certain of these embodiments, metal oxide or metal (e.g., rod, granules, powder) is at least 98% pure, based on trace metals analysis. In certain embodiments, the target metal source material is at least 99.9% pure based on trace metals analysis. In certain embodiments, the target metal source material is at least 99.99% pure based on trace metals analysis. In certain embodiments, the target metal source material comprises no more than 150 ppm sum trace metal impurities.

In certain embodiments, the method of preparing a coin further comprises a method of purifying the plating solution prior to the electroplating step. In certain embodiments, purifying the plating solution is according to known methods to reduce dissolved Cu, Zn, Fe, Co, Sn, Ti, and/or Al from the plating solution. In certain embodiments, purifying is according to known methods to reduce Cu, Zn, Fe, Sn, Ti, and/or Al from the plating solution. In certain embodiments, purifying is according to known methods to reduce Cu, Zn, and/or Fe from the plating solution. In certain embodiments, purifying is according to known methods to reduce Cu from solutions.

In certain embodiments, the plating solution comprises Cu≤0.1 ppm, Cu≤0.2 ppm, Cu≤0.3 ppm, Cu≤0.4 ppm, Cu≤0.5 ppm, Cu≤0.6 ppm, Cu≤0.7 ppm, Cu≤0.8 ppm, Cu≤0.9 ppm, Cu≤10 ppm, Cu≤10.1 ppm, Cu≤10.2 ppm, Cu≤10.3 ppm, Cu≤10.4 ppm, Cu≤10.5 ppm, Cu≤10.6 ppm, Cu≤10.7 ppm, Cu≤10.8 ppm, Cu≤10.9 ppm, Cu≤11 ppm, Cu≤12 ppm, Cu s 13 ppm, Cu s 14 ppm, Cu 15 ppm, Cu≤16 ppm, Cu 17 ppm, Cu≤18 ppm, Cu≤19 ppm, or Cu≤20 ppm. In certain embodiments, the plating solution comprises Cu≤0.1 ppm. In certain embodiments, the plating solution comprises Cu≤0.2 ppm. In certain embodiments, the plating solution comprises Cu≤0.3 ppm. In certain embodiments, the plating solution comprises Cu≤0.4 ppm. In certain embodiments, the plating solution comprises Cu≤0.5 ppm. In certain embodiments, the plating solution comprises Cu≤0.6 ppm. In certain embodiments, the plating solution comprises Cu≤0.7 ppm. In a particular embodiment, the plating solution comprises Cu≤0.1 ppm.

In certain embodiments of the provided methods, the plating solution comprises Fe≤10 ppm. In certain embodiments, the plating solution comprises Fe≤1 ppm, Fe≤5 ppm, Fe≤10 ppm, Fe≤15 ppm, Fe≤20 ppm, Fe≤25 ppm, Fe≤30 ppm, Fe≤32 ppm, or Fe≤35 ppm. In certain embodiments, the plating solution comprises Fe≤1 ppm. In certain embodiments, the plating solution comprises Fe≤5 ppm. In certain embodiments, the plating solution comprises Fe≤10 ppm. In certain embodiments, the plating solution comprises Fe≤15 ppm. In certain embodiments, the plating solution comprises Fe≤20 ppm. In certain embodiments, the plating solution comprises Fe≤25 ppm. In certain embodiments, the plating solution comprises Fe≤30 ppm. In certain embodiments, the plating solution comprises Fe≤32 ppm. In certain embodiments, the plating solution comprises Fe≤35 ppm.

In certain embodiments of the provided methods, the below identified elements are limited to the provided thresholds. That is, in certain embodiments, the plating solution comprises one or more of the following:
Ga, Lu, Pb, and/or Y are individually≤0.1 ppm;
Zn and/or Co are individually≤0.3 ppm;
Cd, Cr, Al, Mn, Mo, Sn, Ti, and/or V are individually≤1 ppm; and
Family I and/or II elements are individually≤1000 ppm.

In certain embodiments, the highest grades of reagents should be used, to avoid trace metal contamination of the target coating, as more than a tenth of a microgram per 100 mg of target metal (that is, 1 ppm of the target metal) is already a significant contamination that may render the coin unusable for production of high-purity radionuclides. In the case of the production of radiocopper it is not accepted to add more than 0.1 ppm of cold Cu as this would reduce the purity of the prepared radionuclide composition.

In certain embodiments of the provided methods of preparing the plating solution, the maximum level of impurities allowed to be added by this process to the target metal starting material (refer to trace metal analysis of supplied starting material) are:
Copper (Cu)≤0.1 ppm;
High affinity metals (Ga, Lu, Pb, Y) are individually≤0.1 ppm;
Zinc and cobalt (Zn, Co) are individually≤0.3 ppm;
Transition and other metals (Cd, Cr, Al, Mn, Mo, Sn, Ti, V, etc.) are individually: 1 ppm;
Iron (Fe)≤10 ppm; and
Family I and II (K, Ba, Mg, Be, etc.) are individually≤1000 ppm.

In certain embodiments of the provided methods of preparing the plating solution impart only very small amounts of impurities to the solution. In these embodiments, the maximum level of impurities added by this process to the target metal starting material (e.g., ^{nat}Ni and enriched Ni isotopes) in comparison to the trace metal analysis of supplied starting material are limited to:
Silver (Ag): ≤0.2 ppm;
Cobalt (Co): ≤0.5 ppm;
Chromium (Cr): ≤0.2 ppm;
Copper (Cu): ≤0.3 ppm;
Iron (Fe): ≤32 ppm;
Potassium (K): ≤0.2 ppm;
Magnesium (Mg): ≤0.1 ppm;
Manganese (Mn): ≤0.1 ppm;
Sodium (Na): ≤3.2 ppm; and
Titanium (Ti): ≤0.1 ppm.

In certain embodiments of the provided methods of preparing the plating solution, the maximum level of impurities tolerated by this process to the target metal (e.g., ^{nat}Zn and ^{xx}Zn isotopes) starting material (refer to trace metal analysis of supplied starting material) are one or more of the following:
High-affinity metals (Ga, Cu, Lu, Pb, Y): are individually≤0.1 ppm;
Zinc and cobalt (Zn, Co) are individually≤0.3 ppm;
Transition and other metals (Ca, Cd, Cr, Al, Mn, Mo, Sn, Ti, V . . . ) are individually≤1 ppm;
Iron (Fe): are individually≤10 ppm; and
Family I and II (K, Ba, Mg, Be, etc.): are individually≤1000 ppm.

### 4.3.4. Electroplating

In certain embodiments, the electroplating occurs at a current of 100 to 380 μA. In certain embodiments, the electroplating occurs at a current of 100 to 360 μA, of 100 to 340 μA, of 100 to 320 μA, of 100 to 300 μA, of 100 to 280 μA, of 100 to 260 μA, of 100 to 240 μA, of 100 to 220 μA, of 100 to 210 μA, of 100 to 200 μA, of 100 to 180 μA, of 100 to 170 μA, of 100 to 160 μA, of 120 to 380 μA, of 140 to 380 μA, of 160 to 380 μA, of 180 to 380 μA, of 200 to 380 μA, of 220 to 380 μA, of 240 to 380 μA, of 260 to 380 μA, of 280 to 380 μA, of 300 to 380 μA, of 320 to 380 μA, of 120 to 350 μA, of 120 to 320 μA, of 120 to 300 μA, of 120 to 280 μA, of 120 to 260 μA, of 120 to 240 μA, of 120 to 220 μA, of 120 to 200 μA. In certain embodiments, the electroplating occurs at a current of 120 to 180 μA, of 130 to 170 μA, of 140 to 170 μA, of 150 to 170 μA. In certain embodiments, the electroplating occurs at a current of 155 to 165 μA. In certain embodiments, the electroplating occurs at a current of 140, 145, 150, 155, 160, 165, 170, 175, or 180 μA. In certain embodiments, the electroplating occurs at a current of 140 μA. In certain embodiments, the electroplating occurs at a current of 145 μA. In certain embodiments, the electroplating occurs at a current of 150 μA. In certain embodiments, the electroplating occurs at a current of 155 μA. In certain embodiments, the electroplating occurs at a current of 160 μA. In certain embodiments, the electroplating occurs at a current of 165 μA. In certain embodiments, the electroplating occurs at a current of 170 μA. In certain embodiments, the electroplating occurs at a current of 175 μA. In certain embodiments, the electroplating occurs at a current of 180 μA. Unless indicated otherwise, the tolerance of any provided current value is f 0.3 μA.

In certain embodiments, the electroplating occurs at a voltage of 2.5-6.5 V. In certain embodiments, the electroplating occurs at a voltage of 3.5-6 V. In certain embodiments, the electroplating occurs at a voltage of 3.25, 3.50, 3.75, 4.0, 4.25, 4.50, 4.75, 5.0, 5.25, 5.50, 5.75, or 6 V, or within a range defined by any two of these values. For example, the electroplating occurs at a voltage of 4.25-5.25 V or from 4.5-5.5 V. In certain embodiments, the electroplating occurs at a voltage of 5.5 V. Unless indicated otherwise, the tolerance of any provided voltage value is ±0.2 V.

In certain embodiments, the electroplating occurs at a temperature of 15-30° C. In certain embodiments, the electroplating occurs at a temperature of 20-25° C. Unless indicated otherwise, the tolerance of any provided temperature value is ±0.5° C.

In certain embodiments, the electroplating occurs in a cycle time of ≤5 hours. In certain embodiments, the electroplating occurs in a cycle time of ≤4 hours. In certain embodiments, the electroplating occurs in a cycle time of ≤3 hours. In certain embodiments, the electroplating occurs in a cycle time of ≤2 hours. In certain embodiments, the electroplating occurs in a cycle time of ≤90 minutes. In these embodiments a cycle can comprise plating a single coin, two coins, three coins or more in a batch process.

In certain embodiments, the electroplating occurs under one or more conditions selected from: a voltage of 3.5-5.5 V; temperature of 20-25° C.; and a cycle time of ≤3 hours. In certain embodiments, the electroplating occurs under two or more conditions selected from: a voltage of 3.5-5.5 V; temperature of 20-25° C.; and a cycle time of ≤3 hours. In certain embodiments, the electroplating occurs under all three conditions selected from: a voltage of 3.5-5.5 V; temperature of 20-25° C.; and a cycle time of ≤3 hours.

In certain embodiments, the electroplating occurs with a plating solution volume of 30, 25, 20, 15, 12, 10, 7, or 5 mL or less, in particular 10 mL or less.

In certain embodiments, the electroplating occurs in an electrolytic cell comprising a fixed anode. In certain embodiments, the anode is selected from a graphite anode and a platinum anode. In certain embodiments, the anode is 99.999% trace metal free by weight. In certain embodiments, the anode is a platinum anode. In certain embodiments, the platinum anode is in the form of a wire or foil.

### 4.4. Methods of Making a High-Purity Radionuclide Composition

An aspect of the disclosure provided herein is the provision of a method of making a high-purity radionuclide composition. The method comprises: irradiation of the target metal of the coin in a particle accelerator according to the present disclosure to produce an irradiated target coating; and isolation of the produced high-purity radionuclide composition.

In certain embodiments, the coin comprises a high-purity Nb backing as described herein. In further embodiments, the coin comprises a target coating prepared as described herein.

An overview of a production process for preparing a copper radionuclide ^{x}Cu (e.g., ⁶⁰Cu, ⁶¹Cu, ⁶²Cu, or ⁶⁴Cu) is given below:

In certain embodiments of the method of producing high-purity radionuclides, isolating comprises dissolving the irradiated target coating in aqueous HCl solution to obtain a radionuclide chloride solution, such as a [^{x}Cu]CuCl₂ aqueous solution. In certain of these embodiments, the aqueous HCl solution is a 10 M HCl solution.

### 4.4.1. Bombardment

Highly pure compositions comprising positron emitting isotopes of copper suitable for medical use, e.g., in diagnostic imaging or through a Positron Emission Tomography (PET) scan, such as ⁶⁰Cu, ⁶¹Cu, ⁶²Cu, and ⁶⁴Cu, can be produced by the deuteron or proton bombardment of a coin prepared according to the present disclosure (e.g., highly pure Nb backing with a target coating comprising stable nickel or zinc isotopes) through a particle accelerator. Certain embodiments of the nuclear reactions and corresponding production routes possible using a small hospital cyclotron are as listed in Table 1 below:

TABLE 1
Production methods of positron-emitting copper isotopes, ⁶⁰Cu, ⁶¹Cu, ⁶²Cu, ⁶⁴Cu, and ⁶⁷Cu.

| | | Incident beam | Typical target metal | |
|---|---|---|---|---|
| Isotope | Reaction | energy (MeV) | enrichment (%) | Reference |
| ⁶⁰Cu | ⁶⁰Ni(p,n)⁶⁰Cu | 11 | >99 | (Pejman Rowshanfarzada, 2006) |
| ⁶¹Cu | natNi(d,n)⁶¹Cu | 8.4 | N/A | (Pejman Rowshanfarzada, 2006), |
| | ⁶⁰Ni(d,n)⁶¹Cu | 8.4 | >99 | (Johan Svedjehed, 2020), |
| | ⁶¹Ni(p,n)⁶¹Cu | 11-13 | | (F. Szelecsényi, 2005) |
| | ⁶⁴Zn(p,α)⁶¹Cu | 14.5 | | |
| ⁶²Cu | ⁶²Ni(p,n)⁶²Cu | 5-14 | >97.0 | (Heike Piel, 1992) |
| ⁶⁴Cu | ⁶⁴Ni(p,n)⁶⁴Cu | 11-12 | >95.0 | (Maite Jauregui-Osoroa, 2021) |
| | ⁶⁸Zn(p,αn)⁶⁴Cu | 11-12 | >99.0 | (V. H. P. Alves, 2017) |
| ⁶⁷Cu | ⁶⁸Zn(p,2p)⁶⁷Cu | 20-70 | Natural - >99% | (Nicholas A. Smith, 2012) |
| | ⁷⁰Zn(p,α)⁶⁷Cu | 16-20 | Natural - 99.7% | |

In various of these embodiments, the radionuclide is a Cu radionuclide. In certain embodiments, the radionuclide is ⁶¹Cu. In certain embodiments, the radionuclide is prepared according to ^{nat}Ni(d,n)⁶¹Cu. In certain embodiments, the radionuclide is prepared according to ⁶⁰Ni(d,n)⁶¹Cu. In certain embodiments, the radionuclide is prepared according to ⁶¹Ni(p,n)⁶¹Cu.

In certain embodiments, the radionuclide is ⁶⁴Cu. In certain embodiments, the radionuclide is prepared according to ⁶⁴Ni(p,n)⁶⁴Cu.

In certain embodiments, the radionuclide is ⁶⁷Cu. In certain embodiments, the radionuclide is prepared according to ⁶⁸Zn(p,2p)⁶⁷Cu or ⁷⁰Zn(p,α)⁶⁷Cu.

4.4.1.1 Bombardment Time

In certain embodiments of the method of producing high-purity radionuclides, the irradiation occurs for one half-life of the radionuclide. In certain of these embodiments, the irradiation is from 60-220 minutes. In certain embodiments, the irradiation is from 30-200 minutes. In certain embodiments, the irradiation is from 50-180 minutes. In certain embodiments, the irradiation is from 60-180 minutes. In certain embodiments, the irradiation is from 80-180 minutes. In certain embodiments, the irradiation is from 90-180 minutes. In certain embodiments, the irradiation is from 100-180 minutes. In certain embodiments, the irradiation is from 110-180 minutes. In certain embodiments, the irradiation is from 120-180 minutes. In certain embodiments, the irradiation is from 30-160 minutes. In certain embodiments, the irradiation is from 30-140 minutes. In certain embodiments, the irradiation is from 30-120 minutes. In certain embodiments, the irradiation is from 30-110 minutes. In certain embodiments, the irradiation is from 30-100 minutes. In certain embodiments, the irradiation is from 30-90 minutes. In certain embodiments, the irradiation is from 30-80 minutes. In certain embodiments, the irradiation is from 30-70 minutes. In certain embodiments, the irradiation is from 30-60 minutes. In certain embodiments, the irradiation is 30, 45, 60, 75, 90, 105, 120, 135, 150, or 165 minutes. In certain embodiments, the irradiation is 30 minutes. In certain embodiments, the irradiation is 45 minutes. In certain embodiments, the irradiation is 60 minutes. In certain embodiments, the irradiation is 30 minutes. In certain embodiments, the irradiation is 75 minutes. In certain embodiments, the irradiation is 90 minutes. In certain embodiments, the irradiation is 105 minutes. In certain embodiments, the irradiation is 120 minutes. In certain embodiments, the irradiation is 135 minutes. In certain embodiments, the irradiation is 150 minutes. In certain embodiments, the irradiation is 165 minutes. In certain embodiments, the irradiation is 200 minutes. In certain embodiments, the irradiation is 220 minutes.

4.4.1.2 Bombardment Particles

In certain embodiments of the method of producing high-purity radionuclides, irradiation comprises: bombarding the target metal with protons, deuterons, or alpha particles. In certain embodiments, the bombardment beam is selected from protons, deuterons, alpha particles, and photons. In certain embodiments, the bombardment beam is selected from protons, deuterons, electrons, and photons. In certain embodiments, the bombardment beam is selected from protons and deuterons. In certain embodiments, the bombardment beam is selected from protons and deuterons. In certain embodiments, the bombardment beam comprises deuterons. In certain embodiments, the bombardment beam comprises protons. In certain embodiments, the bombardment beam comprises alpha particles. In certain embodiments, the bombardment beam comprises photons.

4.4.1.3 Deuteron Bombardment Energy

In certain embodiments of the method of producing high-purity radionuclides, the target metal is bombarded with deuterons having a beam energy≤9, 3-9, or 8-9 MeV. In certain embodiments, the beam energy is 1-10 MeV, 3-9 MeV, 5-9 MeV, 6-9 MeV, 7-9 MeV, 8-9 MeV, 8.1 MeV, 8.2 MeV, 8.3 MeV, 8.4 MeV, 8.5 MeV, 8.6 MeV, 8.7 MeV, 8.8 MeV, or 8.9 MeV.

4.4.1.4 Deuteron Bombardment Current

In certain embodiments of producing high-purity radionuclides, the target metal is bombarded with deuterons with beam current≤100 μA, e.g., 10-100 μA, 10-60 μA, 10-50 μA, 20-60 μA, 30-60 μA, 40-60 μA, 20-50 μA, 30-50 μA, 35-50 μA, 40-60 μA, 40-55 μA, 40-50 μA, or 40-45 μA.

In certain of these embodiments, the target metal comprises ^{nat}Ni, ⁶⁰Ni, or ⁶¹Ni. In these embodiments, the high-purity radionuclide composition comprises ⁶¹Cu.

In certain embodiments of the method of producing high-purity radionuclides, the target metal is bombarded with deuterons having one or both of a beam energy≤9 MeV and/or a beam current≤100 μA.

4.4.1.5 Proton Bombardment Energy

In certain embodiments, the target metal is bombarded with protons having a beam energy of 7-20 MeV, e.g., 7-18 MeV, 7-16 MeV, 7-14 MeV, 7-12 MeV, 7-10 MeV, 8-18 MeV, 9-18 MeV, 10-18 MeV, 11-18 MeV, 12-18 MeV, 13-18 MeV, 8-16 MeV, 9-15 MeV, 10-14 MeV, 11-14 MeV, 12-14 MeV, 13-14 MeV, 13.1 MeV, 13.2 MeV, 13.3 MeV, 13.4 MeV, 13.5 MeV, 13.6 MeV, 13.7 MeV, 13.8 MeV, or 13.9 MeV.

4.4.1.6 Proton Bombardment Current

In certain embodiments, the target metal is bombarded with protons having a beam current of 10-150 μA, e.g., 10-140 μA, 10-130 μA, 10-120 μA, 10-110 μA, 10-100 μA, 10-90 μA, 10-80 μA, 20-150 μA, 30-150 μA, 50-150 μA, 60-150 μA, 70-150 μA, 80-150 μA, 90-150 μA, 100-150 μA, 110-150 μA, 75 μA, 80 μA, 85 μA, 90 μA, or 100 μA.

In certain of these embodiments, the target metal comprises ⁶¹Ni and the radionuclide is a ⁶¹Cu radionuclide. In certain of these embodiments, the target metal comprises ⁶⁰Ni and the radionuclide is a ⁶⁰Cu radionuclide. In certain of these embodiments, the target metal comprises ⁶⁴Ni and the radionuclide is a ⁶⁴Cu radionuclide. In certain of these embodiments, the target metal comprises ⁶⁴Zn and the radionuclide is a ⁶¹Cu radionuclide. In certain of these embodiments, the target metal comprises ⁶⁸Zn and the radionuclide is a ⁶⁴Cu radionuclide.

In certain embodiments, the radionuclide is prepared according to ^{nat}Ni(d,n)⁶¹Cu.

In certain embodiments, the radionuclide is prepared according to ⁶⁰Ni(d,n)⁶¹Cu.

In certain embodiments, the radionuclide is prepared according to ⁶¹Ni(p,n)⁶¹Cu.

In certain embodiments, the radionuclide is prepared according to ⁶⁴Zn(p,α)⁶¹Cu.

In certain embodiments, the radionuclide is ⁶⁴Cu. In certain embodiments, the radionuclide is prepared according to ⁶⁴Ni(p,n)⁶⁴Cu, e.g., on a particle accelerator such as a medical cyclotron.

In certain embodiments, the radionuclide is prepared according to ⁶⁸Zn(p,αn)⁶⁴Cu.

### 4.4.2. Purification

In certain embodiments, separation and purification of the high-purity radionuclide (for example, as a [^{x}Cu]CuCl₂ aqueous solution) is accomplished using a cassette-based FASTlab platform. In certain embodiments, a TBP (tributylphosphate-based) resin is used, e.g., (1 mL) (particle size 50-100 μm; pre-packed, Triskem®). In certain embodiments, a weakly basic resin is used, e.g., (tertiary amine; TK201) (2 mL) (particle size 50-100 μm; pre-packed, Triskem®). In certain embodiments, the resin is pre-conditioned with H₂O (7 mL) and HCl (10M, 7 mL). In certain embodiments, cassette reagent vials were prepared using concentrated HCl (Optima Grade, Fischer Scientific), NaCl (ACS, Fischer Scientific) and/or milli-Q water (Millipore system, 18 MΩ-cm resistivity), e.g., 6M HCl (2×4.2 mL), 5M NaCl in 0.05 M HCl (4.2 mL). In certain embodiments, the obtained ⁶¹Cu was then purified with two subsequent ion exchange resins in a FASTlab synthesis unit. In certain embodiments the acid-adjusted dissolution solution (approx. 7 mL) was loaded over both columns in series and directed into a “Ni collection fraction”. In certain embodiments a TBP resin is implemented as a guard column as it quantitatively retained Fe³⁺ ions, while the Cu²⁺ and Co²⁺ complexes were quantitatively retained on the tertiary amine (TK201) resin. In certain embodiments, both columns are used and washed with 6M HCl (4 mL) to maximize Ni recovery for future recycling. In certain embodiments, the TK201 column was washed with HCl, e.g., 4.5M (5.5 mL) to elute most cobalt salts into the waste stream. In certain embodiments, the TK201 column is washed with HCl, e.g., 5M NaCl in 0.05M (4 mL) to decrease residual acid on the resin and further remove any residual cobalt salts. In certain embodiments, the TK201 column was washed with HCl, e.g., of 0.05M (3 mL) to quantitatively elute the [⁶¹Cu]CuCl₂.

### 4.5. Radionuclide Compositions

In a further aspect of the present disclosure is the provision of a radionuclide composition, e.g., of [⁶¹Cu]CuCl₂. In various embodiments, a radionuclide composition is produced by the bombardment of a target metal by subatomic particles, e.g., irradiated with protons, deuterons, electrons, or alpha particles, particularly protons or deuterons.

In certain embodiments, the radionuclide composition is in the form of an aqueous solution, e.g., an aqueous solution that comprises a radionuclide in a salt, such as [⁶¹Cu]CuCl₂. In certain embodiments, a radioactive composition is dissolved in a HCl solution.

In various embodiments, the radionuclide composition is in the form of a lyophilized halide salt. In various embodiments, the radionuclide composition is in the form of a lyophilized chloride salt.

### 4.5.1. Radionuclidic Purity

The term “radionuclidic purity” refers to the ratio of the radionuclide, expressed as a percentage of total radioactivity content of a radionuclide containing composition. As reported herein, unless otherwise specified, radionuclidic purity is determined by high resolution gamma spectroscopy (e.g., high-purity germanium (HPGe) detector) on a sample after expiration, e.g. >8 hours or >3 weeks) and is then extrapolated (e.g., using the TENDLE-2019 database according to procedures well known in the art), and reported herein as the value at the end of synthesis (EoB+2 hours) of the radionuclide.

Radionuclidic purity at “end of synthesis” or “EoS” refers to a measurement at the time the final radionuclide composition is obtained, e.g., after dissolution and optional purification. Unless otherwise stated, EoS is EoB plus 90 minutes.

Various methods for purifying produced copper radioisotopes are known to those of skill in the art, see for example, INTERNATIONAL ATOMIC ENERGY AGENCY, Production of Emerging Radionuclides towards Theranostic Applications: copper-61, Scandium-43 and -44, and Yttrium-86, IAEA-TECDOC-1955, IAEA, Vienna (2021) and the references cited therein. For example, trialkylphosphate and ion exchange-based purification schemes relevant to Cu, such as either ⁶¹Cu or ⁶⁴Cu purification, are generally applicable.

In various embodiments, the radionuclide composition has a radionuclidic purity at end of synthesis (EoB plus 90 minutes) of ≥95.0%. In certain embodiments, the high-purity composition comprises a ^{6x}Cu radionuclide, e.g., ⁶¹Cu, ⁶⁴Cu, or ⁶⁷Cu. In certain embodiments, the high-purity composition comprises ⁶⁴Cu, for example, for use as a diagnostic agent. In other embodiments, the high-purity composition comprises ⁶⁷Cu for use as a therapeutic agent. In certain embodiments, the high-purity composition comprises ⁶¹Cu, for example, for use in radiolabeling a radiotracer for medical use, such as in diagnostic imaging.

In various embodiments, the high-purity composition comprises ⁶¹Cu and has a radionuclidic purity at end of synthesis of ≥97.0%.

In certain embodiments, the radionuclide composition, e.g., a high-purity radionuclide, comprising ⁶¹Cu, ⁶⁴Cu, or ⁶⁷Cu, particularly ⁶¹Cu, is characterized by one or more of the following purity requirements:
^{110m}Ag≤0.1 Bq/g;
^{108m}Ag≤0.1 Bq/g; and
¹⁰⁹Cd≤0.1 Bq/g.

Considering radiocobalt impurities, the ⁶⁴Ni(p,α) reaction produces ⁶¹Co (t½=1.649 h), with other radiocobalt impurities (e.g., ⁵⁵Co, etc.) arising largely from the small quantities of other (A≠64) Ni isotopes in the isotopically enriched starting material. In the context of ⁶¹Cu, however, among other reactions on other Ni isotopes, the dominant ⁶¹Ni(p,α) and ⁶⁰Ni(d,α) reactions will give rise to long lived ⁵⁸Co (t½=70.86 d) producing 0.05% and 0.11% of ⁵⁸Co relative activity compared with ⁶¹Cu, respectively. As such, efficient purification of the radionuclide composition from radiocobalt by-products may prove to be even more important in the context of ⁶¹Cu purification. In considering QC of ⁶¹Cu, Section 2.6 of the IAEA Radioisotopes and Radiopharmaceuticals Reports No. 1 [INTERNATIONAL ATOMIC ENERGY AGENCY, Cyclotron produced radionuclides: Emerging positron emitters for medical applications: ⁶⁴Cu and ¹²⁴I, Radioisotopes and Radiopharmaceuticals Reports 1, IAEA, Vienna (2016) 63, incorporated herein in its entirety] presents in great detail on ⁶⁴Cu radionuclidic purity, and apparent molar activity.

In certain embodiments, the high-purity radionuclide composition is produced via the deuteron irradiation of natural nickel or ⁶⁰Ni, or via the proton irradiation of ⁶¹Ni, wherein the composition comprises one or more of the following:
⁵⁶Co≤1500 Bq/g;
⁵⁷Co≤100 Bq/g;
⁵⁸Co≤15000 Bq/g; and
⁶⁰Co≤15 Bq/g.

In certain embodiments, the high-purity radionuclide composition is produced via the deuteron irradiation of natural nickel or ⁶⁰Ni, or via the proton irradiation of ⁶¹Ni, wherein the composition comprises two or more of the following:
⁵⁶Co≤1500 Bq/g;
⁵⁷Co≤100 Bq/g;
⁵⁸Co≤15000 Bq/g;
⁶⁰Co≤15 Bq/g; and/or
having two or more of the following:
^{110m}Ag≤1 Bq/g;
^{108m}Ag≤1 Bq/g; and
¹⁰⁹Cd≤1 Bq/g.

In certain embodiments, the high-purity radionuclide composition is produced via the deuteron irradiation of natural nickel or ⁶⁰Ni, or via the proton irradiation of ⁶¹Ni, wherein the radionuclide is not a Cu radionuclide and the composition comprises one or more of the following:
^{110m}Ag≤0.1 Bq/g;
^{108m}Ag≤0.1 Bq/g; and
¹⁰⁹Cd≤0.1 Bq/g.

### 4.5.2. Chemical Purity

The term “chemical purity,” as used herein, is understood to represent the molar percent of the identified or desired radionuclide to all metals in the sample. The radionuclide compositions prepared by the disclosed methods herein exhibit high chemical purity, which facilitates the production of radiopharmaceuticals with high radiochemical purity.

Radiochemical purity, as understood herein, is the ratio or percent of radioactivity from the desired radionuclide in the radiopharmaceutical to the total radioactivity of the sample that includes the radiopharmaceutical. Non-radioactive isotopes of metals (“cold” metals) will not contribute to the total radioactivity of a sample, but they can compete with the desired radionuclide for inclusion in the radiopharmaceutical, e.g., competing for chelation sites in the radiopharmaceutical.

In certain embodiments, the radionuclide composition according to the present disclosure has a chemical purity of ≥99.0% by mole. In certain embodiments, the radionuclide composition is prepared according to the methods provided herein.

In certain embodiments, the radionuclide composition is an aqueous solution and is characterized by one or more of the following:
Fe≤2 mg/L;
⁶⁹Cu and ⁶⁵Cu together are ≤1 mg/L;
Zn≤2 mg/L;
Sn≤0.01 mg/L;
Ti≤0.01 mg/L;
Al≤2 mg/L;
As≤1 mg/L;
Ni≤1 mg/L; and
   wherein any one of Cr, Cd, Co, and Y is ≤0.1 mg/mL.

In certain embodiments, the radionuclide composition is an aqueous solution and is characterized by comprising Fe≤2 mg/L. In some embodiments, the radionuclide composition is an aqueous solution characterized by comprising Fe≤2 mg/L, ≤1.9 mg/L, ≤1.8 mg/L, ≤1.7 mg/L, ≤1.6 mg/L, ≤1.5 mg/L, ≤1.4 mg/L, ≤1.3 mg/L, ≤1.2 mg/L, ≤1.1 mg/L, ≤1 mg/L, ≤0.9 mg/L, ≤0.8 mg/L, ≤0.7 mg/L, ≤0.6 mg/L, ≤0.5 mg/L, ≤0.4 mg/L, ≤0.3 mg/L, ≤0.2 mg/L, or ≤0.1 mg/L.

In certain embodiments, the radionuclide composition is an aqueous solution and is characterized by the sum of ⁶⁹Cu and ⁶⁵Cu≤1 mg/L. In certain embodiments, the radionuclide composition is an aqueous solution and is characterized by the sum of ⁶⁹Cu and ⁶⁵Cu≤1 mg/L, ≤1 mg/L, ≤0.9 mg/L, ≤0.8 mg/L, ≤0.7 mg/L, ≤0.6 mg/L, ≤0.5 mg/L, ≤0.4 mg/L, ≤0.3 mg/L, ≤0.2 mg/L, ≤0.1 mg/L≤0.09 mg/L, ≤0.08 mg/L, ≤0.07 mg/L, ≤0.06 mg/L, ≤0.05 mg/L, ≤0.04 mg/L, ≤0.03 mg/L, ≤0.02 mg/L, or ≤0.01 mg/L.

In certain embodiments, the radionuclide composition is an aqueous solution and is characterized by comprising Ni≤1 mg/L, ≤1 mg/L, ≤0.9 mg/L, ≤0.8 mg/L, ≤0.7 mg/L, ≤0.6 mg/L, ≤0.5 mg/L, ≤0.4 mg/L, ≤0.3 mg/L, ≤0.2 mg/L, ≤0.1 mg/L≤0.09 mg/L, ≤0.08 mg/L, ≤0.07 mg/L, ≤0.06 mg/L, ≤0.05 mg/L, ≤0.04 mg/L, ≤0.03 mg/L, ≤0.02 mg/L, or ≤0.01 mg/L.

In certain embodiments, the radionuclide composition is an aqueous solution and is characterized by comprising Zn≤2 mg/L, ≤1.9 mg/L, ≤1.8 mg/L, ≤1.7 mg/L, ≤1.6 mg/L, ≤1.5 mg/L, ≤1.4 mg/L, ≤1.3 mg/L, ≤1.2 mg/L, ≤1.1 mg/L, ≤1 mg/L, ≤0.9 mg/L, ≤0.8 mg/L, ≤0.7 mg/L, ≤0.6 mg/L, ≤0.5 mg/L, ≤0.4 mg/L, ≤0.3 mg/L, ≤0.2 mg/L, or ≤0.1 mg/L.

In certain embodiments, the radionuclide composition is an aqueous solution and is characterized by comprising Sn≤0.1 mg/L, ≤0.09 mg/L, ≤0.08 mg/L, ≤0.07 mg/L, ≤0.06 mg/L, ≤0.05 mg/L, ≤0.04 mg/L, ≤0.03 mg/L, ≤0.02 mg/L, ≤0.01 mg/L, ≤0.009 mg/L, ≤0.008 mg/L, ≤0.007 mg/L, ≤0.006 mg/L, ≤0.005 mg/L, ≤0.004 mg/L, ≤0.003 mg/L, ≤0.002 mg/L, or ≤0.001 mg/L.

In certain embodiments, the radionuclide composition is an aqueous solution and is characterized by comprising Ti≤0.1 mg/L, ≤0.09 mg/L, ≤0.08 mg/L, ≤0.07 mg/L, ≤0.06 mg/L, ≤0.05 mg/L, ≤0.04 mg/L, ≤0.03 mg/L, ≤0.02 mg/L, ≤0.01 mg/L, ≤0.009 mg/L, ≤0.008 mg/L, ≤0.007 mg/L, ≤0.006 mg/L, ≤0.005 mg/L, ≤0.004 mg/L, ≤0.003 mg/L, ≤0.002 mg/L, or ≤0.001 mg/L.

In certain embodiments, the radionuclide composition is an aqueous solution and is characterized by comprising Al 2 mg/L, ≤1.9 mg/L, ≤1.8 mg/L, ≤1.7 mg/L, ≤1.6 mg/L, ≤1.5 mg/L, ≤1.4 mg/L, ≤1.3 mg/L, ≤1.2 mg/L, ≤1.1 mg/L, ≤1 mg/L, ≤0.9 mg/L, ≤0.8 mg/L, ≤0.7 mg/L, ≤0.6 mg/L, ≤0.5 mg/L, ≤0.4 mg/L, ≤0.3 mg/L, ≤0.2 mg/L, or ≤0.1 mg/L.

In certain embodiments, the radionuclide composition is an aqueous solution and is characterized by comprising As≤1 mg/L, ≤0.9 mg/L, ≤0.8 mg/L, ≤0.7 mg/L, ≤0.6 mg/L, ≤0.5 mg/L, ≤0.4 mg/L, ≤0.3 mg/L, ≤0.2 mg/L, ≤0.1 mg/L≤0.09 mg/L, ≤0.08 mg/L, ≤0.07 mg/L, ≤0.06 mg/L, ≤0.05 mg/L, ≤0.04 mg/L, ≤0.03 mg/L, ≤0.02 mg/L, ≤0.01 mg/L, ≤0.009 mg/L, ≤0.008 mg/L, ≤0.007 mg/L, ≤0.006 mg/L, ≤0.005 mg/L, ≤0.004 mg/L, ≤0.003 mg/L, ≤0.002 mg/L, or ≤0.001 mg/L.

In certain embodiments, the radionuclide composition is an aqueous solution and is characterized by comprising Cr≤0.1 mg/L≤0.09 mg/L, ≤0.08 mg/L, ≤0.07 mg/L, ≤0.06 mg/L, ≤0.05 mg/L, ≤0.04 mg/L, ≤0.03 mg/L, ≤0.02 mg/L, ≤0.01 mg/L, ≤0.009 mg/L, ≤0.008 mg/L, ≤0.007 mg/L, ≤0.006 mg/L, ≤0.005 mg/L, ≤0.004 mg/L, ≤0.003 mg/L, ≤0.002 mg/L, or ≤0.001 mg/L.

In certain embodiments, the radionuclide composition is an aqueous solution and is characterized by comprising Cd≤0.1 mg/L≤0.09 mg/L, ≤0.08 mg/L, ≤0.07 mg/L, ≤0.06 mg/L, ≤0.05 mg/L, ≤0.04 mg/L, ≤0.03 mg/L, ≤0.02 mg/L, ≤0.01 mg/L, ≤0.009 mg/L, ≤0.008 mg/L, ≤0.007 mg/L, ≤0.006 mg/L, ≤0.005 mg/L, ≤0.004 mg/L, ≤0.003 mg/L, ≤0.002 mg/L, or ≤0.001 mg/L.

In certain embodiments, the radionuclide composition is an aqueous solution and is characterized by comprising Co≤0.1 mg/L≤0.09 mg/L, ≤0.08 mg/L, ≤0.07 mg/L, ≤0.06 mg/L, ≤0.05 mg/L, ≤0.04 mg/L, ≤0.03 mg/L, ≤0.02 mg/L, ≤0.01 mg/L, ≤0.009 mg/L, ≤0.008 mg/L, ≤0.007 mg/L, ≤0.006 mg/L, ≤0.005 mg/L, ≤0.004 mg/L, ≤0.003 mg/L, ≤0.002 mg/L, or ≤0.001 mg/L.

In certain embodiments, the radionuclide composition is an aqueous solution and is characterized by comprising Y≤0.1 mg/L≤0.09 mg/L, ≤0.08 mg/L, ≤0.07 mg/L, ≤0.06 mg/L, ≤0.05 mg/L, ≤0.04 mg/L, ≤0.03 mg/L, ≤0.02 mg/L, ≤0.01 mg/L, ≤0.009 mg/L, ≤0.008 mg/L, ≤0.007 mg/L, ≤0.006 mg/L, ≤0.005 mg/L, ≤0.004 mg/L, ≤0.003 mg/L, ≤0.002 mg/L, or ≤0.001 mg/L.

In certain embodiments, trace metal analysis is conducted by ICP-MS, e.g., >3 weeks.

In certain embodiments, the sum of impurities in the radionuclide composition is ≤15 μg/GBq.

In certain embodiments, the radionuclide composition is characterized by Cu≤1.5 μg/GBq, e.g., ≤1.0 μg/GBq; or ≤0.5 μg/GBq.

In certain embodiments, the radionuclide composition is characterized by Al≤3.0 μg/GBq, e.g., ≤2.5 μg/GBq; or ≤2 μg/GBq.

In certain embodiments, the radionuclide composition is characterized by Co≤2 μg/GBq, e.g., ≤1.5 μg/GBq; or ≤1 μg/GBq.

In certain embodiments, the radionuclide composition is characterized by Fe≤4 μg/GBq, e.g., ≤3.5 μg/GBq; or ≤3 μg/GBq.

In certain embodiments, the radionuclide composition is characterized by Pb≤3 μg/GBq, e.g., ≤2.5 μg/GBq; or ≤2 μg/GBq.

In certain embodiments, the radionuclide composition is characterized by Ni≤3 μg/GBq, e.g., ≤2.50 μg/GBq; or ≤2 μg/GBq.

In certain embodiments, the radionuclide composition is characterized by Zn≤2 μg/GBq, e.g., ≤1.5 μg/GBq; or ≤1 μg/GBq.

### 4.5.3. Copper Isotopes

Highly pure radiocopper compositions comprising ⁶⁰Cu, ⁶¹Cu, ⁶²Cu, ⁶⁴Cu, or ⁶⁷Cu are produced through the deuteron, proton, electron, or alpha particle bombardment of a coin prepared as described herein. In certain embodiments, the coin comprises a highly pure Nb backing, a target metal (e.g., a nickel isotope or a mixture thereof, or a zinc isotope, or mixture thereof) through a particle accelerator such as a cyclotron as described herein.

In certain embodiments, a high-purity copper radionuclide composition is obtained according to any one of the target metals, isotope enrichment levels, and incident beam energy described in in Table 1 below; wherein the irradiation occurs in a cyclotron (e.g., a medical cyclotron).

### 4.6. Characterization of a [⁶¹Cu]CuCl₂ Solution

Radionuclidic solutions provided by the methods and materials described herein are characterized according to various properties and attributes. In some embodiments, for example, activity concentration can be determined by a dose calibrator; pH value can be determined by pH paper; radiochemical purity can be determined by radio thin-layer chromatography; radionuclidic purity and/or identity can be determined by gamma spectrometry; and chemical purity can be determined by inductively couple plasma mass spectrometry (ICP-MS). Among the non-limiting characterization profiles of radionuclidic and radiochemical compositions of the present disclosure, high-purity [⁶¹Cu]CuCl₂ may be measured according to some of the properties below.

### 4.6.1. Appearance

In certain embodiments, composition comprising a radioactive copper salt (e.g., [⁶¹Cu]CuCl₂) as provided herein is characterized by a color or mixture of colors. In certain embodiments, a radioactive copper salt aqueous solution (e.g., [⁶¹Cu]CuCl₂) is the color blue. In certain embodiments, a radioactive copper salt aqueous solution (e.g., [⁶¹Cu]CuCl₂) is the color green. In certain embodiments, a radioactive copper salt aqueous solution (e.g., [⁶¹Cu]CuCl₂) is the color turquoise. In certain embodiments, a radioactive copper salt aqueous solution (e.g., [⁶¹Cu]CuCl₂) is colorless.

### 4.6.2. Activity

In certain embodiments, the radionuclide composition as described herein, is further characterized by one or more of: an activity concentration of 0.01-23.33 GBq/mL at calibration; a molar activity of 10-580 MBq/nmol at calibration; and an activity at end of synthesis of >500 MBq. An embodiment, as described above, further characterized by one or more of: an activity concentration of >25 MBq/mL at calibration, a molar activity of 10-580 MBq/nmol at calibration, and an activity at the end of synthesis of >150 MBq.

In certain embodiments, a radionuclide composition comprises a [⁶¹Cu]CuCl₂ activity at end of synthesis of ≥500 MBq, ≥490 MBq, ≥480 MBq, ≥470 MBq, ≥460 MBq, ≥450 MBq, ≥440 MBq, ≥430 MBq, ≥420 MBq, ≥410 MBq, ≥400 MBq, ≥390 MBq, ≥380 MBq, ≥370 MBq, ≥360 MBq, ≥350 MBq, ≥340 MBq, ≥330 MBq, ≥320 MBq, ≥310 MBq, ≥300 MBq, ≥290 MBq, ≥280 MBq, ≥270 MBq, ≥260 MBq, ≥250 MBq, ≥240 MBq, ≥230 MBq, ≥220 MBq, ≥210 MBq, ≥200 MBq, ≥190 MBq, ≥180 MBq, ≥170 MBq, ≥160 MBq, ≥150 MBq, ≥140 MBq, ≥130 MBq, ≥120 MBq, ≥110 MBq, ≥100 MBq, ≥90 MBq, ≥80 MBq, ≥70 MBq, ≥60 MBq, ≥50 MBq, ≥40 MBq, ≥30 MBq, ≥20 MBq, or ≥10 MBq.

In certain embodiments, a radionuclide composition comprises a [⁶¹Cu]CuCl₂ activity at end of synthesis of >500 MBq.

In certain embodiments, a radionuclide composition comprises a [⁶¹Cu]CuCl₂ activity at end of synthesis of >150 MBq.

4.6.2.1 Activity Concentration

In certain embodiments, a composition comprising [⁶¹Cu]CuCl₂ as provided herein is characterized by an activity concentration of 50-400 MBq/mL, 55-395 MBq/mL, 60-390 MBq/mL, 65-385 MBq/mL, 70-380 MBq/mL, 75-375 MBq/mL, 80-370 MBq/mL, 85-365 MBq/mL, 90-360 MBq/mL, 95-355 MBq/mL, 100-350 MBq/mL, 105-345 MBq/mL, 110-340 MBq/mL, 115-335 MBq/mL, 120-330 MBq/mL, 125-325 MBq/mL, 130-320 MBq/mL, 135-315 MBq/mL, 140-310 MBq/mL, 145-305 MBq/mL, 150-300 MBq/mL, 155-295 MBq/mL, 160-290 MBq/mL, 165-285 MBq/mL, 170-280 MBq/mL, 175-275 MBq/mL, 180-270 MBq/mL, 185-265 MBq/mL, 190-260 MBq/mL, 195-255 MBq/mL, 200-250 MBq/mL, 205-245 MBq/mL, 210-240 MBq/mL, 215-235 MBq/mL, or 220-230 MBq/mL.

In certain embodiments, a composition comprising [⁶¹Cu]CuCl₂ as provided herein is characterized by an activity concentration of ≥400 MBq/mL, ≥395 MBq/mL, ≥390 MBq/mL, ≥385 MBq/mL, ≥380 MBq/mL, ≥375 MBq/mL, ≥370 MBq/mL, ≥365 MBq/mL, ≥360 MBq/mL, ≥355 MBq/mL, ≥350 MBq/mL, ≥345 MBq/mL, ≥340 MBq/mL, ≥335 MBq/mL, ≥330 MBq/mL, ≥325 MBq/mL, ≥320 MBq/mL, ≥315 MBq/mL, ≥310 MBq/mL, ≥305 MBq/mL, ≥300 MBq/mL, ≥295 MBq/mL, ≥290 MBq/mL, ≥285 MBq/mL, ≥280 MBq/mL, ≥275 MBq/mL, ≥270 MBq/mL, ≥265 MBq/mL, ≥260 MBq/mL, ≥255 MBq/mL, ≥250 MBq/mL, ≥245 MBq/mL, ≥240 MBq/mL, ≥235 MBq/mL, ≥230 MBq/mL, ≥225 MBq/mL, ≥220 MBq/mL, ≥215 MBq/mL, ≥210 MBq/mL, ≥205 MBq/mL, ≥200 MBq/mL, ≥195 MBq/mL, ≥190 MBq/mL, ≥185 MBq/mL, ≥180 MBq/mL, ≥175 MBq/mL, ≥170 MBq/mL, ≥165 MBq/mL, ≥160 MBq/mL, ≥155 MBq/mL, ≥150 MBq/mL, ≥145 MBq/mL, ≥140 MBq/mL, ≥135 MBq/mL, ≥130 MBq/mL, ≥125 MBq/mL, ≥120 MBq/mL, ≥115 MBq/mL, ≥110 MBq/mL, ≥105 MBq/mL, ≥100 MBq/mL, ≥95 MBq/mL, ≥90 MBq/mL, ≥85 MBq/mL, ≥80 MBq/mL, ≥75 MBq/mL, ≥70 MBq/mL, 65 MBq/mL, ≥60 MBq/mL, ≥55 MBq/mL, ≥50 MBq/mL, ≥45 MBq/mL, or ≥40 MBq/mL.

In certain embodiments, a radionuclide composition comprises a [⁶¹Cu]CuCl₂ activity concentration at calibration of ≥30 MBq/mL, ≥29 MBq/mL, ≥28 MBq/mL, ≥27 MBq/mL, ≥26 MBq/mL, ≥25 MBq/mL, ≥24 MBq/mL, ≥23 MBq/mL, ≥22 MBq/mL, ≥21 MBq/mL, ≥20 MBq/mL, ≥19 MBq/mL, ≥18 MBq/mL, 17 MBq/mL, ≥16 MBq/mL, 15 MBq/mL, ≥14 MBq/mL, ≥13 MBq/mL, ≥12 MBq/mL, ≥11 MBq/mL, ≥10 MBq/mL, 9 MBq/mL, ≥8 MBq/mL, ≥7 MBq/mL, ≥6 MBq/mL, ≥5 MBq/mL, ≥4 MBq/mL, ≥3 MBq/mL, ≥2 MBq/mL, or ≥1 MBq/mL.

In certain embodiments, a radionuclide composition comprises a [⁶¹Cu]CuCl₂ activity concentration at calibration of 0.01-25 GBq/mL.

In certain embodiments, a radionuclide composition comprises a [⁶¹Cu]CuCl₂ activity concentration at calibration of 0.01-30 GBq/mL, 0.50-29.50 GBq/mL, 1-29 GBq/mL, 1.50-28.50 GBq/mL, 2-28 GBq/mL, 2.50-27.50 GBq/mL, 3-27 GBq/mL, 3.50-26.50 GBq/mL, 4-26 GBq/mL, 4.50-25.50 GBq/mL, 5-25 GBq/mL, 5.50-24.50 GBq/mL, 6-24 GBq/mL, 6.50-23.50 GBq/mL, 7-23 GBq/mL, 7.50-22.50 GBq/mL, 8-22 GBq/mL, 8.50-21.50 GBq/mL, 9-21 GBq/mL, 9.50-20.50 GBq/mL, 10-20 GBq/mL, 10.50-19.50 GBq/mL, 11-19 GBq/mL, 11.50-18.50 GBq/mL, 12-18 GBq/mL, 12.50-17.50 GBq/mL, 13-17 GBq/mL, 13.50-16.50 GBq/mL, 14-16 GBq/mL, or 14.50-15.50 GBq/mL.

In certain embodiments, a radionuclide composition comprises a [⁶¹Cu]CuCl₂ activity concentration at calibration of 0.01-3 GBq/mL, 0.05-2.95 GBq/mL, 0.10-2.90 GBq/mL, 0.15-2.85 GBq/mL, 0.20-2.80 GBq/mL, 0.25-2.75 GBq/mL, 0.30-2.70 GBq/mL, 0.35-2.65 GBq/mL, 0.40-2.60 GBq/mL, 0.45-2.55 GBq/mL, 0.50-2.50 GBq/mL, 0.55-2.45 GBq/mL, 0.60-2.40 GBq/mL, 0.65-2.35 GBq/mL, 0.70-2.30 GBq/mL, 0.75-2.25 GBq/mL, 0.80-2.20 GBq/mL, 0.85-2.15 GBq/mL, 0.90-2.10 GBq/mL, 0.95-2.05 GBq/mL, 1-2 GBq/mL, 1.05-1.95 GBq/mL, 1.10-1.90 GBq/mL, 1.15-1.85 GBq/mL, 1.20-1.80 GBq/mL, 1.25-1.75 GBq/mL, 1.30-1.70 GBq/mL, 1.35-1.65 GBq/mL, 1.40-1.60 GBq/mL, or 1.45-1.55 GBq/mL.

In certain embodiments, a radionuclide composition comprises a [⁶¹Cu]CuCl₂ activity concentration at calibration of 0.25-0.50 GBq/mL, 0.50-0.75 GBq/mL, 0.75-1 GBq/mL, 1-1.25 GBq/mL, 1.25-1.50 GBq/mL, 1.50-1.75 GBq/mL, 1.75-2 GBq/mL, 2-2.25 GBq/mL, 2.25-2.50 GBq/mL, 2.50-2.75 GBq/mL, 2.75-3 GBq/mL, 3-3.25 GBq/mL, 3.25-3.50 GBq/mL, 3.50-3.75 GBq/mL, 3.75-4 GBq/mL, 4-4.25 GBq/mL, 4.25-4.50 GBq/mL, 4.50-4.75 GBq/mL, 4.75-5 GBq/mL, 5-5.25 GBq/mL, 5.25-5.50 GBq/mL, 5.50-5.75 GBq/mL, 5.75-6 GBq/mL, 6-6.25 GBq/mL, 6.25-6.50 GBq/mL, 6.50-6.75 GBq/mL, 6.75-7 GBq/mL, 7-7.25 GBq/mL, 7.25-7.50 GBq/mL, 7.50-7.75 GBq/mL, 7.75-8 GBq/mL, 8-8.25 GBq/mL, 8.25-8.50 GBq/mL, 8.50-8.75 GBq/mL, 8.75-9 GBq/mL, 9-9.25 GBq/mL, 9.25-9.50 GBq/mL, 9.50-9.75 GBq/mL, 9.75-10 GBq/mL, 10-10.25 GBq/mL, 10.25-10.50 GBq/mL, 10.50-10.75 GBq/mL, 10.75-11 GBq/mL, 11-11.25 GBq/mL, 11.25-11.50 GBq/mL, 11.50-11.75 GBq/mL, 11.75-12 GBq/mL, 12-12.25 GBq/mL, 12.25-12.50 GBq/mL, 12.50-12.75 GBq/mL, 12.75-13 GBq/mL, 13-13.25 GBq/mL, 13.25-13.50 GBq/mL, 13.50-13.75 GBq/mL, 13.75-14 GBq/mL, 14-14.25 GBq/mL, 14.25-14.50 GBq/mL, 14.50-14.75 GBq/mL, 14.75-15 GBq/mL, 15-15.25 GBq/mL, 15.25-15.50 GBq/mL, 15.50-15.75 GBq/mL, 15.75-16 GBq/mL, 16-16.25 GBq/mL, 16.25-16.50 GBq/mL, 16.50-16.75 GBq/mL, 16.75-17 GBq/mL, 17-17.25 GBq/mL, 17.25-17.50 GBq/mL, 17.50-17.75 GBq/mL, 17.75-18 GBq/mL, 18-18.25 GBq/mL, 18.25-18.50 GBq/mL, 18.50-18.75 GBq/mL, 18.75-19 GBq/mL, 19-19.25 GBq/mL, 19.25-19.50 GBq/mL, 19.50-19.75 GBq/mL, 19.75-20 GBq/mL, 20-20.25 GBq/mL, 20.25-20.50 GBq/mL, 20.50-20.75 GBq/mL, 20.75-21 GBq/mL, 21-21.25 GBq/mL, 21.25-21.50 GBq/mL, 21.50-21.75 GBq/mL, 21.75-22 GBq/mL, 22-22.25 GBq/mL, 22.25-22.50 GBq/mL, 22.50-22.75 GBq/mL, 22.75-23 GBq/mL, 23-23.25 GBq/mL, 23.25-23.50 GBq/mL, 23.50-23.75 GBq/mL, 23.75-24 GBq/mL, 24-24.25 GBq/mL, 24.25-24.50 GBq/mL, 24.50-24.75 GBq/mL, or 24.75-25 GBq/mL.

4.6.2.2 Molar Activity

In certain embodiments, a composition according to the present disclosure is characterized by a [⁶¹Cu]CuCl₂ molar activity concentration at calibration of 10-600 MBq/nmol, 25-600 GBq/nmol, 50-600 GBq/nmol, 75-600 GBq/nmol, 100-600 GBq/nmol, 125-600 GBq/nmol, 150-600 GBq/nmol, 175-600 GBq/nmol, 200-600 GBq/nmol, 225-600 GBq/nmol, 250-600 GBq/nmol, 275-600 GBq/nmol, 300-600 GBq/nmol, 325-600 GBq/nmol, 350-600 GBq/nmol, 375-600 GBq/nmol, 400-600 GBq/nmol, 425-600 GBq/nmol, 450-600 GBq/nmol, 475-600 GBq/nmol, 500-600 GBq/nmol, 525-600 GBq/nmol, 550-600 GBq/nmol, or 575-600 GBq/nmol.

In certain embodiments, a composition according to the present disclosure is characterized by a [⁶¹Cu]CuCl₂ molar activity concentration at calibration of 10-25 GBq/nmol, 10-50 GBq/nmol, 10-75 GBq/nmol, 10-100 GBq/nmol, 10-125 GBq/nmol, 10-150 GBq/nmol, 10-175 GBq/nmol, 10-200 GBq/nmol, 10-225 GBq/nmol, 10-250 GBq/nmol, 10-275 GBq/nmol, 10-300 GBq/nmol, 10-325 GBq/nmol, 10-350 GBq/nmol, 10-375 GBq/nmol, 10-400 GBq/nmol, 10-425 GBq/nmol, 10-450 GBq/nmol, 10-475 GBq/nmol, 10-500 GBq/nmol, 10-525 GBq/nmol, 10-550 GBq/nmol, 10-575 GBq/nmol, 25-600 GBq/nmol, 50-575 GBq/nmol, 75-550 GBq/nmol, 100-525 GBq/nmol, 125-500 GBq/nmol, 150-475 GBq/nmol, 175-450 GBq/nmol, 200-425 GBq/nmol, 225-400 GBq/nmol, 250-375 GBq/nmol, 275-350 GBq/nmol, or 300-325 GBq/nmol.

In certain embodiments, a composition according to the present disclosure is characterized by a [⁶¹Cu]CuCl₂ molar activity concentration at calibration of 10-150 MBq/nmol, 20-150 MBq/nmol, 30-150 MBq/nmol, 40-150 MBq/nmol, 50-150 MBq/nmol, 60-150 MBq/nmol, 70-150 MBq/nmol, 80-150 MBq/nmol, 90-150 MBq/nmol, 100-150 MBq/nmol, 110-150 MBq/nmol, 120-150 MBq/nmol, 130-150 MBq/nmol, 140-150 MBq/nmol, 10-140 MBq/nmol, 10-130 MBq/nmol, 10-120 MBq/nmol, 10-110 MBq/nmol, 10-100 MBq/nmol, 10-90 MBq/nmol, 10-80 MBq/nmol, 10-70 MBq/nmol, 10-60 MBq/nmol, 10-50 MBq/nmol, 10-40 MBq/nmol, 10-30 MBq/nmol, 10-20 MBq/nmol, 10-80 MBq/nmol, 20-90 MBq/nmol, 30-100 MBq/nmol, 40-110 MBq/nmol, 50-120 MBq/nmol, 60-130 MBq/nmol, or 70-140 MBq/nmol.

In certain embodiments, a radionuclide composition comprises a [⁶¹Cu]CuCl₂ molar activity concentration at calibration of 10-150 MBq/nmol.

### 4.6.3. pH

In certain embodiments, composition comprising [⁶¹Cu]CuCl₂ as provided herein is characterized by a pH of 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, 0.99, 1, 1.01, 1.02, 1.03, 1.04, 1.05, 1.06, 1.07, 1.08, 1.09, 1.1, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.31, 1.32, 1.33, 1.34, 1.35, 1.36, 1.37, 1.38, 1.39, 1.4, 1.41, 1.42, 1.43, 1.44, 1.45, 1.46, 1.47, 1.48, 1.49, 1.5, 1.51, 1.52, 1.53, 1.54, 1.55, 1.56, 1.57, 1.58, 1.59, 1.6, 1.61, 1.62, 1.63, 1.64, 1.65, 1.66, 1.67, 1.68, 1.69, or 1.7.

In certain embodiments, the pH of a [⁶¹Cu]CuCl₂ solution is 1-1.6. In certain embodiments, the pH is 1.05-1.55, 1.10-1.45, 1.15-1.35, 1.20-1.25.

In certain embodiments, the pH of a [⁶¹Cu]CuCl₂ solution is from 0.11 to 1.7, 0.12 to 1.69, 0.13 to 1.68, 0.14 to 1.67, 0.15 to 1.66, 0.16 to 1.65, 0.17 to 1.64, 0.18 to 1.63, 0.19 to 1.62, 0.2 to 1.61, 0.21 to 1.6, 0.22 to 1.59, 0.23 to 1.58, 0.24 to 1.57, 0.25 to 1.56, 0.26 to 1.55, 0.27 to 1.54, 0.28 to 1.53, 0.29 to 1.52, 0.3 to 1.51, 0.31 to 1.5, 0.32 to 1.49, 0.33 to 1.48, 0.34 to 1.47, 0.35 to 1.46, 0.36 to 1.45, 0.37 to 1.44, 0.38 to 1.43, 0.39 to 1.42, 0.4 to 1.41, 0.41 to 1.4, 0.42 to 1.39, 0.43 to 1.38, 0.44 to 1.37, 0.45 to 1.36, 0.46 to 1.35, 0.47 to 1.34, 0.48 to 1.33, 0.49 to 1.32, 0.5 to 1.31, 0.51 to 1.3, 0.52 to 1.29, 0.53 to 1.28, 0.54 to 1.27, 0.55 to 1.26, 0.56 to 1.25, 0.57 to 1.24, 0.58 to 1.23, 0.59 to 1.22, 0.6 to 1.21, 0.61 to 1.2, 0.62 to 1.19, 0.63 to 1.18, 0.64 to 1.17, 0.65 to 1.16, 0.66 to 1.15, 0.67 to 1.14, 0.68 to 1.13, 0.69 to 1.12, 0.7 to 1.11, 0.71 to 1.1, 0.72 to 1.09, 0.73 to 1.08, 0.74 to 1.07, 0.75 to 1.06, 0.76 to 1.05, 0.77 to 1.04, 0.78 to 1.03, 0.79 to 1.02, 0.8 to 1.01, 0.81 to 1, 0.82 to 0.99, 0.83 to 0.98, or 0.84 to 0.97.

### 4.6.4. Radionuclidic Purity

In certain embodiments, a composition comprising [⁶¹Cu]CuCl₂ as provided herein is characterized by a radionuclidic purity of ≥99.99%, ≥99.98%, ≥99.97%, ≥99.96%, ≥99.95%, ≥99.94%, ≥99.93%, ≥99.92%, ≥99.91%, ≥99.90%, ≥99.89%, ≥99.88%, ≥99.87%, ≥99.86%, ≥99.85%, ≥99.84%, ≥99.83%, ≥99.82%, ≥99.81%, ≥99.80%, ≥99.79%, ≥99.78%, ≥99.77%, ≥99.76%, ≥99.75%, ≥99.74%, ≥99.73%, ≥99.72%, ≥99.71%, ≥99.70%, ≥99.69%, ≥99.68%, ≥99.67%, ≥99.66%, ≥99.65%, ≥99.64%, ≥99.63%, ≥99.62%, ≥99.61%, ≥99.60%, ≥99.59%, ≥99.58%, ≥99.57%, ≥99.56%, ≥99.55%, ≥99.54%, ≥99.53%, ≥99.52%, ≥99.51%, ≥99.50%, ≥99.49%, ≥99.48%, ≥99.47%, ≥99.46%, ≥99.45%, ≥99.44%, ≥99.43%, ≥99.42%, ≥99.41%, ≥99.40%, ≥99.39%, ≥99.38%, ≥99.37%, ≥99.36%, ≥99.35%, ≥99.34%, ≥99.33%, ≥99.32%, ≥99.31%, ≥99.30%, ≥99.29%, ≥99.28%, ≥99.27%, ≥99.26%, ≥99.25%, ≥99.24%, ≥99.23%, ≥99.22%, ≥99.21%, ≥99.20%, ≥99.19%, ≥99.18%, ≥99.17%, ≥99.16%, ≥99.15%, ≥99.14%, ≥99.13%, ≥99.12%, ≥99.11%, ≥99.10%, ≥99.09%, ≥99.08%, ≥99.07%, ≥99.06%, ≥99.05%, ≥99.04%, ≥99.03%, ≥99.02%, ≥99.01%, ≥99.00%, ≥98.99%, ≥98.98%, ≥98.97%, ≥98.96%, ≥98.95%, ≥98.94%, ≥98.93%, ≥98.92%, ≥98.91%, ≥98.90%, ≥98.89%, ≥98.88%, ≥98.87%, ≥98.86%, ≥98.85%, ≥98.84%, ≥98.83%, ≥98.82%, ≥98.81%, ≥98.80%, ≥98.79%, ≥98.78%, ≥98.77%, ≥98.76%, ≥98.75%, ≥98.74%, ≥98.73%, ≥98.72%, ≥98.71%, ≥98.70%, ≥98.69%, ≥98.68%, ≥98.67%, ≥98.66%, ≥98.65%, ≥98.64%, ≥98.63%, ≥98.62%, ≥98.61%, ≥98.60%, ≥98.59%, ≥98.58%, ≥98.57%, ≥98.56%, ≥98.55%, ≥98.54%, ≥98.53%, ≥98.52%, ≥98.51%, ≥98.50%, ≥98.49%, ≥98.48%, ≥98.47%, ≥98.46%, ≥98.45%, ≥98.44%, ≥98.43%, ≥98.42%, ≥98.41%, ≥98.40%, ≥98.39%, ≥98.38%, ≥98.37%, ≥98.36%, ≥98.35%, ≥98.34%, ≥98.33%, ≥98.32%, ≥98.31%, ≥98.30%, ≥98.29%, ≥98.28%, ≥98.27%, ≥98.26%, ≥98.25%, ≥98.24%, ≥98.23%, ≥98.22%, ≥98.21%, ≥98.20%, ≥98.19%, ≥98.18%, ≥98.17%, ≥98.16%, ≥98.15%, ≥98.14%, ≥98.13%, ≥98.12%, ≥98.11%, ≥98.10%, ≥98.09%, ≥98.08%, ≥98.07%, ≥98.06%, ≥98.05%, ≥98.04%, ≥98.03%, ≥98.02%, ≥98.01%, ≥98.00%, ≥97.99%, ≥97.98%, ≥97.97%, ≥97.96%, ≥97.95%, ≥97.94%, ≥97.93%, ≥97.92%, ≥97.91%, ≥97.90%, ≥97.89%, ≥97.88%, ≥97.87%, ≥97.86%, ≥97.85%, ≥97.84%, ≥97.83%, ≥97.82%, ≥97.81%, ≥97.80%, ≥97.79%, ≥97.78%, ≥97.77%, ≥97.76%, ≥97.75%, ≥97.74%, ≥97.73%, ≥97.72%, ≥97.71%, ≥97.70%, ≥97.69%, ≥97.68%, ≥97.67%, ≥97.66%, ≥97.65%, ≥97.64%, ≥97.63%, ≥97.62%, ≥97.61%, ≥97.60%, ≥97.59%, ≥97.58%, ≥97.57%, ≥97.56%, ≥97.55%, ≥97.54%, ≥97.53%, ≥97.52%, ≥97.51%, ≥97.50%, ≥97.49%, ≥97.48%, ≥97.47%, ≥97.46%, ≥97.45%, ≥97.44%, ≥97.43%, ≥97.42%, ≥97.41%, ≥97.40%, ≥97.39%, ≥97.38%, ≥97.37%, ≥97.36%, ≥97.35%, ≥97.34%, ≥97.33%, ≥97.32%, ≥97.31%, ≥97.30%, ≥97.29%, ≥97.28%, ≥97.27%, ≥97.26%, ≥97.25%, ≥97.24%, ≥97.23%, ≥97.22%, ≥97.21%, ≥97.20%, ≥97.19%, ≥97.18%, ≥97.17%, ≥97.16%, ≥97.15%, ≥97.14%, ≥97.13%, ≥97.12%, ≥97.11%, ≥97.10%, ≥97.09%, ≥97.08%, ≥97.07%, ≥97.06%, ≥97.05%, ≥97.04%, ≥97.03%, ≥97.02%, ≥97.01%, or ≥97%.

### 4.6.5. Long Lived Radionuclidic Impurities

In certain embodiments of a method of producing high-purity radionuclides as provided herein, comprising the step of isolating a desired radionuclide the method further comprises the step of purifying a radionuclide salt solution to decrease amounts of chemical impurities. In certain of these embodiments, purifying includes anion/cation exchange chromatography. In certain embodiments, purifying comprises alkyl phosphate resin chromatography. In certain embodiments, purifying comprises weak cation exchange chromatography. In certain embodiments, purifying comprises decreasing the specific activity (e.g., in Bq/g) of certain radionuclides below a certain threshold.

4.6.5.1 Cobalt Isotopes—⁵⁶Co, ⁵⁷Co, ⁵⁸Co, and ⁶⁰Co

In certain embodiments, a composition comprising [⁶¹Cu]CuCl₂ as provided herein is characterized by aa ⁵⁶Co specific activity of ≤1500 Bq/g, ≤1450 Bq/g, ≤1400 Bq/g, ≤1350 Bq/g, ≤1300 Bq/g, ≤1250 Bq/g, ≤1200 Bq/g, ≤1150 Bq/g, ≤1100 Bq/g, ≤1050 Bq/g, ≤1000 Bq/g, ≤950 Bq/g, ≤900 Bq/g, ≤850 Bq/g, ≤800 Bq/g, ≤750 Bq/g, ≤700 Bq/g, ≤650 Bq/g, ≤600 Bq/g, ≤550 Bq/g, ≤500 Bq/g, ≤450 Bq/g, ≤400 Bq/g, ≤350 Bq/g, ≤300 Bq/g, ≤250 Bq/g, ≤200 Bq/g, ≤150 Bq/g, ≤100 Bq/g, or ≤50 Bq/g.

In certain embodiments, a composition comprising [⁶¹Cu]CuCl₂ as provided herein is characterized by a ⁵⁷Co specific activity of ≤100 Bq/g, ≤95 Bq/g, ≤90 Bq/g, ≤85 Bq/g, ≤80 Bq/g, ≤75 Bq/g, ≤70 Bq/g, ≤65 Bq/g, ≤60 Bq/g, ≤55 Bq/g, ≤50 Bq/g, ≤45 Bq/g, ≤40 Bq/g, ≤35 Bq/g, ≤30 Bq/g, ≤25 Bq/g, ≤20 Bq/g, ≤15 Bq/g, ≤10 Bq/g, ≤5 Bq/g, ≤4.6 Bq/g, ≤4.5 Bq/g, ≤4.4 Bq/g, ≤4.3 Bq/g, ≤4.2 Bq/g, ≤4.1 Bq/g, ≤4 Bq/g, ≤3.9 Bq/g, ≤3.8 Bq/g, ≤3.7 Bq/g, ≤3.6 Bq/g, ≤3.5 Bq/g, ≤3.4 Bq/g, ≤3.3 Bq/g, ≤3.2 Bq/g, ≤3.1 Bq/g, ≤3 Bq/g, ≤2.9 Bq/g, ≤2.8 Bq/g, ≤2.7 Bq/g, ≤2.6 Bq/g, ≤2.5 Bq/g, ≤2.4 Bq/g, ≤2.3 Bq/g, ≤2.2 Bq/g, ≤2.1 Bq/g, ≤2 Bq/g, ≤1.9 Bq/g, ≤1.8 Bq/g, ≤1.7 Bq/g, ≤1.6 Bq/g, ≤1.5 Bq/g, ≤1.4 Bq/g, ≤1.3 Bq/g, ≤1.2 Bq/g, ≤1.1 Bq/g, ≤1 Bq/g, ≤0.9 Bq/g, ≤0.8 Bq/g, ≤0.7 Bq/g, ≤0.6 Bq/g, ≤0.5 Bq/g, ≤0.4 Bq/g, ≤0.3 Bq/g, ≤0.2 Bq/g, or ≤0.1 Bq/g.

In certain embodiments, a composition comprising [⁶¹Cu]CuCl₂ as provided herein is characterized by a ⁵⁸Co specific activity of ≤1500 Bq/g, ≤1450 Bq/g, ≤1400 Bq/g, ≤1350 Bq/g, ≤1300 Bq/g, ≤1250 Bq/g, ≤1200 Bq/g, ≤1150 Bq/g, ≤1100 Bq/g, ≤1050 Bq/g, ≤1000 Bq/g, ≤950 Bq/g, ≤900 Bq/g, ≤850 Bq/g, ≤800 Bq/g, ≤750 Bq/g, ≤700 Bq/g, ≤650 Bq/g, ≤600 Bq/g, ≤575 Bq/g, ≤550 Bq/g, ≤525 Bq/g, ≤500 Bq/g, ≤475 Bq/g, ≤450 Bq/g, ≤425 Bq/g, ≤400 Bq/g, ≤375 Bq/g, ≤350 Bq/g, ≤325 Bq/g, ≤300 Bq/g, ≤275 Bq/g, ≤250 Bq/g, ≤225 Bq/g, ≤200 Bq/g, ≤175 Bq/g, ≤150 Bq/g, ≤125 Bq/g, ≤100 Bq/g, ≤75 Bq/g, ≤50 Bq/g, or ≤25 Bq/g.

In certain embodiments, a composition comprising [⁶¹Cu]CuCl₂ as provided herein is characterized by a ⁶⁰Co specific activity of ≤15 Bq/g, ≤14 Bq/g, ≤13 Bq/g, ≤12 Bq/g, ≤11 Bq/g, ≤10 Bq/g, ≤9 Bq/g, ≤8 Bq/g, ≤7 Bq/g, ≤6 Bq/g, ≤5 Bq/g, ≤4 Bq/g, ≤3 Bq/g, ≤2.9 Bq/g, ≤2.8 Bq/g, ≤2.7 Bq/g, ≤2.6 Bq/g, ≤2.5 Bq/g, ≤2.4 Bq/g, ≤2.3 Bq/g, ≤2.2 Bq/g, ≤2.1 Bq/g, ≤2 Bq/g, ≤1.9 Bq/g, ≤1.8 Bq/g, ≤1.7 Bq/g, ≤1.6 Bq/g, ≤1.5 Bq/g, ≤1.4 Bq/g, ≤1.3 Bq/g, ≤1.2 Bq/g, ≤1.1 Bq/g, ≤1 Bq/g, ≤0.9 Bq/g, ≤0.8 Bq/g, ≤0.7 Bq/g, ≤0.6 Bq/g, ≤0.5 Bq/g, ≤0.4 Bq/g, ≤0.3 Bq/g, ≤0.2 Bq/g, or ≤0.1 Bq/g.

In certain embodiments, a composition comprising [⁶¹Cu]CuCl₂ as provided herein is characterized by a ^{108m}Ag specific activity of ≤2 Bq/g, ≤1.9 Bq/g, ≤1.8 Bq/g, ≤1.7 Bq/g, ≤1.6 Bq/g, ≤1.5 Bq/g, ≤1.4 Bq/g, ≤1.3 Bq/g, ≤1.2 Bq/g, ≤1.1 Bq/g, ≤1 Bq/g, ≤0.9 Bq/g, ≤0.8 Bq/g, ≤0.7 Bq/g, ≤0.6 Bq/g, ≤0.5 Bq/g, ≤0.4 Bq/g, ≤0.3 Bq/g, ≤0.2 Bq/g, ≤0.1 Bq/g.

In certain embodiments, a composition comprising [⁶¹Cu]CuCl₂ as provided herein is characterized by a ^{110m}Ag specific activity of ≤5 Bq/g, ≤4.9 Bq/g, ≤4.8 Bq/g, ≤4.7 Bq/g, ≤4.6 Bq/g, ≤4.5 Bq/g, ≤4.4 Bq/g, ≤4.3 Bq/g, ≤4.2 Bq/g, ≤4.1 Bq/g, ≤4 Bq/g, ≤3.9 Bq/g, ≤3.8 Bq/g, ≤3.7 Bq/g, ≤3.6 Bq/g, ≤3.5 Bq/g, ≤3.4 Bq/g, ≤3.3 Bq/g, ≤3.2 Bq/g, ≤3.1 Bq/g, ≤3 Bq/g, ≤2.9 Bq/g, ≤2.8 Bq/g, ≤2.7 Bq/g, ≤2.6 Bq/g, ≤2.5 Bq/g, ≤2.4 Bq/g, ≤2.3 Bq/g, ≤2.2 Bq/g, ≤2.1 Bq/g, ≤2 Bq/g, ≤1.9 Bq/g, ≤1.8 Bq/g, ≤1.7 Bq/g, ≤1.6 Bq/g, ≤1.5 Bq/g, ≤1.4 Bq/g, ≤1.3 Bq/g, ≤1.2 Bq/g, ≤1.1 Bq/g, ≤1 Bq/g, ≤0.9 Bq/g, ≤0.8 Bq/g, ≤0.7 Bq/g, ≤0.6 Bq/g, ≤0.5 Bq/g, ≤0.4 Bq/g, ≤0.3 Bq/g, ≤0.2 Bq/g, or ≤0.1 Bq/g.

In certain embodiments, a composition comprising [⁶¹Cu]CuCl₂ as provided herein is characterized by a ¹⁰⁹Cd specific activity of ≤15 Bq/g, ≤14 Bq/g, ≤13 Bq/g, ≤12 Bq/g, ≤11 Bq/g, ≤10 Bq/g, ≤9 Bq/g, ≤8 Bq/g, ≤7 Bq/g, ≤6 Bq/g, ≤5 Bq/g, ≤4 Bq/g, ≤3 Bq/g, ≤2 Bq/g, or ≤1 Bq/g.

### 4.6.6. Radiochemical Identity

In certain embodiments, the presence and/or quantity of ⁶¹Cu is characterized by γ-photons. In certain embodiments, ⁶¹CU is characterized by γ-photons with energy peak at: 511±20 keV. In certain embodiments, ⁶¹CU is characterized by γ-photons with energy peak at: 511±20 keV and 283 keV 20 keV. In certain embodiments, ⁶¹Cu is characterized by 7-photons with energy peak at: 511±20 keV, 283 keV±20 keV, and 656 keV±20 keV. In certain embodiments, ⁶¹Cu is characterized by γ-photons with energy peak at: 511±20 keV (eventually sum peak at 1022 keV±20 keV), 283 keV±20 keV and 656 keV±20 keV.

### 4.6.7. Chemical Purity

In certain embodiments, ⁶¹Cu can be characterized by other chemical impurities. In certain embodiments, non-radioactive (cold) elements are present in a [⁶¹Cu]CuCl₂ solution. In certain embodiments, cold elements are present and quantified by ICP-MS (inductively coupled plasma mass spectrometry). In some embodiments, ⁶¹Cu is a transmutation product provided by methods described in the present disclosure. In some embodiments, transmutation of a target metal (e.g., ^{nat}Ni, ⁶⁰Ni, or ⁶¹Ni) provides ⁶¹Cu in varying levels of radiochemical purity.

4.6.7.1 Aluminum

In certain embodiments, a composition comprising [⁶¹Cu]CuCl₂ as provided herein is characterized by comprising aluminum (e.g., non-radioactive) in an amount ≤2 ng/MBq, ≤1.9 ng/MBq, ≤1.8 ng/MBq, ≤1.7 ng/MBq, ≤1.6 ng/MBq, ≤1.5 ng/MBq, ≤1.4 ng/MBq, ≤1.3 ng/MBq, ≤1.2 ng/MBq, ≤1.1 ng/MBq, ≤1 ng/MBq, ≤0.9 ng/MBq, ≤0.8 ng/MBq, ≤0.7 ng/MBq, ≤0.6 ng/MBq, ≤0.5 ng/MBq, ≤0.4 ng/MBq, ≤0.3 ng/MBq, ≤0.2 ng/MBq, or ≤0.1 ng/MBq.

4.6.7.2 Cobalt

In certain embodiments, a composition comprising [⁶¹Cu]CuCl₂ as provided herein is characterized by comprising cobalt (e.g., non-radioactive) in an amount ≤2 ng/MBq, ≤1.9 ng/MBq, ≤1.8 ng/MBq, ≤1.7 ng/MBq, ≤1.6 ng/MBq, ≤1.5 ng/MBq, ≤1.4 ng/MBq, ≤1.3 ng/MBq, ≤1.2 ng/MBq, ≤1.1 ng/MBq, ≤1 ng/MBq, ≤0.9 ng/MBq, ≤0.8 ng/MBq, ≤0.7 ng/MBq, ≤0.6 ng/MBq, ≤0.5 ng/MBq, ≤0.4 ng/MBq, ≤0.3 ng/MBq, ≤0.2 ng/MBq, or ≤0.1 ng/MBq.

4.6.7.3 Copper

In certain embodiments, a composition comprising [⁶¹Cu]CuCl₂ as provided herein is characterized by comprising copper (e.g., non-radioactive) in an amount ≤2 ng/MBq, ≤1.9 ng/MBq, ≤1.8 ng/MBq, ≤1.7 ng/MBq, ≤1.6 ng/MBq, ≤1.5 ng/MBq, ≤1.4 ng/MBq, ≤1.3 ng/MBq, ≤1.2 ng/MBq, ≤1.1 ng/MBq, ≤1 ng/MBq, ≤0.9 ng/MBq, ≤0.8 ng/MBq, ≤0.7 ng/MBq, ≤0.6 ng/MBq, ≤0.5 ng/MBq, ≤0.4 ng/MBq, ≤0.3 ng/MBq, ≤0.2 ng/MBq, or ≤0.1 ng/MBq.

4.6.7.4 Iron

In certain embodiments, a composition comprising [⁶¹Cu]CuCl₂ as provided herein is characterized by comprising iron (e.g., non-radioactive) in an amount ≤3 ng/MBq, ≤2.9 ng/MBq, ≤2.8 ng/MBq, ≤2.7 ng/MBq, ≤2.6 ng/MBq, ≤2.5 ng/MBq, ≤2.4 ng/MBq, ≤2.3 ng/MBq, ≤2.2 ng/MBq, ≤2.1 ng/MBq, ≤2 ng/MBq, ≤1.9 ng/MBq, ≤1.8 ng/MBq, ≤1.7 ng/MBq, ≤1.6 ng/MBq, ≤1.5 ng/MBq, ≤1.4 ng/MBq, ≤1.3 ng/MBq, ≤1.2 ng/MBq, ≤1.1 ng/MBq, ≤1 ng/MBq, ≤0.9 ng/MBq, ≤0.8 ng/MBq, ≤0.7 ng/MBq, ≤0.6 ng/MBq, ≤0.5 ng/MBq, ≤0.4 ng/MBq, ≤0.3 ng/MBq, ≤0.2 ng/MBq, or ≤0.1 ng/MBq.

4.6.7.5 Lead

In certain embodiments, a composition comprising [⁶¹Cu]CuCl₂ as provided herein is characterized by comprising lead (e.g., non-radioactive) in an amount ≤2 ng/MBq, ≤1.9 ng/MBq, ≤1.8 ng/MBq, ≤1.7 ng/MBq, ≤1.6 ng/MBq, ≤1.5 ng/MBq, ≤1.4 ng/MBq, ≤1.3 ng/MBq, ≤1.2 ng/MBq, ≤1.1 ng/MBq, ≤1 ng/MBq, ≤0.9 ng/MBq, ≤0.8 ng/MBq, ≤0.7 ng/MBq, ≤0.6 ng/MBq, ≤0.5 ng/MBq, ≤0.4 ng/MBq, ≤0.3 ng/MBq, ≤0.2 ng/MBq, or ≤0.1 ng/MBq.

4.6.7.6 Nickel

In certain embodiments, a composition comprising [⁶¹Cu]CuCl₂ as provided herein is characterized by comprising nickel (e.g., non-radioactive) in an amount ≤4.5 ng/MBq, ≤4.4 ng/MBq, ≤4.3 ng/MBq, ≤4.2 ng/MBq, ≤4.1 ng/MBq, ≤4 ng/MBq, ≤3.9 ng/MBq, ≤3.8 ng/MBq, ≤3.7 ng/MBq, ≤3.6 ng/MBq, ≤3.5 ng/MBq, ≤3.4 ng/MBq, ≤3.3 ng/MBq, ≤3.2 ng/MBq, ≤3.1 ng/MBq, ≤3 ng/MBq, ≤2.9 ng/MBq, ≤2.8 ng/MBq, ≤2.7 ng/MBq, ≤2.6 ng/MBq, ≤2.5 ng/MBq, ≤2.4 ng/MBq, ≤2.3 ng/MBq, ≤2.2 ng/MBq, ≤2.1 ng/MBq, ≤2 ng/MBq, ≤1.9 ng/MBq, ≤1.8 ng/MBq, ≤1.7 ng/MBq, ≤1.6 ng/MBq, ≤1.5 ng/MBq, ≤1.4 ng/MBq, ≤1.3 ng/MBq, ≤1.2 ng/MBq, ≤1.1 ng/MBq, ≤1 ng/MBq, ≤0.9 ng/MBq, ≤0.8 ng/MBq, ≤0.7 ng/MBq, ≤0.6 ng/MBq, ≤0.5 ng/MBq, ≤0.4 ng/MBq, ≤0.3 ng/MBq, ≤0.2 ng/MBq, or ≤0.1 ng/MBq.

4.6.7.7 Zinc

In certain embodiments, a composition comprising [⁶¹Cu]CuCl₂ as provided herein is characterized by comprising zinc (e.g., non-radioactive) in an amount ≤2 ng/MBq, ≤1.9 ng/MBq, ≤1.8 ng/MBq, ≤1.7 ng/MBq, ≤1.6 ng/MBq, ≤1.5 ng/MBq, ≤1.4 ng/MBq, ≤1.3 ng/MBq, ≤1.2 ng/MBq, ≤1.1 ng/MBq, ≤1 ng/MBq, ≤0.9 ng/MBq, ≤0.8 ng/MBq, ≤0.7 ng/MBq, ≤0.6 ng/MBq, ≤0.5 ng/MBq, ≤0.4 ng/MBq, ≤0.3 ng/MBq, ≤0.2 ng/MBq, or ≤0.1 ng/MBq.

### 4.7. Enumerated Embodiments

1. A coin for bombardment by subatomic particles, the coin comprising:
   a backing comprising a backing surface, wherein the backing comprises:
      Nb, wherein the Nb is 98.8% pure or greater.
2. The coin according to embodiment, wherein Nb is 99-99.999% pure or greater, 99.8% pure or greater, preferably 99.99% pure or greater.
3. The coin according to embodiment 1 or 2, wherein the Nb is characterized by one or more of the following:
   Fe≤40 ppm;
   Ti≤60 ppm;
   Zn≤19 ppm;
   Cu≤5 ppm;
   Sn≤8 ppm;
   Ni≤5 ppm; and
   Al≤5 ppm.
4. The coin according to embodiment 2, wherein the Nb is characterized by one or more of the following:
   Fe≤30 ppm;
   Ti≤10 ppm;
   Zn≤10 ppm;
   Cu≤3 ppm;
   Sn≤5 ppm; and
   Ni<1 ppm.
5. The coin according to embodiment 2, wherein the Nb is characterized by the following:
   Fe≤30 ppm;
   Ti≤2 ppm;
   Zn≤10 ppm;
   Cu≤5 ppm;
   Sn≤5 ppm; and
   Ni<1 ppm.
6. The coin according to any one of embodiments 1-5, wherein the backing has a thickness of 1-1.5 mm.
7. The coin according to any one of embodiments 1-6; further comprising:
   a target coating; and
   wherein the target coating comprises a target metal.
8. The coin according to embodiment 7, wherein the target coating is characterized by one or more of the following: Cd≤0.0005 ppm, Co≤0.005 ppm, Pb≤0.005 ppm, Cu≤0.08 ppm, and Fe≤0.15 ppm.
9. The coin according to embodiment 7 or 8, wherein the target coating has a thickness of 5 to 150 μm, 60-125 μm, or 70-100 μm.
10. The coin according to any one of embodiments 6-9, wherein the target coating has a mass of 30 mg or more, 40-100 mg, 45-80 mg, 40-70 mg, e.g., 70 mg 3 mg or 50 mg 3 mg.
11. The coin according to any one of embodiments 6-10, wherein the thickness of the target coating has a variability of 15% or less, or 10% or less, e.g., wherein the target coating is 15% thicker at the center compared to an average thickness of the coating at the perimeter of the target coating.
12. The coin according to any one of embodiments 6-11, wherein the target coating is in a circular shape having a diameter of 1.5 cm or less.
13. The coin according to any one of embodiments 6-12, wherein the target metal is Ni.
14. The coin according to embodiment 13, wherein the target metal is natural Ni or Ni of naturally occurring isotopic composition.
15. The coin according to embodiment 13, wherein the target metal is isotopically enriched in a minor isotope of Ni relative to natural Ni, wherein the minor isotope is selected from ⁶⁰Ni, ⁶¹Ni, ⁶²Ni, and ⁶⁴Ni, e.g, ⁶⁰Ni, or ⁶¹Ni.
16. The coin according to embodiment 15, wherein the target metal is isotopically enriched in the minor isotope to 95% or more, 96% or more, 97% or more, 98% or more, 99% or more.
17. The coin according to embodiment 15, wherein the minor isotope is ⁶⁴Ni.
18. The coin according to embodiment 15, wherein the target metal is isotopically enriched in the minor isotope to 97% or more.
19. The coin according to embodiment 16, wherein the minor isotope is ⁶²Ni.
20. The coin according to embodiment 15, wherein the target metal is isotopically enriched in the minor isotope to 99% or more.
21. The coin according to embodiment 15, wherein the minor isotope is ⁶⁰Ni.
22. The coin according to embodiment 15, wherein the minor isotope is ⁶¹Ni.
23. The coin according to any one of embodiments 6-12, wherein the target metal is Zn.
24. The coin according to embodiment 23, wherein the target metal is isotopically enriched in
⁶⁸Zn relative to natural Zn.
25. The coin according to embodiment 24, wherein the target metal is isotopically enriched in ⁶⁸Zn to 95% or more.
26. The coin according to embodiment 24, wherein the target metal is isotopically enriched in ⁶⁸Zn to 99% or more.
27. A method for preparing a coin for bombardment by subatomic particles,
   the coin comprising:
      a backing comprising a backing surface, and
      a target coating adhered to the backing surface, wherein the target coating comprises a target metal;
   the method comprising:
      electroplating the target metal from a plating solution onto the backing surface;
      wherein the plating solution comprises cations of the target metal; and
      wherein the plating solution has a pH of 9.5-10.7;
   thereby preparing the coin.
28. The method according to embodiment 27, wherein the backing comprises Nb, Ag, Pt, Au, Al, or W.
29. The method according to embodiment 28, wherein the backing comprises Nb or Ag.
30. The method according to embodiment 29, wherein the backing comprises Nb.
31. A method for preparing the coin according to any one of embodiments 27-30, the method comprising:
   electroplating the target metal from a plating solution onto the backing surface;
   wherein the plating solution comprises cations of the target metal;
thereby preparing the coin.
32. The method according to any one of embodiments 31, wherein the method further comprises:
   abrading the backing surface before the electroplating.
33. The method according to embodiment 32, wherein the abrading is performed with a vibrational tumbler.
34. The method according to embodiment 32, wherein the abrading is performed with a corundum grinding stone.
35. The method according to any one of embodiments 27-31, wherein the plating solution has a pH of 9.5-10.7.
36. The method according to embodiment 35, wherein the plating solution has a pH of 10-10.4.
37. The method according to any one of embodiments 27-39, wherein the plating solution comprises nitrate ions.
38. The method according to embodiment 37, wherein the plating solution comprises HNO₃.
39. The method according to any one of embodiments 27-38, wherein the electroplating occurs at a current of 120 to 180 μA.
40. The method according to any one of embodiments 27-39, wherein the electroplating occurs under one or more conditions selected from:
   a voltage of 3.5-5.5 V;
   temperature of 20-25° C.; and
   a cycle time of ≤5 hours.
41. The method according to embodiment 40, wherein the electroplating occurs at a voltage of 4.25-5.25 V.
42. The method according to embodiment 40, wherein the voltage is 4.5-5.5 V.
43. The method according to embodiment 40, wherein the voltage is 5.5 V.
44. The method according to any one of embodiments 27-43, wherein the plating solution has a volume of 10 mL or less.
45. The method according to any one of embodiments 27-44, wherein the electroplating occurs for ≤3 hours.
46. The method according to any one of embodiments 27-45, further comprising preparing the plating solution.
47. The method according to embodiment 46, wherein the plating solution is prepared by combining the target metal and a molar excess of HNO₃.
48. The method according to embodiment 47, wherein the HNO₃ is in the form of 65% nitric acid in water.
49. The method according to embodiment 48, wherein the HNO₃ is added to the plating solution in excess of 40 grams HNO₃ per gram target metal.
50. The method according to any one of embodiments 47-49, wherein the target metal is in the form of a metal powder that is at least 98% pure.
51. The method according to embodiment 50, wherein the metal powder is at least 99.9% pure.
52. The method according to any one of embodiments 46-51, wherein the preparing the plating solution further comprises adjusting the pH of the plating solution by adding an effective amount of NH₄OH.
53. The method according to any one of embodiments 27-52, further comprising adding a buffer solution to the plating solution prior to the electroplating.
54. The method according to embodiment 53, wherein the buffer solution comprises NH₄Cl and NH₄OH.
55. The method according to embodiment 53 or 54, wherein the buffer solution has a pH of 8.30-9.30.
56. The method according to embodiment 55, wherein the buffer solution has a pH of 9.35-9.25.
57. The method according to any one of embodiments 27-56, wherein the electroplating occurs in an electrolytic cell comprising a fixed anode.
58. The method according to embodiment 57, wherein the anode is selected from a graphite anode and a platinum anode.
59. The method according to embodiment 58, wherein the anode is 99.999% trace metal free.
60. The method according to embodiment 58 or 59, wherein the anode is a platinum anode.
61. The method according to embodiment 60, wherein the platinum anode is in the form of a wire or foil.
62. The method according to any one of embodiments 27-61, wherein the plating solution comprises Fe≤10 ppm.
63. The method according to 62, wherein the plating solution comprises one or more of the following:
   Ga, Lu, Pb, Y≤0.1 ppm;
   Zn, Co≤0.3 ppm;
   Cd, Cr, Al, Mn, Mo, Sn, Ti, and V≤1 ppm; and
   Family I and II elements: ≤1000 ppm.
64. The method according to any one of embodiments 27-63, wherein the target metal is Ni.
65. The method according to embodiment 64, wherein the target metal is natural Ni.
66. The method according to embodiment 64, wherein the target metal is isotopically enriched in a minor isotope of Ni relative to natural Ni, wherein the minor isotope is selected from ⁶⁰Ni, ⁶²Ni, ⁶¹Ni, and ⁶⁴Ni.
67. The method according to embodiment 66, wherein the target metal is isotopically enriched in the minor isotope to 95% or more.
68. The method according to any one of embodiments 64-67, wherein the method further comprises, prior to the electroplating, purifying the plating solution to remove copper.
69. The method according to 68, wherein the plating solution comprises Cu≤0.1 ppm.
70. The method according to any one of embodiments 27-63, wherein the target metal is Zn.
71. The method according to embodiment 70, wherein the target metal is isotopically enriched in ⁶⁸Zn relative to natural Zn.
72. The method according to embodiment 71, wherein the target metal is isotopically enriched in ⁶⁸Zn to 95% or more.
73. The method according to embodiment 70 or 72, wherein the plating solution is characterized as having one or more of the following elements in the range described:
   Ga, Lu, Pb, Y≤0.1 ppm;
   Co≤0.3 ppm;
   Cd, Cr, Al, Mn, Mo, Sn, Ti, and V≤1 ppm; and
   Family I and II elements: ≤1000 ppm.
74. A coin prepared according to the method of any one of embodiments 27-73.
75. A high-purity radionuclide composition, the composition comprising a radionuclide and having a radionuclidic purity at end of synthesis for the radionuclide of ≥95.0%; and wherein
   the radionuclide is a Cu radionuclide, and/or
   the composition comprises one or more of the following:
      ^{110m}Ag≤0.1 Bq/g;
      ^{108m}Ag≤0.1 Bq/g; and
      ¹⁰⁹Cd≤0.1 Bq/g.
76. The composition according to embodiment 75, wherein the composition is an aqueous solution and comprises the radionuclide in the form of radionuclide cations.
77. The composition according to embodiment 76, wherein the aqueous solution further comprises chloride anions.
78. The composition according to embodiment 77, wherein the chloride anions are present in a molar excess of the radionuclide cations.
79. The composition according to any one of embodiments 75-78, wherein the radionuclide is a Cu radionuclide.
80. The composition according to embodiment 79, wherein the radionuclide is ⁶¹Cu.
81. The composition according to embodiment 79, wherein the radionuclide is ⁶⁸Ga.
82. The composition according to any one of embodiments 75-81, wherein the composition comprises one or more of the following:
   ^{110m}Ag≤0.1 Bq/g;
   ^{108m}Ag≤0.1 Bq/g; and
   ¹⁰⁹Cd≤0.1 Bq/g.
83. The composition according to any one of embodiments 75-81, wherein the composition comprises one or more of the following:
   ⁵⁶Co equal to or less than 1500 Bq/g;
   ⁵⁷Co equal to or less than 100 Bq/g;
   ⁵⁸Co equal to or less than 15000 Bq/g; and
   ⁶⁰Co equal to or less than 15 Bq/g.
84. The composition according to embodiment 83, wherein the composition comprises two or more of the following:
   ⁵⁶Co equal to or less than 1500 Bq/g;
   ⁵⁷Co equal to or less than 100 Bq/g;
   ⁵⁸Co equal to or less than 15000 Bq/g;
   ⁶⁰Co equal to or less than 15 Bq/g; and/or
   having two or more of the following:
   ^{110m}Ag equal to or less than 1 Bq/g;
   ^{108m}Ag equal to or less than 1 Bq/g; and
   ¹⁰⁹Cd equal to or less than 1 Bq/g.
85. The composition according to any one of embodiments 75-78, wherein the radionuclide is not a Cu radionuclide and the composition comprises one or more of the following:
   ^{110m}Ag≤0.1 Bq/g;
   ^{108m}Ag≤0.1 Bq/g; and
   ¹⁰⁹Cd≤0.1 Bq/g.
86. The composition according to any one of embodiments 75-85, having a chemical purity for the radionuclide of ≥99 molar %.
87. The composition according to embodiment 85, wherein the composition is an aqueous solution and comprises one or more of the following:
   Fe≤2 mg/L;
   ⁶⁹Cu and ⁶⁵Cu together are ≤1 mg/L;
   Zn≤2 mg/L;
   Sn≤0.01 mg/L;
   Ti≤0.01 mg/L;
   Al≤2 mg/L;
   As≤1 mg/L;
   Ni≤1 mg/L; and
   wherein any one of Cr, Cd, Co, and Y is ≤0.1 mg/mL.
88. The composition according to embodiment 87, wherein the composition comprises Fe≤2 mg/L.
89. The composition according to embodiment 87, wherein the composition comprises Cu≤1 mg/L.
90. The composition according to embodiment 87, wherein the composition comprises Ni≤1 mg/L.
91. The composition according to any one of embodiments 75-90, characterized by one or more of:
   an activity concentration of 0.25-25 GBq/mL at calibration (EoB+8 hrs);
   a molar activity of 10-100 MBq/nmol at calibration (EoB+8 hrs); and
   an activity at end of synthesis (EoB plus 90 minutes) of >500 MBq.
92. A method of making a high-purity radionuclide composition comprising a radionuclide, the method comprising:
   irradiating in a particle accelerator the target metal of the coin according to any one of embodiments 7-26 or embodiment 74 to produce an irradiated target material; and
   isolating the high-purity radionuclide composition.
93. The method according to embodiment 92, wherein the high-purity radionuclide composition is according to any one of embodiments 75-86.
94. The method according to embodiment 92 or 92, wherein the isolating comprises:
   dissolving the irradiated target material in aqueous HCl solution to obtain a radionuclide chloride solution.
95. The method according to embodiment 94, wherein the aqueous HCl solution is a >5 M HCl solution.
96. The method according to embodiment 94 or 95, wherein the isolating further comprises:
   purifying the radionuclide chloride solution to reduce chemical impurities.
97. The method of any one according to any one of embodiments 92-96, wherein the irradiating occurs for one half-life of the radionuclide.
98. The method of embodiment 97, wherein irradiation occurs for 60-120 minutes.
99. The method according to any one of embodiments 92-98, wherein the irradiating comprises:
   bombarding the target metal with protons, deuterons, or alpha particles.
100. The method according to embodiment 99, wherein is the target metal is bombarded with deuterons.
101. The method according to embodiment 99, wherein the deuterons have a beam energy≤9 MeV and/or a beam current≤60 μA.
102. The method according to embodiment 101, wherein the deuterons have a beam energy of 3-9 MeV.
103. The method according to embodiment 101, wherein the deuterons have a beam current of 10-60 μA.
104. The method according to any one of embodiments 100-103, wherein the target metal comprises natural Ni, ⁶⁰Ni, or ⁶¹Ni, wherein the radionuclide is ⁶¹Cu, and wherein the ⁶¹Cu is produced according to one of the following reactions: ^{nat}Ni(d,n)⁶¹Cu, ⁶¹Ni(p,n)⁶¹Cu, or ⁶⁰Ni(d,n)⁶¹Cu.
105. The method according to embodiment 99, wherein the target metal is bombarded with protons.
106. The method according to embodiment 105, wherein the protons have a beam energy≤18 MeV and/or a beam current≤120 μA.
107. The method according to embodiment 106, wherein the protons have a beam energy of 6-18 MeV.
108. The method according to embodiment 106, wherein the protons have a beam current of 10-120 μA.
109. The method according to any one of embodiments 104-108, wherein the target metal comprises ⁶¹Ni, wherein the radionuclide is ⁶¹Cu, and wherein the is ⁶¹Cu produced according to the following reaction: ⁶¹Ni(p,n)⁶¹Cu.
110. The method according to any one of embodiments 104-108, wherein the target metal comprises ⁶⁴Zn, wherein radionuclide is ⁶¹Cu, and wherein the ⁶¹Cu is produced according to the following reaction: ⁶⁴Zn(p,α)⁶¹Cu.
111. The method according to any one of embodiments 104-108, wherein the target metal comprises ⁶⁰Ni, wherein the radionuclide is ⁶⁰Cu, and wherein the ⁶⁰Cu is produced according to the following reaction: ⁶⁰Ni(p,n)⁶⁰Cu.
112. The method according to any one of embodiments 104-108, wherein the target metal comprises ⁶²Ni, wherein the radionuclide is ⁶²Cu, and wherein the ⁶²Cu is produced according to the reaction: ⁶²Ni(p,n)⁶²Cu.
113. The method according to any one of embodiments 104-108, wherein the target metal comprises ⁶⁴Ni, wherein the radionuclide is ⁶⁴Cu, and wherein the ⁶⁴Cu is produced according to the reaction: ⁶⁴Ni(p,n)⁶⁴Cu.
114. The method according to any one of embodiments 104-108, wherein the target metal comprises ⁶⁸Zn, wherein the radionuclide is ⁶⁴Cu, and wherein the ⁶⁴Cu is produced according to the reaction: ⁶⁸Zn(p,αn)⁶⁴Cu.
115. A method for producing ⁶⁰Cu, ⁶¹Cu, ⁶²Cu, or ⁶⁴Cu, the method comprising: irradiating a coin with subatomic particles, wherein the coin comprises a niobium backing and a target coating, wherein the target coating comprises a target metal selected from ^{nat}Ni, ⁶⁰Ni, ⁶¹Ni, ⁶²Ni, ⁶⁴Ni, or ⁶⁸Zn, wherein the subatomic particles are selected from protons, deuterons, neutron, electrons, and alpha particles.

### 5. EXAMPLES

### 5.1. Summary of Experimental Observations

Aspects of the present disclosure are directed to a rapid electroplating method in a basic medium for producing coins to be used in particle accelerator-based radionuclide production. Examples of raw material to be irradiated using the provided method typically pertain to the isotopes of nickel and zinc electroplated on niobium, a relatively inert backing material.

Aspects of the present disclosure provide technology that enables the production of highly pure radionuclides in an aqueous chloride form (e.g., [⁶¹Cu]CuCl₂) to be used as a precursor in radiopharmaceuticals. The production of the highly pure radionuclide composition starts with irradiating a target coating comprising a target metal (e.g., natural or enriched nickel or zinc isotopes) through a particle accelerator, e.g., a medical cyclotron, to produce an irradiated target coating, i.e., a radionuclide. The purity of the target metal and coin backing is one aspect that allows the production of a high-quality radionuclide composition in terms of radionuclidic and chemical purity. The present disclosure provides a process using superior quality target metal and backing available at relatively low cost and large quantities for industrial radionuclide production and enables the production of coin manufacturing in much less time than methods in present use.

Aspects of the coin preparation method of the present disclosure provide significant improvements to the current coin plating methods currently found in the literature. For example, embodiments of the presently disclosed method rely on nitric acid to dissolve a target metal source material for electroplating, which stands in contrast to known electroplating methods employed in literature, which require hydrochloric and sulfuric acids. In the current literature, additional chemical constituents are used during plating solution preparation, such as cyanide or bromide, that act as buffers which pose health hazards for the operator during the chemical process and are not suitable for use with radiopharmaceuticals. Provided are methods of production that do not rely on such constituents and, thus, allow the negation of these risk factors.

In addition, aspects of the present disclosure introduce the concept of an electrolytic bath or plating solution with a significantly higher pH (e.g., 9.9-10.8) (e.g., prepared by dissolving the target metal in nitric acid, and then using a buffer based on ammonium chloride/hydroxide solution) that unexpectedly overcomes challenges in producing high quality, highly adhesive, electroplated target metal and enables coin production in a much shorter period of time. Reliance on the disclosed basic plating solution significantly differs from typical protocols, which rely on acidic or mildly basic solutions to plate target coatings for coin production. Below is a table obtained from IAEA RADIOISOTOPES AND RADIOPHARMACEUTICALS, REPORTS, No. 1, (INTERNATIONAL ATOMIC ENERGY AGENCY, Cyclotron produced radionuclides: Emerging positron emitters for medical applications: ⁶⁴Cu and ¹²⁴I, Radioisotopes and Radiopharmaceuticals Reports 1, IAEA, Vienna (2016) 63—“IAEA report”) indicating the electroplating conditions for nickel electroplating procedures.

TABLE 2
IAEA Report on electroplating nickel to a backing material (coin).

| | | | | | | | Electrode | | |
|---|---|---|---|---|---|---|---|---|---|
| | Plating bath | | Backing | | Volume | Voltage | distance | | Temperature |
| Country | (aqueous solution) | pH | material | Electrode | (mL) | (V) | (mm) | Stirring | (° C.) |
| Italy | (NH₄)₂Ni(SO₄)₂ | 9 | Au | Pt | 15 | 2.2 | 5 | Rotating | Room |
| Japan | (NH₄)₂Ni(SO₄)₂ | 9 | Au | Graphite | 5-7 | 2.6 | 5 | Syringe | Room |
| Finland | (NH₄)₂Ni(SO₄)₂ | 9 | Au | Graphite | 10 | 2.5 | 8 | No | Room |
| Rep. of Korea | (NH₄)₂Ni(SO₄)₂ | 9 | Au | Pt | 10 | 3.0 | 5 | Rotating | Room |
| China | NiCl₂ | 2 | Au | Pt | 50 | 3.8 | 20 | Rotating | Room |
| Denmark | Ni(SO₄)₂ | 6 | Ag | Pt | 6.5 | 3.2 | 20 | No | Room |
| USA (Washington) | (NH₄)₂Ni(SO₄)₂ | 9 | Au | Graphite | 10 | 2.5 | 5 | Rotating | Room |
| USA (Wisconsin) | (NH₄)₂Ni(SO₄)₂ | 9 | Au | Pt | 5 | 2.5 | 10 | No | Room |
| France | (NH₄)₂Ni(SO₄)₂ | 9.8 | Au | Pt | 100 | 1.1 | 10 | Rotating | 30 |
| Syrian Arab Republic | Ni(NO₃)₂, | 9 | Ag | Pt | 250 | 6 | 30 | Rotating | Room |
| | Na₂SO₄, NH₄Cl | | | | | | | | |
| | and H₃BO₄ | | | | | | | | |

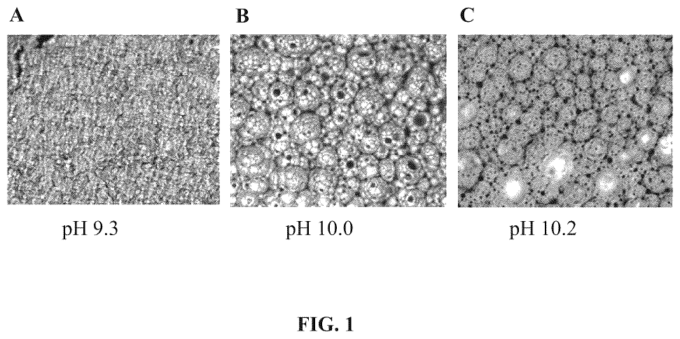

The higher pH of the presently disclosed methods is achieved through the addition of NH₄OH which shifts the anode-cathode to a higher potential, reduces the rate of H₂ evolution on the cathode, and reduces the cycle time required for a plating procedure from 24 hours to less than 3 hours for a complete plating of, e.g., 100 mg of target metal, while producing a high-quality coating having a more homogenous and uniform porous structure. See FIG. 1 (panels A-C).

In contrast, mildly basic solutions are predominantly found in the literature, as illustrated in the Table 2, above. Reliance on H₂SO4 is also consistentl

y given, as evidenced by the presence of the sulfate counter ion in all basic examples shown in the IAEA Table 3. As an initial matter, a mildly basic solution is used throughout all experiments compared to the more strongly alkaline pH used in the technology described herein. This indicates that current market suppliers are unaware or unable to produce the benefits of increased ammonium content in the plating solution. The present disclosure is the first to report the advantages of increasing ammonia concentration in the plating solution and using a highly basic pH. These advantages appear to be related to the observation that the more homogeneous porosity of the crystal structure of nickel plated onto a backing material suggests that the amount of hydrogen evolution is significantly reduced. Without being bound by theory, this may be attributed to the chemical characteristic state of NH₃ and its tendency to bond with protons to form NH₄⁺.

Additionally, the mildly basic pH levels utilized in the prior art methods referenced in Table 2, above restrict the optimal voltage that can be reached during the electroplating process due to a lower NH₃ content that influences the possible anode-cathode potential. In comparison, the present method describes a more alkaline plating solution that tolerates a higher anode-cathode potential that allows for a relatively increased optimal voltage. As a result, the electroplating durations can be shortened from an average of 24 hours to <3 hours while yielding similar plated masses.

Prior to the present disclosure, the advantages associated with a Nb were not contemplated in part because it was thought that Nb resulted in poor adhesion. In fact, the implementation of a niobium backing has been expressly disfavored (see, e.g., Table 3 below, reproduced from the IAEA report). The prior art methods require a weaker acid when dissolving the target metal for plating since these methods relied on producing coins for irradiation based on silver, gold, or platinum as their target backing materials. However, these materials cannot withstand the acidic properties of a strong acid such as HNO₃ as they will begin to dissolve upon contact. Niobium, on the other hand, is highly resistant to acids at room temperature and allows the utilization of a more aggressive acid such as HNO₃. Embodiments of the presently disclosed method allows the use of HNO₃ (nitric acid) to produce Ni(NO₃)₂ in place of the more commonly utilized H₂SO₄ (sulfuric acid) that produces NiSO₄. In contrast to the prevailing wisdom, the present disclosure reveals that good adhesion between Ni target coating and Nb backing is possible, and many unexpected advantages are achieved. For example, the strongly acidic properties of nitric acid allow the raw material to dissolve faster and to a higher concentration than the use of sulfuric acid. With this, the losses of highly expensive isotopically enriched materials can be avoided, thus making the use of enriched targets more economically viable.

TABLE 3
IAEA report identifies possible backing materials used in cyclotron-
produced radioisotopes for medical purposes (page 8 of the report).

| Backing material | Advantage | Disadvantage |
|---|---|---|
| Au | Reusable for many years; | Expensive |
| | Low activation | |
| Ag | High thermal conductivity; | Presence of metallic |
| | Inexpensive | contaminants; High |
| | | activation |
| Ag on Cu | Inexpensive; | Presence of metallic |
| | High thermal conductivity | contaminants; Cu |
| | | leakage |
| Au on Cu | Inexpensive; | Cu leakage |
| | Good adhesion | |
| Graphite | High purity; | Limit on the deposit |
| | No activation; | thickness; Lower |
| | Inexpensive; High | thermal conductivity |
| | fusion temperature | and limited current |
| Nb | None | Poor adhesion |

Moreover, the dominance of NiSO₄ in the IAEA report (and inspection of the related reports) suggests that the nickel-plating solution used was bought as nickel sulfate from a supplier. This factor introduces the possibility of contamination or impurities in the plating solution as it depends on the parameters from sources and suppliers of said chemicals. This difference between 99.9% purity and 99.99% purity plays a major role in the resulting radionuclidic, radiochemical and chemical purity of a radiopharmaceutical that incorporates a radionuclide, where the presence of cold copper, zinc, iron or cadmium is an issue. Furthermore, the possibility of a raw material pre-purification is considered not feasible. All procurement of chemicals and processes pertaining to the electroplating procedures in embodiments of the presently disclosed method are conducted using pure reagent and inert non-metal materials under controlled conditions. This significantly reduces the possibility of contamination from trace metals or other unwanted chemicals detected during the purification process. During the whole process, the use of metal tools and accessories in contact with solutions and raw materials was eliminated. Even in less-than-ideal temperatures and air quality conditions, a procedure of the present disclosure ensures the production of high-quality coins.

The above Table 3 from page 8 of the IAEA report identifies possible backing materials used in cyclotron-produced radioisotopes for medical purposes. It indicates the lack of understood advantages from Nb. This is accompanied by documented data yielding insufficient electroplating qualities due to its poor adhesion. On the contrary, the previously observed poor adhesion when using Nb-backing was not observed upon applying the electroplating methods provided herein. The electrochemical plating process is distinct from plasma coating procedures. Plasma coating alters the grain structure of the backing material through thermal processes, leading to changes in grain structure and high bonding of the plated material to the backing material. However, these changes hinder the effective dissolution in an acidic solution. In certain embodiments, by modifying the surface structure, e.g., by abrasion of the backing material, as disclosed herein, the inert nature and ability of niobium to resist acids at room temperature can be utilized for radioisotope production.

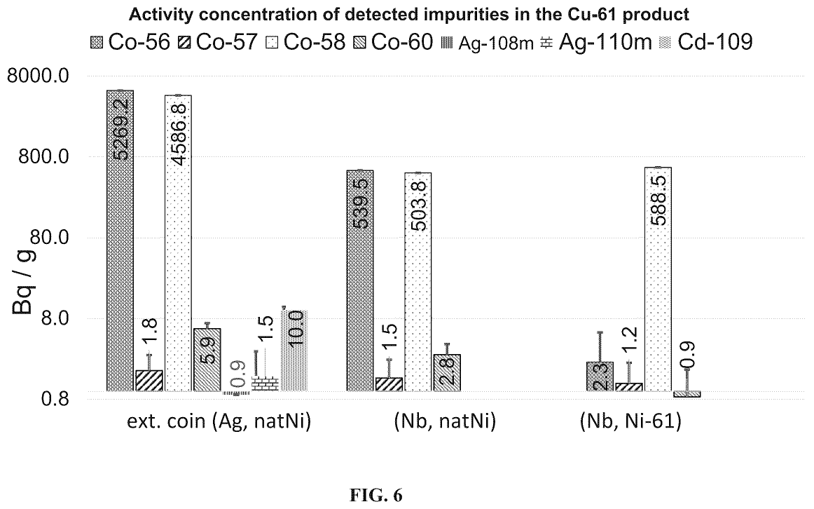

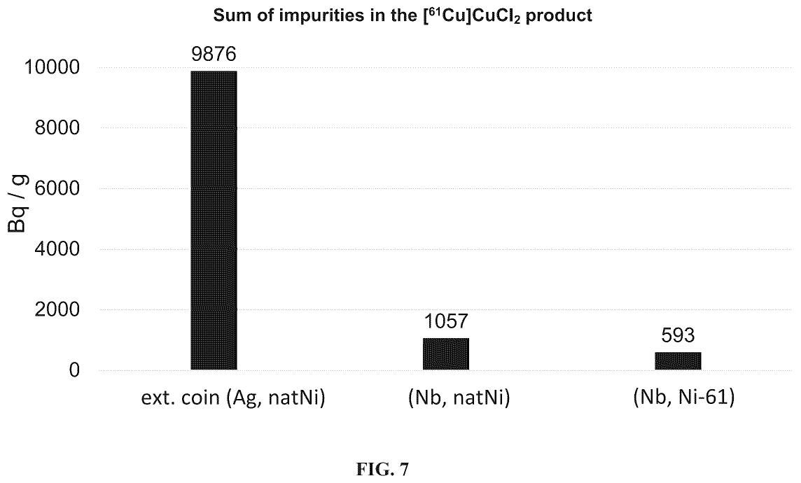

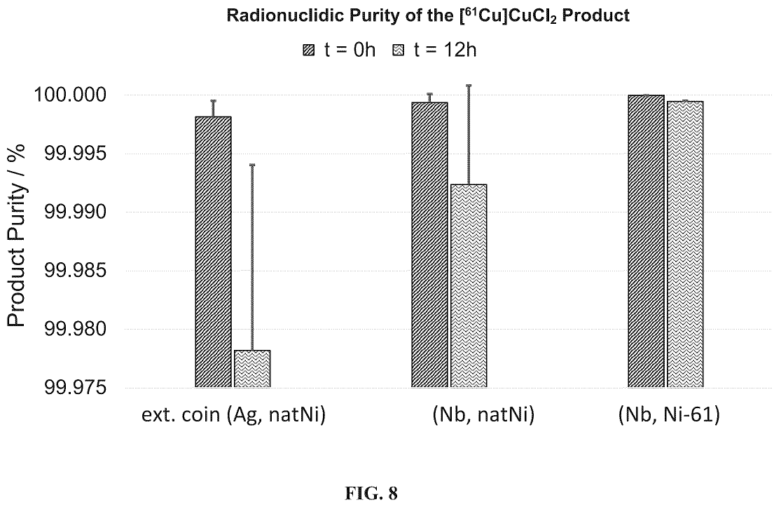

By applying this consensus to the production of radionuclides and the manufacturing of plating solutions under controlled environments (as stated in the section above), a difference in results is obtained from a purification and dissolution standpoint. The data of FIG. 6, FIG. 7, and FIG. 8 are compiled from gamma spectrometry and observations of radionuclidic impurities measured in [⁶¹Cu]CuCl₂ solutions obtained from the deuteron irradiation of a ^{nat}Ni target coating on Nb backing (Niobium nat-Ni) at 8.4 MeV, 60 mins at 60 μA; and with proton irradiation of a ⁶¹Ni target on Nb backing (Niobium Ni-61), at 13 MeV, 40 mins at 40 μA. A comparison of impurities within [⁶¹Cu]CuCl₂ solutions produced was made according to the provided methods with commercially available natNi targets (ext. coins).

As seen, irradiation of Nb backed coins prepared according to the present disclosure demonstrate a 89.3% reduction of radionuclidic impurities when compared with Ni on conventional silver to niobium backings, a 94% reduction of radionuclidic impurities when comparing ^{nat}Ni on conventional silver backings to ⁶¹Ni on niobium backings, and a 45.9% reduction of radionuclidic impurities when comparing Ni on niobium backings to ⁶¹Ni on niobium backings, when accounting for the sum of total impurities

The described factors affect the radionuclidic and chemical purity of a radionuclide, which impacts the purity of a radiopharmaceutical prepared from the radionuclide described in more detail below:

### 5.1.1. Chemical Purity

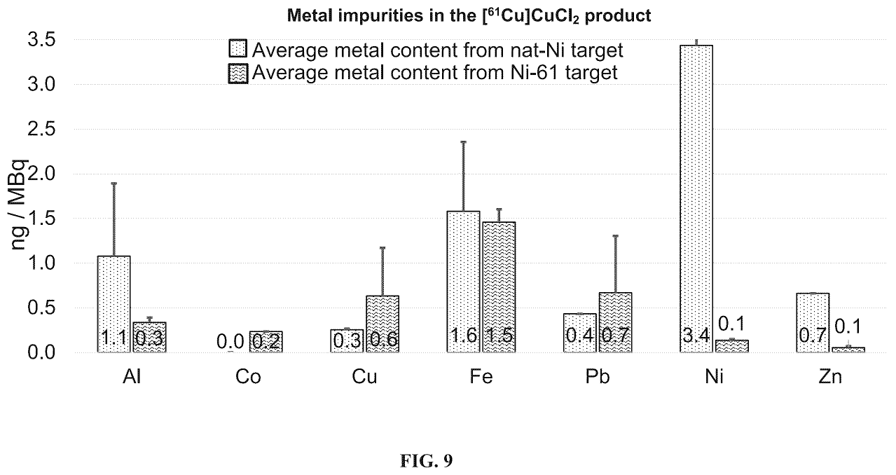

Trace metals and cold copper compete with ⁶¹Cu to bind a chelator (for example, NODAGA) in this order: cold Cu(II) (i.e., stable isotopes)>Zn(II)>Fe(III)>Sn(IV)>Ti(IV)>Al(III.). The competition from these trace metals and cold copper decreases the tracer's radiolabeling yield and radiochemical purity significantly, see Innovative Complexation Strategies for the Introduction of Short-lived PET Isotopes into Radiopharmaceuticals (p. 105). Frequent sources of trace metals are the raw nickel metal powder itself, especially isotopically enriched nickel, reagents, and any metals in instruments used, such as iron. The purification process (ion-exchange columns) removes much of the trace metals except for cold (of particular relevance are stable isotopes ⁶⁹Cu and ⁶⁵Cu), which passes through into the product fraction by being the same element as the desired ⁶¹Cu. One way of preventing cold copper contamination and the associated reduction in chemical purity is to pass the dissolved nickel raw material (stable isotopes) through the process and separate the cold copper from the nickel before plating (see FIG. 9 for ICP-MS analysis) and Table 4 display the chemical purity of the [⁶¹Cu]CuCl₂ by either bombardment of ^{nat}Ni or ⁶¹Ni on a niobium backing and the resulting impurity profile.

TABLE 4
Chemical Purity of ⁶¹Cu transmuted from ^{nat}Ni vs. ⁶¹Ni

ng/MBq

| | Cu-61 from nat-Ni | Cu-61 from Ni-61 |
|---|---|---|
| Aluminum (Al) | 1.1 | 0.3 |
| Cobalt (Co) | N/D | 0.2 |
| Copper (Cu) | 0.3 | 0.6 |
| Iron (Fe) | 1.6 | 1.5 |
| Lead (Pb) | 0.4 | 0.7 |
| Nickel (Ni) | 3.4 | 0.1 |
| Zinc (Zn) | 0.7 | 0.1 |

### 5.1.2. Radionuclidic Purity

Radionuclidic purity is important in radiopharmacy since any radionuclidic impurities introduce uncertainty in the radiation dose received by the patient and may also degrade the quality of any imaging procedure performed. For example, if significant levels of other radionuclides are present, then biological distribution may be altered. Radionuclide samples contain some contaminants arising from the production process or the decay of the primary radioisotope. Radionuclide impurities can occur as a result of the manufacturing process, for example, for nuclides produced by cyclotron there can be contaminants due to impurities in the target or by the energy of the reaction. Impurities in the target coating may be transmuted into many minor elements, multiplying the impurity profile after bombardment. In order to control the effects of these contaminants on the radiation dose received by the patient, limits are set on the maximum levels of contamination allowed. These limits are defined by governmental agencies, e.g., in pharmacopoeia monographs, and vary depending upon the radionuclide concerned and the physical decay characteristics of the likely contaminants. Measurement of radionuclidic purity may be performed high resolution using gamma-ray spectroscopy on samples well after bombardment. The activity of the long-lived isotopes is then extrapolated back to EoB or EoS or even at expiration. High activity emitted from long lived radionuclidic impurities greatly increases the cost and complexity of managing the disposal of all consumables that come into contact with the nuclide composition.

Through the deuteron irradiation of natural nickel and ⁶⁰Ni, and proton irradiation of ⁶¹Ni, long-lived isotopes of cobalt are produced: ⁵⁶Co, ⁵⁷Co, ⁵⁸Co and ⁶⁰Co. Other long-lived radionuclides such as ^{110m}Ag, ^{108m}Ag and ¹⁰⁹Cd are produced through the irradiation of commonly used silver backing material, which are dissolved along with starting material during the purification process. Due to their long half-lives, the proportion of these radionuclides increases with time compared to the ⁶¹Cu, decreasing the radionuclidic purity of the product, especially at later time points when using ^{nat}Ni as a starting material. Though most cobalt isotopes can be separated in the purification process, the ^{110m}Ag, ^{108m}Ag and ¹⁰⁹Cd end up in the ⁶¹Cu fraction and nickel solution that is further used in recycling of irradiated target coating. The long-lived radionuclides become problematic when considering the radiation burden to the patient and the accumulation of radioactive waste. Third-party coin manufacturers did not publish the contamination from the non-niobium coin backings (e.g., silver). As provided by the present disclosure, the method of making and using coins comprising niobium represents an advantage, e.g., in view of the radionuclidic and chemical purity of samples produced following subatomic particle bombardment, isolation, and purification. A detailed comparison of the known ⁶¹Cu products to ⁶¹Cu as provided by the present disclosure is provided below.

With these factors in mind, a niobium backing material was chosen due to its inert nature to acids at room temperature and at elevated temperatures. This characteristic allows the niobium backing material to resist the acid medium used during the dissolution and purification process. By doing so, higher radionuclidic and chemical purity can be achieved in the radiometal aqueous solution, eventually resulting in higher purity for the radiopharmaceutical prepared from the desired ⁶¹Cu isotope. Although plating methods of niobium exist, the element has not yet been used for radionuclide production due to the poor adhesion of the plated Ni material (as discussed above). The Ni (or ⁶⁸Zn for the production of ⁶⁸Ga) requires sufficient adhesion for the coin to survive thermal loads (1200 W) during irradiation and pneumatic shuttle acceleration at 5 bar to 7 bar of pressure and abrupt stop at the head. On the other hand, however, the plated Ni (or Zn) must dissolve sufficiently during the dissolution and purification process. Attempts were made to plasma-coat niobium backings for plating nickel (Ni). However, this process resulted in losses and incomplete dissolution of Ni from the niobium backing. The thermal processes involved in plasma coating altered the grain structure of the niobium backing material, leading to a strong bond between the plated nickel and niobium. This strong bond made it difficult for the nickel to fully dissolve, causing losses. The plasma coating process itself resulted in very high losses in target coating, rendering the process not viable for use, especially with very expensive highly enriched target metals. The main reference to this summary is the IAEA documentation regarding cyclotron radionuclide production, IAEA RADIOISOTOPES AND RADIOPHARMACEUTICALS, REPORTS, No. 1. (INTERNATIONAL ATOMIC ENERGY AGENCY VIENNA, 2016) Additionally, a monetary evaluation regarding the procurement costs of niobium utilized as a backing material displays a 40% lower cost in comparison to commonly used backing materials such as gold, silver, and platinum where costs range from €80 to €120 per backing material (single coin).

Parallel to this, elements pertaining to the radiochemical purity of the labelling process can be controlled by manufacturing the plating solution under controlled conditions described herein. By procuring the plating solution from a raw base material of, e.g., nickel, the possibility of contamination is now independent from outside sources and suppliers. Such material and equipment used in these cases are inert glass beakers and falcon tubes (ensured to not contain any undesirable substances), TraceSelect pure water, pure reagents (trace-metal grade), inert coin adapter and electrolytic cell (on the electroplating unit), etc. Through this, the contaminants of trace metals can be minimized reduced or avoided all together. This difference between 99.9% purity and 99.99% purity plays a role in the resulting chemical purity of a radionuclide and therefore in the radiochemical purity of a radiopharmaceutical prepared from the radionuclide, where the presence of cold Cu, Zn, Fe, Sn, Ti, or Al or any salt thereof are an issue as they will compete for binding to the chelator in the tracer along with the desired radionuclide (⁶¹Cu).

Robustness of plating is tested through a drop and scratch test. This assessment ensures that the electrodeposited substrate on the backing will survive mechanical impacts of the shuttling system and establishes an increased probability of survivability under the cyclotron beam.

In certain embodiments, coins are irradiated with 8.4 MeV deuterons for an average duration of 120 mins at a range of 40 μA to 45 μA or with 13.2 MeV deuterons at 40 μA to 45 μA using an ARTMS or GE shuttling system on a GE PET Trace cyclotron.

In certain embodiments, the coins are irradiated with 8.4 MeV deuterons for an average duration of 120 mins at a range of 40 μA to 45 μA or with 10 μA to 100 μA 13 MeV protons using an ARTMS or GE shuttling system on a GE PET Trace cyclotron.

Dissolution of Ni from the niobium backing is undergone via the utilization of a dissolution system in 10 M HCl. The subsequent ⁶¹Cu is then purified with two subsequent ion exchange resins in a FASTlab synthesis unit. The processing time for these purifications can reach up to 60 minutes.

The resulting [⁶¹Cu]CuCl₂ solution of the plated material has an average activity of 1.7-4.5 GBq. This activity is measured using a dose calibrator and its radionuclidic purity by a calibrated gamma spectrometer e.g., at PSI in Switzerland.

Gamma spectrometry measurements were performed to identify any radionuclidic impurities, particularly long-lived radionuclides. These results indicate an 89.3% and 94% reduction in impurities for ^{nat} Ni and ⁶¹Ni on niobium backing materials with respect to silver backing materials when utilizing the methods disclosed herein. ICP-MS measurements are performed on the product of cold dissolutions by Labor Veritas in Switzerland to monitor elemental impurities present in the product according to ICH-Q3D. All detected impurities are within regulated ICH-Q3D concentrations (see ICH-Q3D Guidelines, pg 25).

The plating of highly enriched ⁶¹Ni is also enabled with the same plating parameters as described above, for a higher yield and industrial production using proton irradiation (typically at 10 μA to 100 μA, 13 MeV protons for 20 minutes to 2 hours and up to one half-life of ⁶¹Cu).

Following automated transportation of the irradiated coin from the cyclotron to the hot cell docking station, the capsule was transferred to a QIS dissolution unit with tongs. The transmuted target metal was dissolved from the niobium backing material using 1:1 7M HCl: 30% H₂O₂ (ultratrace analysis, Merck) (4 mL). The acid-peroxide mixture is circulated, immersing the coin and target metal surface to dissolve all irradiated elements at 2 mL/min for about 23 minutes at about 60° C. When the target metal was fully dissolved, acidic solution containing the dissolved metal was withdrawn and the QIS system was flushed with 10M HCl (3 mL). The combined acidic solutions were then fed forward to the FASTlab purification unit.

### 5.2. Example 1. Making a Coin for Deuteron/Proton Bombardment

### 5.2.1. Example 1.1 Preparing Plating Solution

5.2.1.1 Preparation of Buffer Solution

Ammonium Chloride (4.6 g, Aldrich: 326372, Trace Select) was weighed into a clean (no metal) Falcon Tube (50 mL), and the previously cleaned magnetic stirring bar was added. 6 mL of Trace Select water (Honeywell 95305) was added in one aliquot to flush walls of the Falcon in case any salt sticks to the Falcon tube walls. 1 mL of ammonium hydroxide 28% (Sigma 338818) was added with a 1000 μL pipette with a respective pipette tip, 8× times. The lid of the Falcon was closed, and the Falcon is, in turns, vortexed (1-2 minutes) (immersion in an ultra-sonic bath was a possible alternative for 1-2 minutes) and shaken, until all salt was dissolved. The Falcon tube can also be warmed (e.g., by rolling between hands) to improve solubility, temperature (e.g., around 23° C., preferably between 23-25° C.). After complete dissolution of the salt, the pH acceptance criteria, pH range 9.28-9.62, needs to be verified by pH measurement of the solution at RT, e.g., with and electronic pH meter. The Falcon tube was closed with parafilm and stored at room temperature. Prior to use, any solid salt formation was redissolved. 5.2.1.2 Preparation of Nickel Nitrate Plating Solution

A 50 mL glass beaker was washed with nitric acid (Trace Select) followed by water (Trace Select). In a fume hood, the beaker was dried by placing it on a heating plate set to 150° C. To the beaker was added 210 mg of natural (isotopic distribution) nickel (powder, Sigma-Aldrich<50 μm, 99.7% trace metals basis, essentially free from any impurities, except iron. The copper impurity amounts to <0.3 ppm.) were weighed into the beaker and 4 mL of 65% nitric acid were added using a pipette. The beaker was placed back on the active heating plate and the stirring was set to 300 rpm. Ensure the ventilation of the fume hood was functioning properly (evolution of NO₂). During the dissolution, the solution turns green. The solution was reduced by evaporation to a volume of ≈600 μL and taken from the heating plate to cool down to room temperature. The remaining solution was transferred to a 50 mL metal-free Falcon tube. The glass beaker was rinsed with a total of 2.8 mL of Trace Select water, in steps of 0.8 mL, 1 mL, and 1 mL, where each step was transferred to the Falcon tube before the adding the next washing fraction. Buffer solution (4 mL), 11 mL of Trace Select water, and 3 mL of ammonium hydroxide 28% (Sigma 338818) were added to the Falcon tube. The pH of the solution was measured and adjusted to the required pH by adding ammonium hydroxide 28% (Aldrich 338818) using sterile B-Braun syringes.

5.2.1.3 Examples of Suitable Starting Material to Prepare ⁶⁰Ni and ⁶¹Ni Electroplating Solutions

The following are example lots of ⁶⁰Ni and ⁶¹Ni (certificate as provided by Isoflex, USA, March 2018):

TABLE 5

| Isotop | ⁶¹Ni |
|---|---|
| Enrichment | 86.20% |
| Form | Metal ingot/powder |
| Certificate | 6275 |

| | Isotope | Ni-58 | Ni-60 | Ni-61 | Ni-62 | Ni-64 |
|---|---|---|---|---|---|---|
| Isotopic | Content (%) | 1.17 | 0.8 | 86.2 | 11.7 | 0.14 |
| distribution | | | | | | |

| | Element | Al | Bi | Ca | Cd | Co | Cr | Cu | Fe | K | Mg |
|---|---|---|---|---|---|---|---|---|---|---|---|
| Chemical | Content | 10 | <10 | 20 | 10 | <10 | <10 | 20 | 40 | <10 | <50 |
| admixtures | (ppm) | | | | | | | | | | |

| Element | Mo | Mn | Na | Pb | Si | Sn | Zn |
|---|---|---|---|---|---|---|---|
| Content | <8 | <50 | <10 | <10 | 20 | 30 | 50 |
| (ppm) | | | | | | | |

TABLE 6

| | |
|---|---|
| Isotope | ⁶¹Ni |
| Enrichment | 99.39% |
| Form | Metal powder |
| Certificate | TBD/not specified |

| | Isotope | Ni-58 | Ni-60 | Ni-61 | Ni-62 | Ni-64 |
|---|---|---|---|---|---|---|
| Isotopic | Content (%) | 0.01 | 0.29 | 99.39 | 0.29 | 0.02 |
| distribution | | | | | | |

| | Element | Al | Co | Cr | Cu | Fe | Mg | Mn | Pb | Si | Ti |
|---|---|---|---|---|---|---|---|---|---|---|---|
| Chemical | Content | 12 | <10 | <10 | 14 | <10 | <10 | <10 | <10 | <10 | <50 |
| admixtures | (ppm) | | | | | | | | | | |

| Element | Zn | C | S |
|---|---|---|---|
| Content | <10 | 157 | <10 |
| (ppm) | | | |

TABLE 7

| | |
|---|---|
| Isotop | ⁶⁰Ni |
| Enrichment | 99.31% |
| Form | metal powder |
| Certificate | TBD/not specified |

| | Isotope | Ni-58 | Ni-60 | Ni-61 | Ni-62 | Ni-64 |
|---|---|---|---|---|---|---|
| Isotopic | Content | 0.21 | 99.31 | 0.46 | 0.015 | 0.005 |
| distribution | (%) | | | | | |

| | Element | Al | Co | Cr | Cu | Fe | Mg | Mn | Pb | Si | Ti |
|---|---|---|---|---|---|---|---|---|---|---|---|
| Chemical | Content | <10 | 70 | 20 | 25 | <10 | <10 | <10 | <10 | 15 | <10 |
| admixtures | (ppm) | | | | | | | | | | |

| Element | Zn | C | S | P |
|---|---|---|---|---|
| Content | 15 | 114 | 20 | 30 |
| (ppm) | | | | |

The samples of natural nickel from Sigma-Aldrich were essentially free from any impurities, except iron. The copper impurity amounts to <0.3 ppm. Please see certificate of analysis as described in Example 2. Additional suitable sources of natural Ni include:
Nickel powder, <50 μm, 99.7% trace metals basis
Nickel rod, diam. 6.35 mm, =99.99% trace metals basis
Nickel foil, thickness 0.5 mm, 99.98% trace metals

5.2.1.4 Preparation of Zinc Nitrate Plating Solution

A 50 mL glass beaker was washed with nitric acid (Trace Select) followed by water (Trace Select). In a fume hood, the beaker was dried by placing it on a heating plate set to 150° C. 210 mg of natural (isotopic distribution) zinc (zinc powder, Sigma-Aldrich<10 μm, >98%) were weighed into the beaker and 4 mL of 65% nitric acid were added using a pipette. The beaker was placed back on the active heating plate and the stirring was set to 300 rpm. Ensure the ventilation of the fume hood was functioning properly (evolution of NO₂). During the dissolution, the solution turns green. The solution was reduced by evaporation to a volume of ˜600 μL and taken from the heating plate to cool down to room temperature. The remaining solution was transferred to a 50 mL metal-free Falcon tube. The glass beaker was rinsed with a total of 2.8 mL of Trace Select water, in steps of 0.8 mL, 1 mL, and 1 mL, where each step was transferred to the Falcon tube before the adding the next washing fraction. 4 mL of the buffer solution (prepared in Section 5.2.1.1), 11 mL of Trace Select water, and 3 mL of ammonium hydroxide 28% (Sigma 338818) were added to the Falcon tube. The pH of the solution was measured and adjusted to the required pH by adding ammonium hydroxide 28% (Aldrich 338818) using sterile B-Braun syringes.

Optional Abrasion of the Backing Surface

In certain embodiments, if the target coating was not sufficiently adhered to the backing surface, the Nb backing surface may be surface-treated prior to the process of electroplating to improve adhesion of the target coating. It was found that adhesion results were close to ideal when the backing surface was treated with abrasion prior to electroplating. While not to be bound by theory, one consideration was that oxides were formed on the surface of the Niobium backing, e.g., either through a process during manufacturing, storage or prior use and that the presence of oxides hinders the adhesion of a target metal, e.g., Ni or Zn, to the Nb backing. Another consideration was that the process of removing oxides may impart nucleation sites onto the Nb backing surface that enables adhesion of the target metal deposition.

Implementing particular surface pre-treatments, e.g., those that remove the oxide layer on received backing, sufficient adhesion of the target coating was reliably achieved.

In certain embodiments, niobium backing may be surface treated with the use of a Bosch Impact 12 hand grinder, grinding handgun was used at 50 rpm for a duration of roughly 45 to 60 seconds (pink corundum abrasive grit size 60) washed with ethanol.

Electroplating the Backing Surface

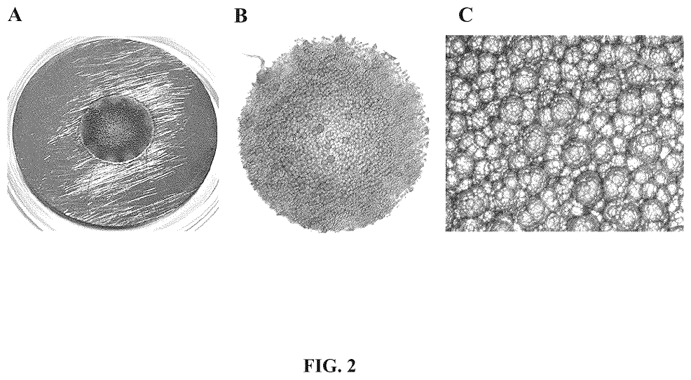

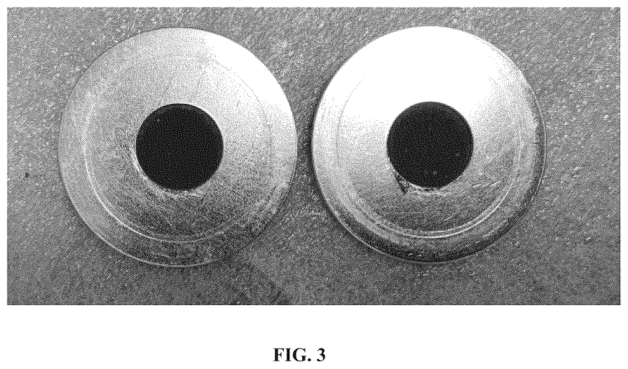

A disc shaped niobium backing was obtained from high purity Nb as described herein and (28 mm×1 mm) was cleaned with ethanol (high-purity) and inserted in a Comecer Electroplating Unit V21204. A platinum wire anode was positioned so that the distance relative to the coin surface was between about 1 and 3 mm, adjusted by a polymer spacer. The coin mass was determined to be 5.25 grams. Niobium backing (22 mm×1 mm weighs 3.3 g). The plating solution was charged to the electrolyte container and attached to the apparatus. The voltage was set to 4.5V. The current reading after 5 min stabilization was 180 PA. The duty cycle for pump was set to 45%. The plating liquid turned from blue to transparent, slow decrease of current to 160 μA was observed over the period of 120 minutes. The plating process was stopped. The coin was taken out of the electrolytic cell and its weight was measured. The coin also underwent microscopic evaluation, FIGS. 2 and 3 using a DINOLite digital microscope to observe the crystal structure and homogeneity of the surface. The coin (FIG. 33) was stored in a metal-free Falcon tube under a nitrogen atmosphere.

5.2.1.5 Results of the Electroplating

Upon completion of electroplating, the coin underwent a microscopic evaluation using a DINOLite digital microscope to observe the crystal structure and homogeneity of the surface. As can be seen in FIG. 2 (panels A-C), a homogenous target coating having durable adhesion was obtained.

### 5.3. Example 2. General Guidelines for High-Purity [⁶¹Cu]Cl₂ Production

The purpose of this example was to enable the bulk production of copper-61 (⁶¹Cu) from the deuteron irradiation of natural nickel and/or enriched ⁶⁰Ni. This effort was a proof of concept, and, therefore, there were no benchmarked specifications for ⁶¹Cu. However, we optimize target performance, target geometry/material use, irradiation parameters, and chemical processing methods to produce [⁶¹Cu]CuCl₂ following enriched ⁶⁰Ni irradiation, or, scaled accordingly for ^{nat}Ni irradiation. There were no pharmacopoeia specifications for radio-copper explicitly, however, test QC methods include assessment of radionuclidic purity and apparent molar activity (to demonstrate usability of the extracted [⁶¹Cu]CuCl₂). The final yield parameters were determined mutually to confirm a commercially viable production of [⁶¹Cu]CuCl₂) (USZ, GE, SN) after the first irradiations and yield measurements.

This example considers use of two different types of targets, natural nickel (^{nat}mNi) targets and highly enriched Nickel-60 (⁶⁰Ni) targets both of which were suitable for deuteron bombardment. However, ^{nat}Ni was cheap and available in high-purity while ⁶⁰Ni was still costly and requires efficiency measures. If even higher yields were desired, target coating preparation efforts may be directly translated into the proton-based ⁶¹Ni(p,n)⁶¹Cu route, however, given the cost of enriched ⁶¹Ni (c.a. $25 USD/mg), such an approach imposes the need for target metal recycling.

The set of guidelines below enable all types of targets in the production of ⁶¹Cu, including the production of high-purity [⁶¹Cu]CuCl₂ from the Nb coins with a Zn or Ni (any isotopic enrichment) coating electroplated thereon as provided herein. Specific details are also provided for deuteron, and proton irradiations, respectively. This protocol was followed to generate all the [⁶¹Cu]Cl compositions evaluated in the following examples.

| Backing | Flat coin - disc-shaped. The dimensions of the backing form are: | | |
|---|---|---|---|
| Geometry | Coin backing: | | |
| | Diameter Ø = 20-30 ± 0.1 mm | | |
| | Thickness H = 1.5 mm | | |
| | Target Ni layer or coating | | |
| | Diameter 13 mm (deuteron) or 10 mm (proton) | | |
| | Mass 70-100 mg, e.g, around 100 ± 40 mg (deuteron) or | | |
| | around 50 ± 20 mg (proton) | | |
| | Thickness (H) full density (d = 8.9) | | |
| | i. Hₘᵢₙ = 0.1 mm; Hₘₐₓ = 0.14 mm corresponding to 70- | | |
| | 100 mg deposited | | |
| | Tolerances/finishes unless otherwise stated are as follows: | | |
| | Surface finish: Ra 1.6 | | |
| | General tolerance: ISO 2768-m | | |
| | Sharp edges and corners according to ISO 13 715 | | |
| Backing | Optional - Surface treated with abrasion by pink corundum grindstone - | | |
| Surface | free of impurities | | |
| Backing | Niobium foil, 99.8% (metals basis), 1 mm (0.04 in) thick, annealed, | | |
| Material | Stock No.: 10257 | | |
| | Lot No.: C15P07 | | |
| | Element | ppm | |
| | Carbon | 24 | |
| | Hydrogen | 1 | |
| | Molybdenum | 2 | |
| | Nickel | 4 | |
| | Silicon | 1 | |
| | Titanium | 2 | |
| | Zirconium | 3 | |
| | Iron | 1 | |
| | Hafnium | 2 | |
| | Nitrogen | 14 | |
| | Oxygen | 56 | |
| | Tantalum | 785 | |
| | Tungsten | 4 | |
| Backing | Niobium 99.9% typical certificate of analysis results, Goodfellows | | |
| Material | Product nr. 931-627-20 | | |
| | Element | ppm | |
| | B | <10 | ppm |
| | Ni | <5 | ppm |
| | O | 100 | ppm |
| | Si | 100 | ppm |
| | Zr | <10 | ppm |
| | Ta | 500 | ppm |
| | H | <10 | ppm |
| | W | <100 | ppm |
| | C | 25 | ppm |
| | N | 20 | ppm |
| | Fe | 30 | ppm |
| | Cu | <5 | ppm |
| | Mo | 10 | ppm |
| | Ti | <10 | ppm |

| Transfer system | As the coin can be automatically transferred to and from the cyclotron by | |
|---|---|---|
| compatibility | means of a pneumatic target transfer system, it was critical that the | |
| | deposited Ni was robust to direct air flow and abrupt mechanical | |
| | movements. | |
| | In certain embodiments, the target coating remains adhered to the backing | |
| | during pneumatic transfer both to and from the cyclotron. Such a | |
| | pneumatic system was typically fed by a compressed air connection of ~6-7 | |
| | bar, and at minimum, 360 SLPM flow. Such a system was “push-push”, and | |
| | therefore, compressed air was typically blown on both the front and rear | |
| | sides of the coin, respectively, depending on the direction of transfer. The | |
| | coin will also come to an abrupt stop as it reaches the station or hotcell. | |
| | In certain embodiments, suitable tests that indicate target coating durability | |
| | include the following, whereby the total mass loss for all tests combined | |
| | should be negligible (e.g. <1 mg): Visual inspection, gentle | |
| | knocking/tapping on a countertop on top of white paper to check for | |
| | loosening of target coating grains, gently rubbing an acid-washed Teflon | |
| | spatula against the deposited target coating and checking for loosening of | |
| | target coating grains, and/or placing and gently pressing down on a piece of | |
| | Scotch tape against the target coating. | |
| | If there was access to the cyclotron apparatus, it was recommended to | |
| | transfer the coin back/forth multiple times and ensure target coating | |
| | stability (i.e., no mass loss). Such a test may be performed with a degrader | |
| | in place. | |
| Method of | Electrodeposition from bath with a significantly high pH (e.g., 9.9-10.8) | |
| Production | | |
| Target Metal | To withstand the deposited beam power, the target metal was preferably | |
| Form | metallic nickel (not, e.g., nickel oxide). | |
| | Depending on the means of target coating preparation (e.g. electroplating), | |
| | the raw nickel starting material need not necessarily be metallic. However, | |
| | methods used for preparing ^{nat}Ni target metal should ultimately be directly | |
| | translatable to preparation of ⁶⁰Ni or ⁶¹Ni target metals. At present, it was | |
| | understood that enriched Ni was typically in the form of a salt. | |
| Target Coating | The use of binders must not necessary be avoided if they are absent of the | |
| Additives | final metallic coin and if an assessment on a case-by-case basis to | |
| | understand potential impact to product quality has been done (e.g. ICP-MS | |
| | on the binder material. | |
| | Any reagents used for target coating preparation (e.g. electroplating | |
| | reagents) must be of the highest quality, in particular, with regards to trace | |
| | metals. | |
| Metal Content | Preferably, the highest grades of reagents should be used, to avoid trace | |
| | metals contamination of the target coating, as more than a tenth of a | |
| | microgram per 100 mg of target metal (that is, 1 ppm of the target metal) is | |
| | already a significant contamination that may render the coin unusable for | |
| | production of high-purity radionuclides. In the case of the production of | |
| | radiocopper it is not accepted to add more than 0.1 ppm of cold Cu as this | |
| | would reduce the purity of the prepared radionuclide composition. | |
| | Preferably, max level of impurities allowed to be added by the process to | |
| | the initial nickel: | |
| | Copper (Cu): 0.1 ppm | |
| | High affinity metals (Ga, Lu, Pb, Y): 0.1 ppm | |
| | Zinc and cobalt (Zn, Co): 0.3 ppm | |
| | Transition and other metals (Cd, Cr, Al, Mn, Mo, Sn, Ti, V . . .): | |
| | 1 ppm on a case by case | |
| | Iron (Fe): 10 ppm | |
| | Family I and II (K, Ba, Mg, Be . . .): 1000 ppm | |
| | The metal coins were analyzed on a batch per batch basis by dissolution in | |
| | nitric acid to assess the metal contamination within the coin that were not | |
| | found in the starting nickel metal and thus originate from the process. | |
| | The amount suggested above were a good, albeit not strict, guide since | |
| | chemical purification following irradiation will, in turn, further remove | |
| | some of these impurities. The ultimate specification on this front will | |
| | therefore be an iterative process as the Cu/Ni separation chemistry is | |
| | refined. However, the process shall not significantly add impurities that | |
| | were not in the originating pure nickel material. | |
| | It is preferable that cold Cu should be minimized in the deposited Ni since | |
| | this will follow the chemistry of any ⁶¹Cu and cannot be separated post- | |
| | irradiation. Any such cold Cu will directly compete with ⁶¹Cu during | |
| | radiolabeling of the pharmaceutical. Methods of removing Cu from the | |
| | dissolved target metal are well known. | |
| Density of Target | To withstand the deposited beam power, the Ni target coating should | |
| metal | preferably be of reasonably high volumetric density (e.g. approximately ≥90% | |
| | or, ≥8 g/cm³). | |
| Power Rating | The power rating for the target metal, including the combined deposited Ni | |
| | and plate should preferably be: | |
| | ≥420 W (deuterons) | |
| | ≥820 W (protons) | |
| Loading Mass of | The loading mass vs. the deposited mass of Ni (i.e. deposition efficiency) | |
| Target coating | relates not to technical specifications, but rather, to cost. In the case of ^{nat}Ni | |
| | deposition, loading efficiency will not have a significant impact on the cost | |
| | of ⁶¹Cu. However, losses should be minimized in considering the translation | |
| | to enriched ^{6x}Ni. For ⁶⁰Ni, losses should be maintained below ~10%, and | |
| | for ⁶¹Ni, below ~1%. Some techniques such as magnetron sputtering are | |
| | thus not possible for enriched nickel but are satisfactory for ^{nat}Ni. | |
| Mass/thickness | For deuterons (i.e. ^{nat}Ni or ⁶⁰Ni), the thickness should be appropriate for | |
| of Nickel | stopping the deuterons, with a maximum 10% variability in material | |
| | deposition. Such thicknesses equate to: | |
| | ≥100 μm (assuming 100% density) | |
| | ≥70 mg or ≥89 mg/cm² (assuming 10 mm diameter) | |
| | For protons (i.e. ⁶¹Ni), one may wish to selectively limit the deposited | |
| | material to optimize the balance between material cost, yield, and backing | |
| | material activation. With a maximum 10% variability in material | |
| | deposition, four examples are noted below. | |
| | ⁶¹Ni Scenario #1 (11→9 MeV) | |
| | 78 μm (assuming 100% density) | |
| | 55 mg or 69 mg/cm² (assuming 10 mm diameter well) | |
| | ⁶¹Ni Scenario #1 (12→8 MeV) | |
| | 155 μm (assuming 100% density) | |
| | 108 mg or 138 mg/cm² (assuming 10 mm diameter well) | |
| | ⁶¹Ni Scenario #1 (13→7 MeV) | |
| | 233 μm (assuming 100% density) | |
| | 163 mg or 208 mg/cm² (assuming 10 mm diameter well) | |
| | ⁶¹Ni Scenario #1 (13→4 MeV) | |
| | 309 μm (assuming 100% density) | |
| | 216 mg or 275 mg/cm² (assuming 10 mm diameter well) | |
| Isotopic | The ^{6x}Cu radioisotopes which will be coproduced during production of | |
| enrichment | ⁶¹Cu (t 1/2 = 3.339 h) include: | |
| | ⁵⁷Cu (t ½ = 0.196 s) | ⁵⁸Cu (t ½ = 3.204 s) |
| | ⁵⁹Cu (t ½ = 81.5 s) | ⁶⁰Cu (t ½ = 23.7 m) |
| | ⁶²Cu (t ½ = 9.673 m) | ⁶⁴Cu (t ½ = 12.701 h) |

| | |
|---|---|
| | From a practical handling point of view, all but ⁶⁰Cu and ⁶⁴Cu are likely to |
| | have decayed prior to use. Only ⁶⁴Cu will have any impact on the possible |
| | shelf-life of ⁶¹Cu. |
| | In addition to the production of Cu radioisotopes, other radionuclides (e.g. |
| | Co and Ni) will also be produced, the ratio of which will depend on the |
| | isotopic composition, and whether undergoing deuteron or proton |
| | irradiation. As these byproducts are chemically different from copper, such |
| | radionuclides may be removed during ⁶¹Cu purification/processing. For |
| | example, The Cu-61 was purified from metal and radiometal impurities via |
| | a GE Healthcare FASTlab 2 module through a tributyl phosphate resin |
| | cartridge and a tertiary-amine-based weak ionic exchange resin containing |
| | long-chained alcohols. |
| Any other | Niobium is preferred over silver for its better resistance to corrosion, its low |
| requirements | amount of activation on irradiation and for its high melting temperature that |
| | permits the deposit of nickel by other processes such as melting or heat |
| | sintering. However, silver possesses a higher thermal conductivity and may |
| | be suitable for certain embodiments. |
| | For backing manufacture, the following sheet of niobium is suitable for |
| | laser cutting: |
| | http://www.Goodfellow.com |
| | NB000400 Niobium Foil, Size: 150 × 150 mm Thickness: 1.5 mm, |
| | Purity: 99.9%, Temper: Annealed, Quality: LT |
| | From one sheet up to 25 backings can be manufactured. |

### 5.4. Example 3. Purification and Characterization of [⁶¹Cu]CuCl₂ and Waste Streams

The irradiated target coating was dissolved in a total volume of 7 mL of 6 M HCl with the addition of 30% hydrogen peroxide via a dissolution chamber. Separation and purification was accomplished using a cassette-based FASTlab platform using a TBP (tributylphosphate-based) resin (1 mL) (particle size 50-100 μm; pre-packed, Triskem) then a weakly basic (tertiary amine; TK201) resin (2 mL) (particle size 50-100 μm; pre-packed, Triskem) each of which were pre-conditioned with H₂O (7 mL) and HCl (OM, 7 mL). The cassette reagent vials were prepared using concentrated HCl (Optima Grade, Fischer Scientific), NaCl (ACS, Fischer Scientific) and milli-Q water (Millipore system, 18 MΩ-cm resistivity). 6M HCl (2×4.2 mL), 5M NaCl in 0.05 M HCl (4.2 mL). The subsequent ⁶¹Cu was then purified with two subsequent ion exchange resins in a FASTlab synthesis unit as follows.
1) The acid-adjusted dissolution solution (approx. 7 mL) was loaded over both columns in series and directed into a “Ni collection fraction”. The TBP resin acted as a guard column as it quantitatively retained Fe³⁺ ions, while the Cu²⁺ and Co²⁺ complexes were quantitatively retained on the tertiary amine (TK201) resin.
2) Both columns were washed with 6M HCl (4 mL) to maximize Ni recovery for future recycling.
3) The TK201 column was washed with 4.5M HCl (5.5 mL) to elute the majority of cobalt salts.
4) The TK201 column was washed with 5M NaCl in 0.05M HCl (4 mL) to decrease residual acid on the resin and further remove any residual cobalt salts.
5) The TK201 column was washed with of 0.05M HCl (3 mL) to quantitatively elute the [⁶¹Cu]CuCl₂.

The resulting [⁶¹Cu]CuCl₂ solution of the plated material has an average activity of 1-4.5 GBq. This activity was measured using a dose calibrator from Comecer and its radionuclidic purity by a gamma spectrometer at PSI in Switzerland.

Gamma spectrometry measurements were performed to identify any radionuclidic impurities, particularly long-lived radionuclides. These results indicate a 89.3% and 94% reduction in impurities for ^{nat}Ni and ⁶¹Ni on niobium backing materials with respect to silver backing materials when utilizing the methods disclosed herein. ICP-MS measurements were performed on the product of cold dissolutions by Labor Veritas in Switzerland to monitor elemental impurities present in product according to ICH-Q3D. All detected impurities were within regulated ICH-Q3D concentrations (see ICH-Q3D Guidelines, pg 25).

The plating of highly enriched ⁶¹Ni was also enabled with the same plating parameters as described above, for a higher yield and industrial production using proton irradiation (typically at 80 μA to 100 μA, 13 MeV protons for 1 hour to 2 hours and up to one half-life of ⁶¹Cu).

### 5.5. Example 4. Purity and Activity Evaluations of [⁶¹Cu]CuCl₂ Compositions Prepared from ^{nat}Ni(d,n)⁶¹Cu and ⁶⁰Ni(d,n)⁶¹Cu Using Nb-Backed Coins

This example presents information on the activity of the produced ⁶¹Cu generated using the Nb backing, Ni electrodeposited coins of the present disclosure; alongside cobalt radioisotopes, that were produced with deuteron irradiation using the coin comprising a natural nickel target coating and the coin comprising enriched ⁶⁰Ni as target metal, i.e., ^{nat}Ni(d,n)⁶¹Cu and ⁶⁰Ni(d,n)⁶¹Cu, respectively. The irradiated materials were dissolved and purified as described in Example 3.

The obtained and purified [⁶¹Cu]Cu product and waste generated during purification from the products of deuteron irradiation of natural nickel/Nb coin and ⁶⁰Ni/Nb coin, respectively, was processed and analysed by gamma-spectrometry and presented below.

TENDL-2019 based thick target coating yield calculations using isotopic abundancy of natural nickel/Nb coin and enriched ⁶⁰Ni/Nb coin, respectively.

### 5.5.1. Radiocobalt Content

Table 8 contains activities of cobalt radioisotopes in the different fractions post FASTlab purification as a mean of three measurements (n=3 irradiations) using ^{nat}Ni/Nb coin. The activities were extrapolated to a 3 h and 50 μA beam at EoB (end of bombardment)+2 h. The activity of [⁶¹Cu]CuCl₂ in these irradiations was determined experimentally and confirmed to be ˜80% of TENDL-2019 based estimates.

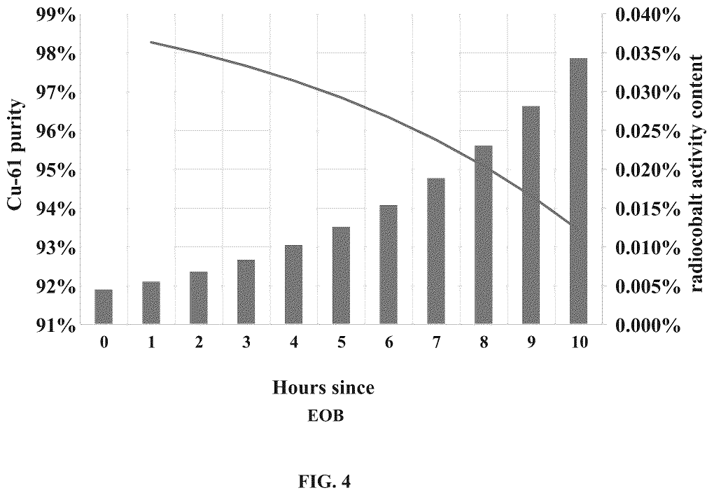

Activity of produced ⁶¹Cu for irradiation with deuteron at 8.4 MeV, 3 h at 50 μA at 80% efficiency (EoB+2 h): 3052 MBq. Also see FIG. 4 for the change in cobalt radioisotopes with time along with the corresponding change in ⁶¹Cu purity.

TABLE 8
Cobalt isotopes: natNi/Nb coin

| | Cu fraction | Ni fraction | Co-waste I + II | Half-life |
|---|---|---|---|---|
| Radionuclide | [Bq] | [Bq] | [Bq] | [days] |
| ⁵⁶Co | 118345 | 2696 | 2458071 | 77 |
| ⁵⁷Co | 0 | 0 | 474 | 272 |
| ⁵⁸Co | 95395 | 2145 | 1940192 | 71 |
| ⁶⁰Co | 124 | 3 | 2602 | 1925 |

Table 9 contains calculated activities of cobalt radioisotopes that would be obtained by using 99% enriched ⁶⁰Ni as target metal. The activities were extrapolated to a 3 h and 50 μA beam at EoB (end of bombardment)+2 h. The activity of ⁶¹Cu was calculated accordingly.

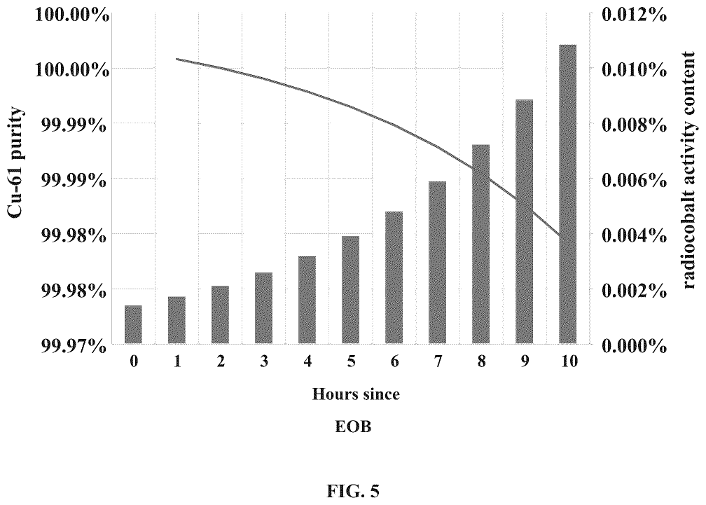

Activity of produced ⁶¹Cu with deuteron irradiation at 8.4 MeV, 3 h at 50 μA at 80% efficiency (EoB+2 h): 11.552 MBq. Also see FIG. 5 for the change in cobalt radioisotopes with time and the corresponding change in ⁶¹Cu purity.

TABLE 9
Cobalt isotopes: enriched ⁶⁰Ni/Nb target coin.

| | | | Separated | |
|---|---|---|---|---|
| | ⁶¹Cu fraction | Separated Ni | Co-waste I + II | Half-life |
| Radionuclide | [Bq] | [Bq] | [Bq] | [days] |
| ⁵⁶Co | 365 | 8 | 7583 | 77 |
| ⁵⁷Co | 0 | 0 | 1793 | 272 |
| ⁵⁸Co | 242909 | 5463 | 4940424 | 71 |
| ⁶⁰Co | 0.5 | 0 | 11 | 1925 |

### 5.5.2. Activity and Chemical Purity

Based on a combination of theoretical calculations and experimental results, the purity of [⁶¹Cu]CuCl₂ produced from deuteron irradiation of ^{nat}Ni/Nb target coin was compared with [⁶¹Cu]CuCl₂ from deuteron irradiation of enriched ⁶⁰Ni/Nb coin.

In Table 10, the extrapolated radiocobalt activity content and ⁶¹Cu purity of [⁶¹Cu]CuCl₂ solution produced by ^{nat}Ni as target metal for a 50 μA, 3 h deuteron irradiation after FASTlab purification were presented.

TABLE 10
Natural Ni/Nb Coin- Analysis of ⁶¹Cu activity
and purity in produced [⁶¹Cu]CuCl₂ solution.

| | Co | | | | | |
|---|---|---|---|---|---|---|
| | species | | | | % Purity | |
| | activity | | | | PET | % |
| Hours | in Cu | ⁶¹Cu | ⁶⁴Cu | | nuclides | non-Cu |
| post | fraction | activity | activity | % Purity | ⁶¹Cu + | radio- |
| EoB | [Bq] | [MBq] | [MBq] | ⁶¹Cu | ⁶⁴ Cu | nuclides |
| 0 | 213864 | 4622 | 70 | | 99.995% | 0.00456% |
| 1 | 213784 | 3756 | 66 | 98.261% | 99.994% | 0.00559% |
| 2 | 213704 | 3052 | 63 | 97.979% | 99.993% | 0.00686% |
| 3 | 213624 | 2479 | 59 | 97.652% | 99.992% | 0.00841% |
| 4 | 213544 | 2015 | 56 | 97.274% | 99.990% | 0.01031% |
| 5 | 213465 | 1637 | 53 | 96.837% | 99.987% | 0.01263% |
| 6 | 213385 | 1330 | 50 | 96.332% | 99.985% | 0.01545% |
| 7 | 213305 | 1081 | 48 | 95.750% | 99.981% | 0.01890% |
| 8 | 213225 | 878 | 45 | 95.081% | 99.977% | 0.02309% |
| 9 | 213145 | 714 | 43 | 94.312% | 99.972% | 0.02817% |
| 10 | 213066 | 580 | 41 | 93.432% | 99.966% | 0.03434% |

Less than 0.03% non-Cu radioisotopes (⁵⁶Co and ⁵⁸Co) will be left in the copper fraction, assuming a product expiry time of 8 h post EoB. This value was lower than the limit allowed for ⁶⁸Ga cyclotron-produced as found in the Pharmacopeia (*0.1% at expiry for non-Ga radioisotopes):

The ⁶⁴Cu originating from ^{nat}Ni irradiation (content˜5% at expiry) will be the main impurity, reducing the radioisotopic purity of ⁶¹Cu product at longer timescales post-irradiation times or shelf-life (illustrated as the grey curve in FIG. 4).

In Table 11: ⁶⁰Ni/Nb coin-Analysis of ⁶¹Cu activity and purity and after FASTlab purification. FIG. 5, shows the extrapolated radiocobalt activity content and ⁶¹Cu purity of the produced [⁶¹Cu]CuCl₂ solution.

TABLE 11
⁶⁰Ni/Nb coin - Analysis of ⁶¹Cu activity and
purity in produced [⁶¹Cu]CuCl₂ solution.

| | Co | | | | | |
|---|---|---|---|---|---|---|
| | species | | | | % Purity | |
| | activity | | | | PET | % |
| Hours | in Cu | ⁶¹Cu | ⁶⁴Cu | | nuclides | non-Cu |
| post | fraction | activity | activity | % Purity | ⁶¹Cu + | radio- |
| EoB | [Bq] | [MBq] | [MBq] | ⁶¹Cu | ⁶⁴Cu | nuclides |
| 0 | 243275 | 17498 | 0.378 | | 99.999% | 0.00139% |
| 1 | 243176 | 14217 | 0.358 | 99.996% | 99.998% | 0.00171% |
| 2 | 242977 | 11552 | 0.339 | 99.995% | 99.998% | 0.00210% |
| 3 | 242680 | 9386 | 0.321 | 99.994% | 99.997% | 0.00259% |
| 4 | 242285 | 7627 | 0.304 | 99.993% | 99.997% | 0.00318% |
| 5 | 241792 | 6197 | 0.288 | 99.991% | 99.996% | 0.00390% |
| 6 | 241201 | 5035 | 0.272 | 99.990% | 99.995% | 0.00479% |
| 7 | 240514 | 4091 | 0.258 | 99.988% | 99.994% | 0.00588% |
| 8 | 239731 | 3324 | 0.244 | 99.985% | 99.993% | 0.00721% |
| 9 | 238853 | 2701 | 0.231 | 99.983% | 99.991% | 0.00884% |
| 10 | 237882 | 2195 | 0.219 | 99.979% | 99.989% | 0.01084% |

Less than 0.01% non-Cu radioisotopes (⁵⁶Co and ⁵⁸Co) were left in the Cu fraction, assuming a product expiry time of 8 h post EoB. This value was ten times lower than the allowed limit for ⁶⁸Ga cyclotron-produced as found in the Pharmacopeia (0.1% at expiry for non-Ga radioisotopes*).

Less than 0.02% ⁶⁴Cu was left in the copper fraction at an expiry time of 8 h post EoB, one hundred times lower than the specification required for ⁶⁸Ga (2% Ga radioisotopes were allowed for ⁶⁸Ga).

### 5.5.3. Purity of Produced [⁶¹Cu]CuCl₂ from Ni/Nb Coins: Comparison with Commercially Available Radionuclides

In Table 12, a comparison of the regulatory specifications on the purity of commercially available radionuclides were given along with the characteristics of the high purity [⁶¹Cu]CuCl₂ produced from deuteron irradiation of natNi/Nb and enriched ⁶⁰Ni/Nb coin (50 μA, 3 h) and after FASTlab purification were presented.

TABLE 12
Comparison between commercially available radionuclides and [⁶¹Cu]CuCl₂
solution produced from irradiation of ^{nat}Ni/Nb coins and enriched ⁶⁰Ni/Nb coins.

| | | % Max | | | | |
|---|---|---|---|---|---|---|
| | | radioisotopes | % Max other | | | % Max other |
| | % Purity at | of same element | radioisotopes | Dominant | % Purity at | radioisotopes |
| Radionuclide | calibration | at calibration | at calibration | impurities | expiry | at expiry |
| ¹¹¹In¹ | 99.93% | 0.075% | | ⁶⁵Zn, ^{114m}In | 99.85% | 0.15% |
| ¹⁸F² | | | | ⁵⁶Co | 99.90% | 0.10% |
| ¹⁸F ³ | | | | ⁵⁶Co | 99.99% | 0.01% |
| ⁶⁸Ga | 98% | 2% | 0.10% | | | |
| cyclotron⁴ | | | | | | |
| ⁶⁸Ga | 99.90% | | 0.001% | ⁶⁸Ge | | |
| generator⁵ | | | | | | |
| ¹⁷⁷Lu⁶ | 99.90% | 0.05% | | | | |
| ⁶¹Cu from | 97.27% | 3.16% | 0.013% | ⁵⁶Co, ⁵⁸Co | 95.08% | 5% |
| ^{nat}Ni | (EoB + 4 h) | | | | (EoB + 8 h) | |
| ⁶¹Cu from | 99.99% | 0.009% | 0.004% | ⁵⁶Co, ⁵⁸Co | 99.98% | 0.02% |
| ⁶⁰Ni | (EoB + 4 h) | | | | (EoB + 8 h) | |

REFERENCES:
¹https://www.accessdata.fda.gov/drugsatfda_docs/label/2002/in111mal021902LB.pdf
²a. Pharmacopeia
b. reports of practical oncology and radiotherapy 19 (2014) S22-S31 doi: 10.1016/j.rpor.2014.03.001
c. Applied Radiation and Isotopes 81 (2013) 268-271 doi: 10.1016/j.apradiso.2013.03.044
³ ULg, USZ communication
⁴http://www.radiofarmacia.org/wp-content/uploads/2018/10/MONOGRAF%D6A-GA68Cl.pdf
⁵a. https://www.ire.eu/medias/164/Brochure-galli-Eo.pdf
b. Molecules 2015, 20, 12913-12943; doi: 10.3390/molecules200712913
c. https://mri.cts-mrp.eu/Human/Downloads/DK_H_2294_001_FinalSPC.pdf
⁶a. https://www.diagimaging.com/literature/ITG/ITG%20Lu-177%20n.c.a.pdf
b. Nuclear Medicine and Molecular Imaging volume 49, pages 85-107 (2015) doi: 10.1007/s13139-014-0315-z
c. https://www.ema.europa.eu/en/documents/assessment-report/lumark-epar-public-assessment-report_en.pdf
d. https://www.ema.europa.eu/en/documents/assessment-report/endolucinbeta-epar-public-assessment-report_en.pdf

As the first notable comparison, cyclotron production of ⁶⁸Ga from proton irradiation also produces long lived radionuclides, (see, e.g., Applied Radiation and Isotopes, 65(10), 1101-1107, IAEA-TECDOC-1863 Gallium-68 Cyclotron Production) notably ⁶⁵Zn (half-life=244 days) from the ⁶⁶Zn(p,pn)⁶⁵Zn decay. With a roughly 0.365% of ⁶⁶Zn in an enriched ⁶⁸Zn starting target metal, about 770 Bq of ⁶⁵Zn will be produced from a 50 μA, 3 h beam with an energy of 13 MeV in a thick target coating (TENDL-2019 based calculations). Using natural Zn with 27.7% abundancy in ⁶⁶Zn, 58 kBq of ⁶⁵Zn will be produced in one run of 50 μA for 3 h beam. The isotopic purity of Zn in the target metal is, thus, very important.

Similar with [⁶¹Cu]CuCl₂ production, cyclotron production of [⁶⁴Cu]CuCl₂ from proton irradiation also produces long-lived cobalt radionuclides, namely, ⁵⁵Co, ⁵⁷Co, ⁵⁸Co, and ⁶⁰Co. (See, e.g., Nuclear Medicine & Biology, Vol. 24, pp. 35-43, 1997; Applied Radiation and Isotopes 68 (2010) 5-13) By operating with a degraded beam of below 13 MeV, ⁶⁰Co (from ⁶⁴Ni(p,na)⁶⁰Co) was reduced to 1 Bq per run of 50 μA, 3 h. With beam energies below 13 MeV, ⁵⁵Co, formed from the ⁵⁸Ni(p,a)⁵⁵Co reaction, will remain the main impurity (half-life=17.53 hours). The 170 Bq of the long-lived ⁵⁷Co was formed in about 170 Bq in these conditions mostly from ⁶⁰Ni(p,a)⁵⁷Co.

Note: These estimates were computed from thick target coating yields using TENDL-2019 cross section data and isotopic abundancy of enriched ⁶⁴Ni as follows: 0.00376% ⁵⁸Ni, 0.00298% ⁶⁰Ni, 0.0058% ⁶¹Ni, 0.135% ⁶²Ni, 99.858% ⁶⁴Ni).

### 5.6. Example 5. Enriched ⁶¹Ni as Target Metal on Nb Backed Coins

⁶¹Cu was produced through the proton bombardment of ⁶¹Ni electroplated Nb backed coin via cyclotron equipped with a solid target system irradiating a highly pure Niobium coin plated with highly pure ⁶¹Ni (purity 99.42%). The proton beam currents used were up to 100 μA, and beam energy of 13 MeV. An aluminum beam degrader was used.

The solid target irradiated material was dissolved in a total volume of 7 mL of 6M HCl with the addition of 30% H₂O₂ in a heated dissolution chamber. The ⁶¹Cu was purified from metal and radiometal impurities via a GE Healthcare FASTlab 2 module through a tributyl phosphate resin cartridge and a tertiary-amine-based weak ionic exchange resin containing long-chained alcohols. The product was finally eluted in an ISO class 5 environment in 3 mL 0.05 M HCl through a sterile filter Millex 4 mm Durapore PVDF 0.22 μm into a sterile evacuated vial. The vial was handled with care using the appropriate shielding and can be stored at room temperature until use using appropriate shielding for transport and handling.

TABLE 13
Specifications of [⁶¹Cu]CuCl₂.

| Parameter | Test Method | Specification | |
|---|---|---|---|
| Appearance | Visual inspection | Clear, colorless solution, free | |
| | | from particulate matter | |
| Volume | Weight measurement | 3 ± 0.3 | mL |
| Activity | Dose calibrator | 0.30-2.00 | GBq/mL |
| concentration (EoS) | | | |
| pH value | pH paper strips | 1-1.6 | |
| Radiochemical | Radio-TLC | ≥99% (as [⁶¹Cu]CuCl₂) | |
| purity | | | |
| Radionuclidic | γ-Spectrometry (in lab at EoS) | γ-photons with energy peaks at: | |
| identity | | 283 keV ± 20 keV | |
| | | 511 ± 20 keV (eventually sum | |
| | | peak at 1022 keV ± 20 keV) | |
| | | 656 keV ± 20 keV | |
| | Half-life via dose calibrator | 200 ± 20 | min |
| Radionuclidic | γ-Spectrometry (sent out, evaluated >3 weeks, | ≥99.9% | |
| purity | values extrapolated to EoS) | | |
| Bacterial endotoxin | LAL test (Endosafe) | ≤17.5 | EU/mL |

| | | |
|---|---|---|
| content | | |
| Chemical purity | ICP-MS (sent out, evaluated >3 weeks, values | Sum of impurities ≤15 μg/GBq |
| | relevant to EoS as these do not change with | Cu ≤0.5 μg/GBq |
| | time) | Al ≤2 μg/GBq |
| | | Co ≤1 μg/GBq |
| | | Fe ≤3 μg/GBq |
| | | Pb ≤1 μg/GBq |
| | | Ni ≤2 μg/GBq |
| | | Zn ≤1 μg/GBq |

*post-release (≥3 weeks)
^{#}measured periodically

As shown in Table 14, and FIG. 6, commercially available ⁶¹CU contains radionuclidic impurities, particularly high levels of ⁵⁶Co, ⁶⁰Cu and ⁸⁸Co, in addition to ^{110m}Ag (t^{1/2}439 years) and ¹⁰⁹Cd. Commercially available [⁶¹Cu]CuCl₂ contains radionuclidic impurities, particularly high levels of ⁵⁶Co and ⁵⁸Co, in addition to ^{110m}Ag and ¹⁰⁹Cd. Elimination of Ag and Cd isotopes from the Cu-61 product by replacing silver with niobium as backing material. There was a nine-fold reduction of ⁵⁶Co isotopes for natNi and >2000× reduction for Ni-61 (less shielding of radioactive waste is required). 50% reduction of long-lived cobalt isotopes (earlier final disposal of the produced waste) was also observed. It was clear from the data below, that the radionuclidic purity of [⁶¹Cu]CuCl₂ produced by the methods of the present disclosure was shown to be superior to previously known methods and products. The high levels of long-lived Co, Ag, and Cd radionuclides pose a radiation burden for the patient and a radioactive waste issue for consumables that have come in contact with the [⁶¹Cu]CuCl₂ product during radiopharmaceutical manufacturing and radiolabeling.

The presence of long-lived impurities causes complications in the handling and waste management of contaminated materials. These data show that the provided compositions have a significantly reduced radiation burden to patients and also significantly reduce the cost and complexity of waste management. All materials/consumables that come into contact with the [⁶¹Cu]CuCl₂ solution must be disposed of according to local governmental regulations. Costs of waste disposal rise proportionately with the activity and half-life of the radionuclidic impurities present.

TABLE 14
Detailed radionuclidic impurities present in commercially available
⁶¹Cu compared to high-purity [⁶¹Cu]Cl₂ of the present
disclosure, expressed in Bq/g. The high levels of long-lived Co,
Ag and Cd radionuclides pose a radiation burden for the patient and a
waste issue for consumables that have come in contact with the
[⁶¹Cu]Cl₂ product during radiopharmaceutical
manufacturing/radiolabeling. Values relevant for End of Synthesis
(doesn't change much in several hours)

| | | | Ext. Coins | Present Coins | |
|---|---|---|---|---|---|
| Coin | | | nat-Ni on Ag | nat-Ni on Nb | ⁶¹Ni on Nb |
| Elements | T_{1/2} | | Bq/g | | |
| Co-56 | 77.23 | days | 5269.2 | 539.5 | 2.3 |
| Co-57 | 271.74 | days | 1.8 | 1.5 | 1.2 |
| Co-58 | 70.86 | days | 4586.8 | 503.8 | 588.5 |
| Co-60 | 5.27 | years | 5.9 | 2.8 | 0.9 |
| Ag-108m | 439 | years | 0.9 | N/D | N/D |
| Ag-110m | 249.86 | days | 1.5 | N/D | N/D |
| Cd-109 | 462.6 | days. | 10 | N/D | N/D |

TABLE 16
Radionuclidic purity of [⁶¹Cu]CuCl₂ stemming from the irradiation
of commercially available coins or material to [⁶¹Cu]CuCl₂ produced
through method of the present disclosure. Radionuclidic purity of
commercially available ⁶¹Cu compared to high-purity [⁶¹Cu]CuCl₂
of the present disclosure as measured at EOS and EOS + 12 hours.

| | |
|---|---|
| Ext. Coins | Present Coins |

| Coin | nat-Ni on Ag | nat-Ni on Nb | ⁶¹Ni on Nb |
|---|---|---|---|
| Purity % t = 0 h | 99.998 | 99.999 | 99.9999 |
| Purity % t = 12 h | 99.978 | 99.993 | 99.999 |

### 5.6.1. Endotoxin Determination by Limulus Amebocyte Lysate (LAL Test)

The bacterial endotoxins were determined by LAL test using the Charles River Endosafe™-PTS system.

During dispensing of the [⁶¹Cu]CuCl₂ solution, an aliquot of 1 mL was dispensed for quality control tests. The tests were carried out in a non-classified quality control laboratory. The solution was composed of [⁶¹Cu]CuCl₂, 0.05 M HCl(aq).

TABLE 17
LAL-tested [⁶¹Cu]CuCl₂ solution.

| Material | Description |
|---|---|
| Endosafe ™-PTS | Charles River PTS2005F. Disposable test |
| cartridge sensitivity 5 - | cartridge used as platform for the rapid |
| 0.05 Eu/mL | kinetic chromogenic LAL test. Pre-loaded |
| | with all the reagents required to perform |
| | the test. |
| Endotoxin free water | Charles River W120 |
| Endotoxin-free pipette | Sarstedt Biosphere Quality Tips, 70.762.200 |
| tips | (100-1000 μL); 70.3031.305 (250 μL); |
| | 70.1114.200 (0.5-20 μL) |
| Endotoxin-free dilution | Charles River TL 1000 |
| tubes | |
| Endotoxin-free TRIS | Charles River 100 mM TRIS buffer BT105 |
| buffer | |

The [⁶¹Cu]CuCl₂ solution (pH 1.3) was diluted before the analysis using LAL reagent water and a buffer in order to reach a pH value in the range 6-7.6. To adjust the pH, TRIS buffer was added to the [⁶¹Cu]CuCl₂ solution.

A dilution was prepared of the [⁶¹Cu]CuCl₂ to be tested mixing the reagents in the endotoxin-free dilution tubes as follows: dilution factor (1:75); [⁶¹Cu]CuCl₂ sample (10 μL); TRIS buffer (40 μL); water (700 μL). Mix for about 30 seconds.

### 5.6.2. Conclusion

The experimental activities of [⁶¹Cu]CuCl₂ produced after deuteron irradiation were about 80% of the theoretical yield as calculated from TENDL-2019 cross section data.

The main long-lived nuclides in the radioactive waste fraction from cyclotron production of [⁶¹Cu]CuCl₂ are radiocobalt species of ⁵⁶Co, ⁵⁷Co, ⁵⁸Co and ⁶⁰Co. After four years, ⁵⁶Co, ⁵⁷Co, and ⁵⁸Co were calculated to have decayed below Swiss clearance limits, LL, leaving only ⁶⁰Co. *Clearance limit (LL) means the value corresponding to the specific activity level of a material below which handling of this material was no longer subject to mandatory licensing or, accordingly, supervision).

To improve the yield and purity of the [⁶¹Cu]CuCl₂ product, coins with 99% enriched ⁶⁰Ni or ⁶¹Ni can be used. Using these targets, the extrapolated purity of ⁶¹Cu will be higher as ⁶⁴Cu will not be formed as a radioisotopic impurity. Additionally, the ⁵⁶Co and ⁶⁰Co contents will be reduced by a factor of 100. On the other hand, ⁵⁷Co amounts will quadruple, and ⁵⁸Co amounts will be doubled but the former one was in low activity (which will decay below LL before ⁵⁶Co/⁵⁸Co) and the later has an increased LL of 1 Bq/g (vs 0.1 Bq/g for ⁵⁶Co and ⁶⁰Co). Overall the Co-waste handling will remain similar (dispatch to long term storage after four years) but the amount of ⁶⁰Co can be reduced one hundred times with ⁶⁰Ni instead of natural Ni.

### 5.7. Example 6. Methods of Making High-Purity Ga-68 (⁶⁸Ga)

The planned process pertaining to irradiation and purification for ⁶⁸Ga production was listed below.

Zinc electroplating example procedure: The plating of highly enriched (e.g, ≥99%) ⁶⁸Zn was conducted with the same plating parameters as described above for a higher yield and industrial production using proton irradiation (typically at 80-100 μA, 13.5 MeV protons for 1-2 h).

The ⁶⁸Zn target metal on Nb coins were irradiated with 13.5 MeV protons for an average of 120 mins at a range of 10 to 100 μA on a cyclotron.

The dissolution of the ⁶⁸Zn from the niobium backing will be made via an ARTMS system in 10 M HCl. The subsequent [⁶⁸Ga]GaCl₃ was then purified with 2 subsequent ion exchange resins in a FASTlab synthesis unit. The average processing time for these purifications was around 30-60 mins.

With 100% dissolution of the plated material, the average activity of the resulting [⁶⁸Ga]GaCl₃ will be measured and the decay-corrected yield was calculated. The measurement tools used were a dose calibrator from COMECER and its radionuclidic purity by a gamma spectrometer at PSI in Switzerland.

Gamma spectrometry measurements were performed to record any radionuclidic impurities, especially long-lived radionuclides. At the same time, ICP-MS measurements were performed on the product of cold dissolutions by Labor Veritas in Switzerland to monitor elemental impurities present in the product according to ICH-Q3D regulations.

### 6. EQUIVALENTS AND INCORPORATION BY REFERENCE

While aspects of the present disclosure have been particularly shown and described with reference to certain embodiments and various alternate embodiments, it will be understood by persons skilled in the relevant art that various changes in form and details can be made therein without departing from the spirit and scope of the present disclosure.

All references, issued patents, and patent applications cited within the body of the instant specification are hereby incorporated by reference in their entirety, for all purposes. In particular, U.S. Provisional Patent Application No. 63/409,684, filed Sep. 23, 2022, is hereby incorporated by reference in its entirety.

1. A coin for bombardment by subatomic particles, the coin comprising:
a backing, wherein the backing consists of Nb, wherein the Nb is ≥98.8% pure.

2. The coin according to claim 1, wherein Nb is ≥99.99% pure.

3. The coin according to claim 1, wherein the Nb is characterized by one or more of the following:
Fe≤40 ppm;
Ti≤60 ppm;
Zn≤19 ppm;
Cu≤5 ppm;
Sn≤8 ppm;
Ni<5 ppm; and
Al≤5 ppm.

4-5. (canceled)

6. The coin according to claim 1, wherein the backing has a thickness of 0.5-3 mm.

7. The coin according to claim 1, further comprising:
a target coating adhered to a surface of the backing; and
wherein the target coating comprises a target metal.

8. The coin according to claim 7, wherein the target coating is characterized by one or more of the following: Cd≤0.0005 ppm, Co≤0.005 ppm, Pb≤0.005 ppm, Cu≤0.08 ppm, and Fe≤0.15 ppm.

9. The coin according to claim 7, wherein the target coating has a thickness of 0.05-20 mm.

10. The coin according to claim 7, wherein the target coating has a mass of 30-200 mg.

11. The coin according to claim 7, wherein the target coating mass is electroplated onto the surface of the backing.

12-14. (canceled)

15. The coin according to claim 7, wherein the target metal is Ni.

16. The coin according to claim 15, wherein the target metal is Ni of naturally occurring isotopic composition.

17. The coin according to claim 15, wherein Ni is isotopically enriched in a minor isotope of Ni relative to natural Ni, wherein the minor isotope is selected from ⁶⁰Ni, ⁶¹Ni, ⁶²Ni, and ⁶⁴Ni.

18-24. (canceled)

25. The coin according to claim 7, wherein the target metal is Zn.

26-28. (canceled)

29. A method for preparing a coin for bombardment by subatomic particles,
the coin comprising:
a backing, and
a target coating adhered to a surface of the backing, wherein the target coating comprises a target metal;
the method comprising:
electroplating the target metal from a plating solution onto the surface of the backing;
wherein the plating solution has a pH of 9.5-10.7.

30. The method according to claim 29, wherein the backing is selected from a Nb, Ag, Pt, Au, Al, and W backing.

31. (canceled)

32. The method according to claim 30, wherein the backing is a Nb backing.

33. A method for preparing the coin according to claim 7, the method comprising a step of:
electroplating the target metal from a plating solution to form the target coating adhered to the surface of the backing.

34-63. (canceled)

64. The method according to claim 29, wherein the target metal is Ni.

65. The method according to claim 64, wherein the target metal is natural Ni.

66. The method according to claim 64, wherein the target metal is isotopically enriched in a minor isotope of Ni relative to natural Ni, wherein the minor isotope is selected from ⁶⁰Ni, ⁶²Ni, ⁶¹Ni, and ⁶⁴Ni.

67-72. (canceled)

73. The method according to claim 29, wherein the plating solution is characterized as having one or more of the following elements in the range described:
Ga, Lu, Pb, Y≤0.1 ppm;
Co≤0.3 ppm; and
Cd, Cr, Al, Mn, Mo, Sn, Ti, and V≤1 ppm.

74. A coin prepared according to the method of claim 29.

75. A high-purity radionuclide composition, the composition comprising a radionuclide and having a radionuclidic purity at end of synthesis for the radionuclide of ≥95.0%; and wherein
the radionuclide is a Cu radionuclide, or
the composition comprises one or more of the following:
^{110m}Ag≤0.1 Bq/g;
^{108m}Ag≤0.1 Bq/g; and
¹⁰⁹Cd≤0.1 Bq/g.

76-78. (canceled)

79. The composition according to claim 75, wherein the radionuclide is a Cu radionuclide.

80. The composition according to claim 79, wherein the radionuclide is ⁶¹Cu.

81-91. (canceled)

92. A method of making a high-purity radionuclide composition comprising a radionuclide, the method comprising:
irradiating in a particle accelerator the target metal of the coin according to claim 7 to produce an irradiated target coating; and
preparing the high-purity radionuclide composition from the irradiated target coating.

93-114. (canceled)

115. The coin according to claim 6, wherein the backing is disc-shaped and has a uniform thickness in the range of 0.5-3 mm with a tolerance of ±0.1 mm.
